(19) United States
(12) Patent Application Publication
(10) Pub. No.: US 2005/0195975 A1
(43) Pub. Date: Sep. 8, 2005

(54) Digital media distribution cryptography using media ticket smart cards

(76) Inventor: Kevin Kawakita, Temple City, CA (US)

Correspondence Address: KEVIN KAWAKITA, 5812 TEMPLE CITY BL #100, TEMPLE CITY, CA, 91780, US

(21) Appl. No.: 10/755,624

(22) Filed: Jul. 6, 2004

Related U.S. Application Data
(60) Provisional application No. 60/441,189, filed on Jan. 21, 2003.

(51) Int. Cl. H04K 1/00

(52) U.S. Cl. 380/30

(57) ABSTRACT

FIG. 7 of the drawings depicts an overall view of this invention which relates to a new method or process for a system used to do digital media distribution in an architecture of public key cryptography called the digital media distribution cryptography architecture (100) which is implemented in computer hardware, computer software, and communications protocols, furthermore, the hardware components involved are media ticket smart cards (880), media ticket smart card readers (900), local area networks (924) (LAN's), internet protocol (IP) wide area networks (928) (WAN's), personal computers (820) (PC's), world wide web servers (824) (WWW), cryptographic media players (e.g. crypto-MP3 players) with built-in media ticket smart card readers (880), (900), (1004), cryptographic digital signal processors (932) (C-DSP's), furthermore, the software components involved are cryptographic key distribution programs, cryptographic mathematics algorithms, and cryptographic protocols.

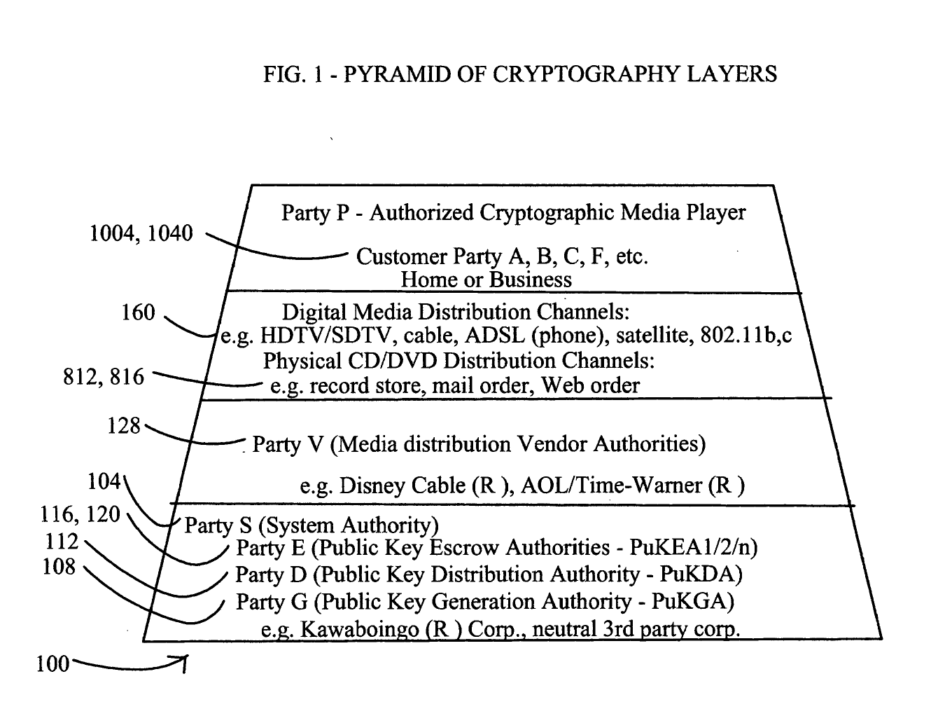

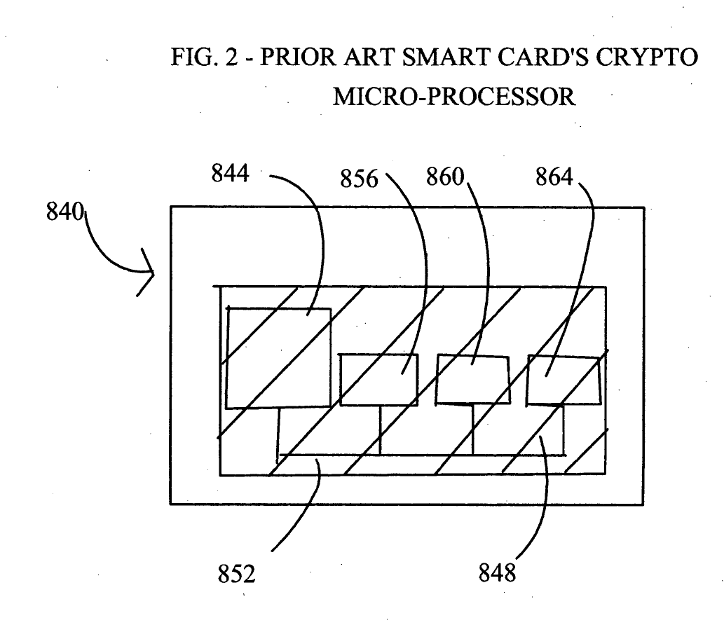

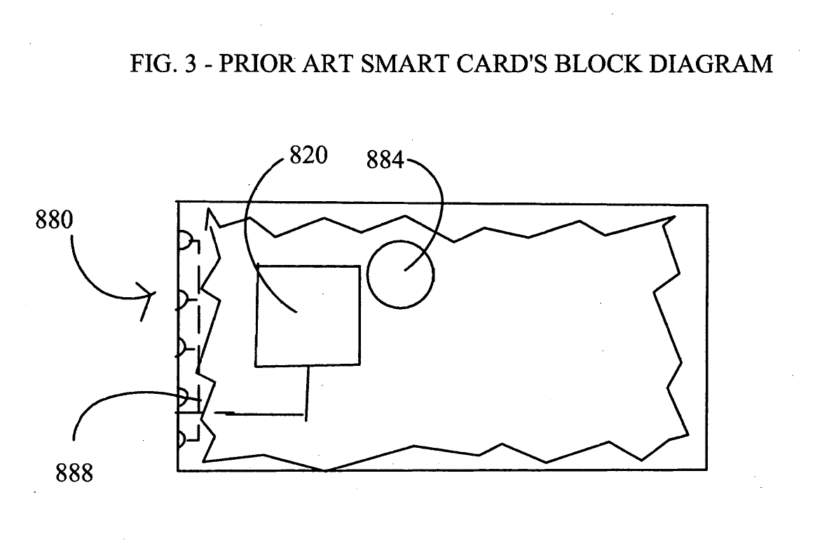

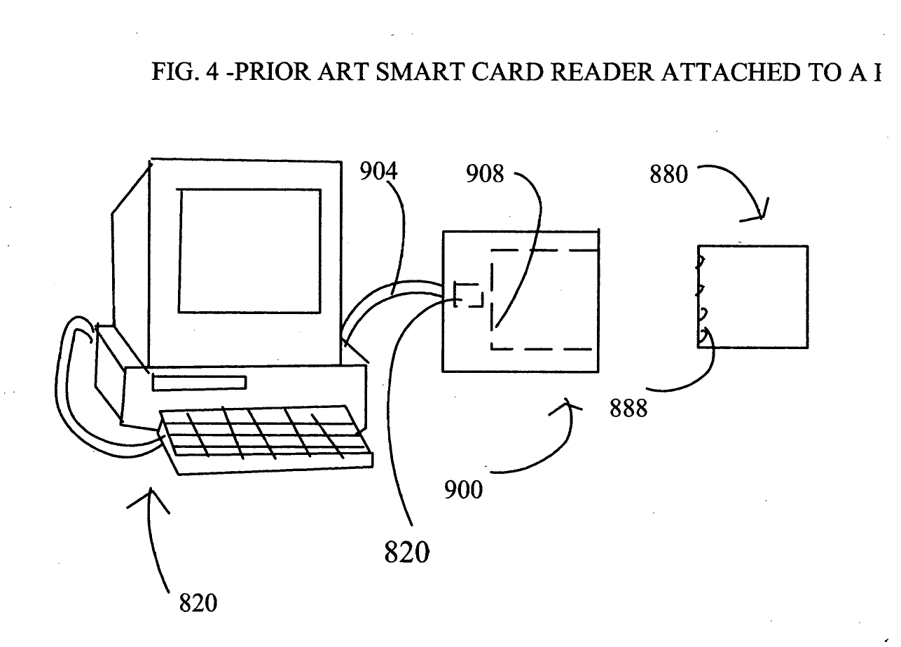

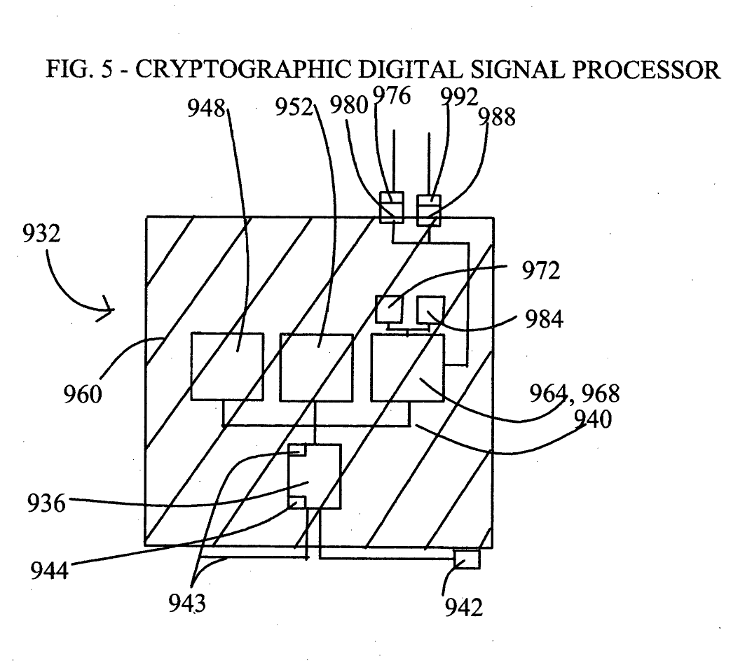

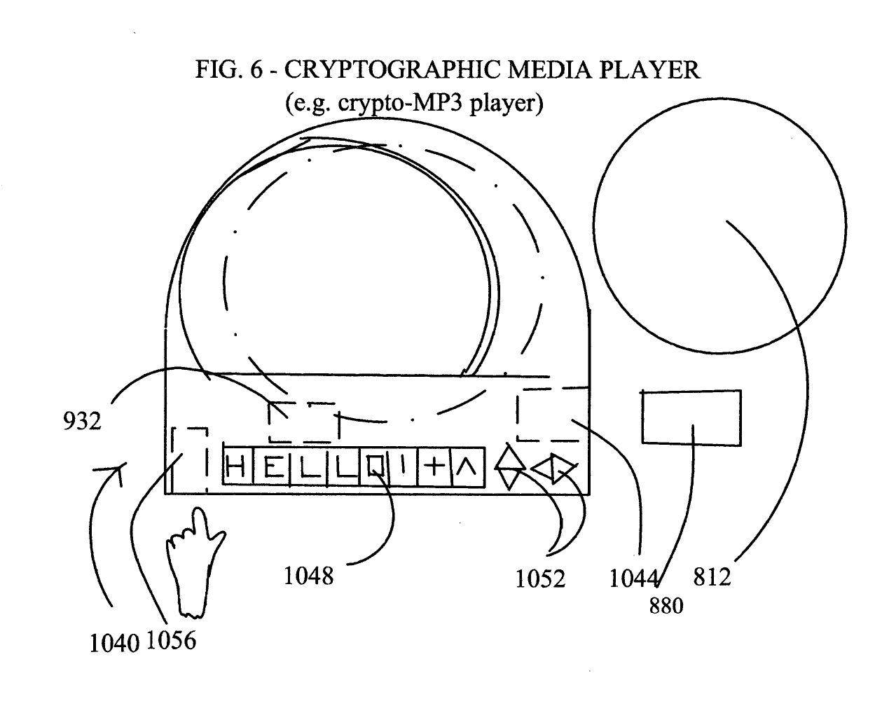

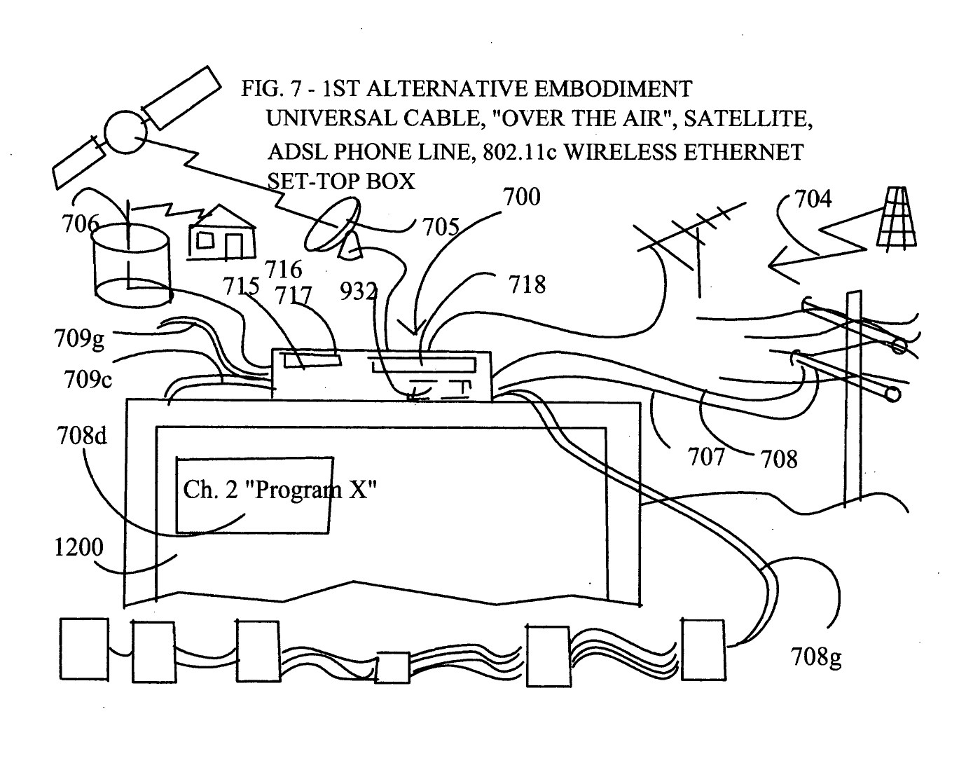

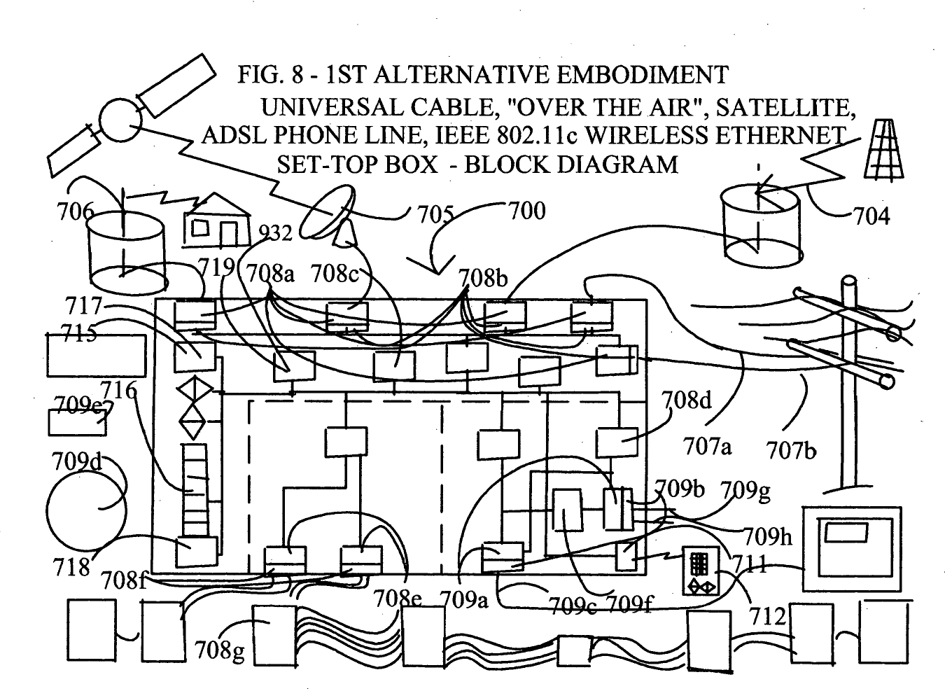

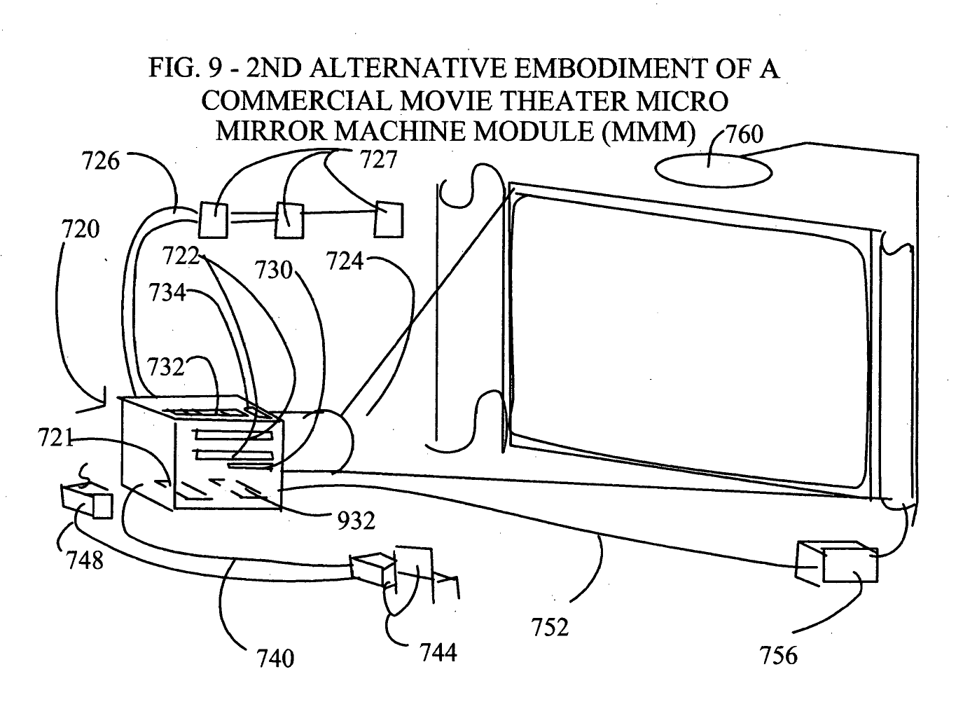

### OBJECTS & ADVANTAGES—vs. PRIOR ART

A. An object of this invention is to support physical and electronic distribution of custom encrypted digital media limited to digital music, digital movies, digital newspapers, and digital books (not including digital computer programs, digital computer games, and digital computer multi-media)

(see REFERENCES—NON-PATENT LITERATURE [REF 404]—“The Secure Digital Music Initiative (SDMI)”).

Napster (R) and Gnutella (R) types of peer to peer web music distribution services of movie picture electronics group (MP3) compressed digital music files allow customers to widely distribute illegal, copyright protected media. The MP3 files are customer created at home personal computers reading non-encrypted music compact disk sources. The music digital master on the compact disks are totally unprotected from illegal copyright piracy.

B. An object of this invention is to use only one smart media card per owner of the corresponding digital media from many different media distribution vendors of digital music, digital movies, electronic newspapers, and electronic books.

One smart media card per music company or one smart media card per item of music will be burdensome and confusing to the customer.

Prior art floppy based or dongle based or keychain based cryptographic key storage was matched one to one with a piece of encrypted data.

C. An object of this invention is to allow the owner's one smart media card to be used with any owner's cryptographic media player [REF 508].

Having one smart media card matched to only the owner's single cryptographic media player [REF 508] will be confusing and limit the choice of players.

D. An object of this invention is to stop the use of any unauthorized digital copying of digital media.

Napster (R) types of peer to peer web music distribution services of movie picture electronics group (MP3) compressed digital music files allow customers to widely distribute illegal, copyright protected media. The MP3 files are customer created at home personal computers reading non-encrypted music compact disk sources. The music digital master on the compact disks are totally unprotected from illegal copyright piracy.

Taiwanese music piracy operations routinely legally copy music cassette tapes, music compact disks, and movie video cassette tapes for overseas distribution into countries not in the international copyright convention. The unencrypted music and movie analog and digital masters are vulnerable and not technologically protected.

E. An object of this invention is to restrict one digital media distribution company's unencrypted digital masters only to itself and absolutely no other party especially prohibiting access by any other competing digital media distribution company.

F. An object of this invention is to allow play counts or count controlled plays or counted decryptions of custom encrypted media including counts of free trial media plays.

Unencrypted digital media can be used an unlimited number of times and allow unlimited perfect copying of digital masters for distribution to unlimited numbers of people.

G. An object of this invention is to provide all public key cryptography functions such as:
1). authentication (like an exchange of photo ID's or thumbprints)
2). encryption/decryption (for privacy)
3). integrity (wholeness or non-tampering)
4). digital signatures (like handwritten signatures)
5). non-repudiation (denying digital signatures)
6). authorization (approval using digital signatures and dating or official post marks)
7). archiving (storing digitally signed documents in a high integrity environment)
8). accessibility (restricting access to authorized users)
9). audit trail (recording accesses to information with Public Key ID's, dates, times, and locations)
10). play counts/play codes for counting paid for and authorized personally encrypted digital media plays and for decrypting them
11). crypto key splitting and key escrow.
12). crypto key administration and key architectures,

Digital media without encryption cannot implement these legal attributes.

H. An object of this invention is to support pass-thru encryption of cryptographic keys called play codes (session keys or 1-time secret keys) and play counts (paid for numbers of plays, −1 for indefinite plays, or counts of free trial plays) for their trip from a media distribution company's central web server over the open internet to a customer's personal computer over wiretappable buses to a secure, cryptographic memory inside of a smart card which is inserted into a smart card reader attached to the same personal computer.

Prior art cryptographic systems have relied upon secure sockets layer (SSL) types of public key distribution. Secure sockets layer does not store cryptographic keys in cryptographic memory. It also does not use pass-thru encryption over wiretappable computer buses. Secure sockets layer is vulnerable to hacker cryptographic algorithm disassembly attacks, logic analyzer attacks, hard disk copying and automated password decryption on hard disk hacker programs, keyboard capture buffers, etc.

I. An object of this invention is to support physical transfer of encrypted digital media in the form of digital versatile disk read/write, compact disk record once, and FLASH memory cards and also the physical transfer of smart media cards from a customer's personal computer to a cryptographic media player [REF 508] into which both are inserted.

J. An object of this invention is to support pass-thru encryption of cryptographic keys in the form of play codes (session keys or 1-time secret keys) and play counts (paid for numbers of plays, −1 for indefinite plays, or counts of free trial plays) from a smart media card inserted into a smart card reader built-into a cryptographic media player [REF 508] for transferring such keys over wiretappable (“red”) computer buses to a cryptographic digital signal processor unit [REF 500], [REF 504] having its own tamper resistant non-volatile electrically erasable programmable read only memory which processor is contained inside of the cryptographic media player [REF 508].

Examples are pass-thru, encrypted, transfer of keys from smart cards to smart card readers (using smart card reader vendor family keys) to cryptographic-DSP's (using cryptographic-DSP vendor family keys).

K. An object of this invention is to support an optional smart media card authentication triangle between the three points of:
point 1, customer A to
point 2, cryptographic media player [REF 508], to
point 3, smart media card A holding a customer, or user's private keys, secret keys, session keys, play codes, and play counts to prevent the use of stolen smart media cards.

Any one of the three points which are detected as unauthorized will stop the smart media card read/write process.

L. An object of this invention is to support a cryptograpic media authentication triangle between the three points of:
point 1, cryptographic media player [REF 508], to
point 2, smart media card holding a customer, or user's private keys, secret keys, session keys, play codes, and play counts, to
point 3, a copy of 1-way transferred and custom session key encrypted digital media.

Any one of the three points which are detected as unauthorized will stop the custom encrypted digital media playing process.

M. An object of this invention is to support legal fair use of US copyrighted encrypted digital media or the archiving of two to three copies for personal use. This invention also supports non-copyrighted commercial material and home produced material by allowing unlimited unencrypted plays of the media.

N. An object of this invention is to support legal first use of US copyrighted encrypted digital media or the right of one person to sell or transfer in entirety the encrypted digital media to another person and transfer only relevant smart media card cryptographic keys to the other person's smart media card.

O. An obect of this invention is to support lost and stolen smart media cards.

P. In the 1st alternative embodiment, an object of this invention is to support custom encrypted digital high definition television (HDTV) signals or else cable digital signals for playing upon a cryptographic media player/television/digital recorder with a built-in smart card reader.

Q. In the 2nd alternative embodiment, an object of this invention is to support a high performance, movie cryptographic media player/micro-mirror machine module (MMM) for commercial movie theater use.

Definition of Trusted (“Black”) Hardware.

Cryptographic keys can only be held in trusted hardware which is equipped with tamper resistant non-volatile electrically erasable programmable read only memory (TNV-EEPROM).
Cryptographic keys even in secret key encrypted form mixed with random noise called “salt” should absolutely never be held in any non-cryptographic memory such as prior art computer hard disks for permanent storage!!!!!!!!!

Non-cryptographic permanent memory examples are ordinary prior art hard disk drives, compact disk record once drives, digital versatile disk read/write drives, or flash (bank programmable) types of solid state memory card drives.

Unencrypted digital masters represent multi-million dollar sources of piracy revenue and are considered a media distribution company's jealously guarded crown jewels. The compromising of cryptographic keys will release multi-million dollar digital masters of hit movies and hit music to the illegal pirate or bootleg video and music industry. Record company promotional pre-releases of music and movie company first release movie masters are routinely copied by illegal copyright pirates even before the first commercial releases to the public!!!!

The media distribution company's secure world wide web server is assumed to be secure and trusted being physically guarded at the media distribution company's central office building and also with internet gateway firewall protection. Web server security levels are from highest to lowest:
1). For highest security, the web server may be an isolated server with no or extremely restricted local area network office connections which holds no unencrypted digital media masters, only encrypted digital media masters. Footprint downloads or data transfer must occur from the ordinary office local area network using hand carried removable hard disk drives and streaming tape cassettes.
2). For next highest security, the web server may be a proxy server or have local area network protocol isolation with the rest of the office. No other office phone line or modem connections should be allowed to avoid points of hacker entry.

The only secure tamper resistant non-volatile electrically erasable programmable read only memory (TNV-EEPROM) or shortened to secure cryptographic memory available in this system is:
1). in the smart media card
2). in the cryptographic media player [REF 508] or more specifically inside of its cryptographic digital signal processor integrated circuit chip (e.g. crypto-MP3 player).

Definition of Untrusted (“Red”) Hardware.

The internet is untrusted hardware.

Any non-cryptographic memory is untrusted hardware.

Any non-cryptographic memory devices are untrusted hardware.

Any wiretappable buses are untrusted hardware.

Pass-thru encryption of cryptographic keys using family keys upon unencrypted data always combined with sequence numbers or time stamps if a clock is available upon both sides to prevent recorded replay attacks must be done over all untrusted (“red”) hardware and buses.
Any secure sockets layer (SSL) internet connection is considered to be untrusted hardware!!!!!!!

It is definitely not secure enough for transporting cryptographic keys which could be used by pirates to illegally access the clear-text (unencrypted) digital masters of multi-million dollar, commercial digital media such as hit movies, hit music, electronic newspapers, and popular electronic format books. This is because a fully automated hacker personal computer program which can be remotely planted by a virus will automatically extract secure sockets layer private keys and secret keys from hard disks. Such a hacker program will eventually be produced by hackers if indeed it does not already exist because there are no technological barriers to stop the hacker. The hackers will use assembly code dis-assembly and logic analyzers to reverse engineer the assembly code location and secret key encryption algorithm which mixes the private key and secret key with random noise called “salt” and permanently stores the private key and secret keys on hard disk. A hacker program will be made to automatically retrieve the secret key encrypted private key and secret keys on hard disk and then randomly try to brute force crack the correct key sequence.

Alternately, a simple keyboard capture buffer remotely planted by a virus can retrieve the keyboard entered customer password and also find out the operating system secret key used to encrypt the private key stored on hard disk for permanent storage.

Factory distribution of cryptographic keys (before any internet based media distribution):

The smart media card system authority, party S, has a division of powers into three components to keep the potential access to plain text digital masters restricted to the originating digital media distribution company (its crown jewels worth multi-millions of dollars):
1). public key generating authority (PuKGA), party G: has knowledge of whole private keys and whole family keys, but, no knowledge of customer identifications of any kind.
2). public key distribution authority (PuKDA), party D: has knowlege of customer identifications of the kind registered by customers through retail store forms, web registration, and mail-back postcards, but, no knowledge of whole private keys and whole family keys.
3). public key escrow authorities (PuKEA), parties En (a minimum of parties E1 and E2 for cryptographic keys split into a front-half and a back-half):
   party E1 has only half of private keys, half of family keys, half of secret keys.
   party E2 has the other halves.
   party E1 and party E2 have no customer identification information of any kind.

### Central Public Key Generation Authority (PuKGA)—Party G

The smart media card system authority, party S, has a dedicated function of a public key generation authority, party G, has knowledge of whole cryptographic keys, but, no knowledge of customer identities or vendor identities!!!!!!

1). Party G generates from true random noise:
the system family key (FaK-F)
   which is a family key (common secret key (SeK-F)), FaK-F, where party F is the common family, which is given to the public key distribution authority, party D, for eventual pre-factory distribution to trusted media distribution companies, party Vn.

2). Party G generates an initialization vector (IV) used as a secret key seed (SeK-D) given only to:
a). the public key generation authority (C-PuKGA), party G,
b). the public key distribution authority (C-PuKDA), party D,

The top secret initialization vector (IV) is used as the seed for a message authentication cipher (MAC). A message authentication cipher (MAC) is a message digest cipher (MDC) using a secret seed which restricts its used to classified parties. A message digest cipher (MDC) is a one-way hash code which in example inputs a 512-bit cipher block of data and produces a fixed bit output uniquely representing the data such as a 128-bit pseudorandom output. A message authentication cipher (MAC) code (MAC code) is a fixed bit output such as 128-bits uniquely representing some digital data which only the holders of the initialization vector (IV) can produce.

The initialization vector (IV) is distributed by the party G only to the central public key distribution authority (C-PukDA), party D, who will use it to keep the customer index number (CIN) top secret to stop its use to link cryptographic keys to owners (just as social security numbers should be kept citizen secret). Instead of a customer index number (CIN), a message authentication cipher code (MAC code) of the customer index number (CIN) is made public called the MAC(CIN).

3). The public key generation authority, party G, pre-factory prepares smart media cards:

The public key generation authority, party G, pre-factory deposits a family key, FaK-F, copy into every blank smart media card before they are given to the public key distribution authority, party D, for eventual physical distribution to trusted media distribution companies, parties Vn, who in turn will factory distribute them to customers at retail stores and in the certified mail.

The party G will generate an incremented customer index number (CIN) which is kept top secret.

The party G will compute a message authentication cipher (MAC) of the customer index number (CIN) called the MAC(CIN) which is used as a public customer identification number.

Party G pre-factory generates public key/private key pairs with the private key always being kept top secret and the public key as public information,
{PuK-A, PrK-A},
{PuK-B, PrK-B,},
etc.
   for all customers, party A, party B, etc. and assigns them one by one to customers of unknown identity:
{CIN, MAC(CIN), PrK-A, PuK-A},
{CIN, MAC(CIN), PrK-B, PuK-B},
etc.

Party G pre-factory embeds into smart media card A, the values of:

G-FaK-F
{-----, MAC(CIN), PrK-A, PuK-A}

and into smart media card B, the values of:

G-FaK-F
{-----, MAC(CIN), PrK-B, PuK-B}

etc.

and imprints on the smart card exterior the public customer identification number, MAC(CIN), for identification, since, the central public key distribution authority (C-PuKDA), party D will have no access to the public keys or private keys inside.

Access to the private key field of the smart media cards will be done through an access code (e.g. passcode, passphrase, or password) which initial access code must be denied the Central Public Key Distribution Authority (C-PuKDA), party D, who can have no knowledge of private keys, Therefore, the initial access code is stored inside of a party G database given to a Public Key Access Code Authority (PuKAC) who will later contact the customer with the initial access code:

{

{-----, MAC(CIN), -----, PuK-A,

initial access code},

{-----, MAC(CIN), -----, PuK-B,

initial access code},

etc.

}

Party G gives the smart media cards to the party D who in turn will give them to authorized media distribution companies, parties Vn, for eventual sale to customers.

The party G gives a customer public key database without private keys to the central public key distribution authority (C-PuKDA), party D, for eventual publishing on the world wide web (WWW):

{CIN, MAC(CIN), -----, PuK-A},
{CIN, MAC(CIN), -----, PuK-B},
etc.

The party D will make all public keys without private keys or customer index number (CIN) publicly available over a smart media card system authority internet web server using digital certificate standards (e.g. International Telegraphy Union's (ITU's) X.509 standard).

{---, MAC(CIN), -----, PuK-A,

customer name, etc.},

{---, MAC(CIN), -----, PuK-B,

customer name, etc.},

This new method does not trust other public key systems already in use!!!!!!!!! Existing public key systems such as secure sockets layer (SSL) based public keys are not hacker safe and may be compromised which would give away multi-million dollar in value commercial digital masters for music and movies!!!!!!

The public key generation authority, party G, may destroy the private keys after smart card depositing for absolute privacy. The private keys are kept top secret.

Optionally the party G may use a central public key escrow authority (C-PuKEA), parties En, with a minimum of two escrow parties to hold the front half and the back half of split cryptographic keys, to hold split cryptographic keys.

{---, MAC(CIN), key split PrK-A, PuK-A},
{---, MAC(CIN), key split PrK-B, PuK-B},
etc.

4). The public key generation authority (C-PuKGA), party G, pre-factory prepares the cryptographic digital signal processors for transfer to the public key distribution authority (C-PuKDA), party D, for passing to the media distribution vendors, parties Vn, for eventual manufacturing into cryptographic media players [REF 508] for customer sale.

Party G pre-factory prepares the cryptographic digital signal processing integrated circuits eventually used inside of the cryptographic media players [REF 508] by hardware manufacturers.

Party G must pre-factory install cryptographic keys into the tamper resistant non-volatile electrically erasable programmable read only memory (TNV-EEPROM) of the cryptographic digital signal processing (C-DSP) integrated circuits (IC's).

A cryptographic, digital signal processing unit (C-DSP) includes:

cryptographic memory for crypto keys
and crypto algorithms,
hardware session key (1-time secret keys)
decryption circuits with hardware block error
detection and correction,
MPEG X digital decompression circuits,
digital audio/video signal processing
circuits,
digital artificial signal degradation
circuitry,
analog audio/video or
analog signal processing circuits with line
amplifiers for output to loudspeakers,
digital video signal modulation to analog
for output to computer displays (e.g. SVGA
monitors, UXGA monitors, etc.)

Party G installs the smart media card system authority system family key, called party P, FaK-F into the cryptographic digital signal processors (C-DSP's).

Party G generates a top secret vendor index number (VIN) for all media distribution vendors, parties Vn. Party G also generates a public vendor identfication number using a message authentication cipher of vendor index number (MAC(VIN)).

Party G generates vendor private key/public key pairs:

{VIN, MAC(VIN), PrK-Vn, PuK-Vn},
{VIN, MAC(VIN), PrK-Vn, PuK-Vn},
etc.

The whole set of public keys, PuK-Vn, indexed by vendor identification number (MAC(VIN) will be embedded into each and every cryptographic digital signal processor for eventual use in cryptographic media players:

{---, MAC(VIN), ------, PuK-Vn},
{---, MAC(VIN), ------, PuK-Vn},
etc.

Party G will distribute to the central public key distribution authority (C-PuKDA), party D:

{VIN, MAC(VIN), ------, PuK-Vn},
{VIN, MAC(VIN), ------, PuK-Vn},
etc.

Party D will distribute to each vendor, party Vn, only his own public key data including his own top secret vendor private key, PrK-Vn:
{VIN, MAC(VIN), PrK-Vn, PuK-Vn}

The public key generation authority, party G, may destroy the vendor private keys, PrK-Vn, after cryptographic digital signal processor depositing for absolute privacy. The private keys are kept top secret to each vendor.

Optionally the party G may use a central public key escrow authority (C-PuKEA), parties En, with a minimum of two escrow parties to hold the front half and the back half of split cryptographic keys, to hold split cryptographic keys.

{---, MAC(VIN), key split PrK-Vn, PuK-Vn},
{---, MAC(VIN), key split PrK-Vn, PuK-Vn},
etc.

Party G will also generate unique to each media distribution vendor, party Vn, a unique vendor secret key, SeK-Vn. Party G will give this vendor secret key to the central public key distribution authority for eventual distribution to each media distribution vendor of only his own top secret vendor private key which protects his own digital media masters.

{VIN, MAC(VIN), ------, SeK-Vn},
{VIN, MAC(VIN), ------, SeK-Vn},
etc.

Party G will embed the whole set of unique vendor secret keys, SeK-Vn, indexed by vendor identfication number (MAC(VIN)) into each and every cryptographic digital signal processor (C-DSP) for eventual manufacturing into cryptographic media players.

{VIN, MAC(VIN), ------, SeK-Vn},
{VIN, MAC(VIN), ------, SeK-Vn},
etc.

The public key generation authority, party G, may destroy the vendor secret keys, SeK-Vn, after cryptographic digital signal processor depositing for absolute privacy. The private keys are kept top secret.

Optionally the party G may use a central public key escrow authority (C-PuKEA), parties En, with a minimum of two escrow parties to hold the front half and the back half of split cryptographic keys, to hold split cryptographic keys.

{---, MAC(VIN), key split SeK-Vn},
{---, MAC(VIN), key split SeK-Vn},
etc.

Party G gives the programmed cryptographic digital signal processing integrated circuits to the central distribution authority, party D who will pass them to the media distribution vendors, parties Vn, for factory manufacture into cryptographic media players.

5). The public key generation authority (C-PuKGA), party G, may deposit important split cryptographic keys with the central public key escrow authority (C-PuKEA), parties En:
Optionally, the smart media card system authority-public key generation authority function may key split the cryptographic keys as into a front half and a back half and transfer the cryptographic keys to at least two separate public key escrow authorities. The public key escrow authority function handles the cases of customer lost smart media cards or customer stolen smart media cards or disputes over legal ownership of smart media cards as in divorse cases. This key escrow function allows the smart media card system authority to re-construct cryptographic data and cryptographic keys after lost or stolen smart media cards are reported which might otherwise represent data permanently lost to customers. Disputed legal ownership of smart media cards as in divorse or separation cases may also restore smart media card contents to rightful legal owners even if the smart card itself is not available to a court.
The cryptographic keys should be key split into at least a front half key and a back half key just like breaking it in half. The front half of all keys generated and issued is deposited by the smart media card system authority with a neutral key escrow agent in a computer relational database. The back half of all keys generated and issued is deposited by the smart media card system authority with an entirely separate neutral key escrow agent in a computer relational database.

It is assumed for convenience, payment, and legal ownership that each customer will usually have only one registered smart media card registered with the smart media card system authority for all of his own personal music and movies.

Party E1 receives (front key split halves of):

Customer private key pairs:

(

{---, MAC(CIN), front half PrK-A, PuK-A},
{---, MAC(CIN), front half PrK-B, PuK-B},
etc.

}.

Vendor private key, PrK-Vn, pairs:

{

{---, MAC(VIN), front half PrK-Vn},
{---, MAC(VIN), front half PrK-Vn},
etc.

}

Vendor unique secret key, SeK-Vn, pairs:

{

{---, MAC(VIN), front half SeK-Vn},
{---, MAC(VIN), front half SeK-Vn},
etc.

}

Party E2 receives (back key split halves of):

Customer private key pairs:

(

{---, MAC(CIN), back half PrK-A, PuK-A},
{---, MAC(CIN), back half PrK-A, PuK-A},
etc.

}

Vendor private key, PrK-Vn, pairs:

{

{---, MAC(VIN), back half PrK-Vn},
{---, MAC(VIN), back half PrK-Vn},
etc.

}

Vendor unique secret key, SeK-Vn, pairs:

{

{---, MAC(VIN), back half SeK-Vn},
{---, MAC(VIN), back half SeK-Vn},
etc.

}

### Central Public Key Distribution Authority (C-PuKDA)—Party D

The smart media card system authority, party S, has a dedicated function of a central public key distribution authority (C-PuKDA), party D:
which has knowledge of customer identifications and vendor identifications, but, no knowledge of whole cryptographic keys!!!!

1). Input:

Party D receives from the central public key generation authority (C-PuKGA), party G, the following:

Party D receives from party G who generates from true random noise:
the system family key (FaK-F)
   which is a common secret keys (SeK-F) where party F is the common family, which is given to the public key distribution authority, party D, for eventual pre-factory distribution to trusted media distribution companies, party Vn.

Party D receives from party G, the initialization vector (IV). Party D will use it to keep the customer index number (CIN) top secret to stop its use to link cryptographic keys to owners (just as social security numbers should be kept citizen secret). Instead of a customer index number (CIN), a message authentication cipher code (MAC code) of the customer index number (CIN) is made public called the MAC(CIN).

Party D will receive from party G a customer public key database without private keys to the central public key distribution authority (C-PuKDA), party D, for eventual publishing on the world wide web (WWW) without the top secret customer index number (CIN):

{CIN, MAC(CIN), -----, PuK-A},
{CIN, MAC(CIN), -----, PuK-B},
etc.

Party D receives from party G the pre-factory programmed smart media cards who in turn will give them to authorized media distribution companies, parties Vn, for eventual sale to customers.

Party receives from party G media distribution vendor databases:

{VIN, MAC(VIN), ------, PuK-Vn},
{VIN, MAC(VIN), ------, PuK-Vn},
etc.

Party D will distribute to each vendor, party Vn, only his own public key data:
{VIN, MAC(VIN), ------, PuK-Vn}

Party D receives from party G who will also generate unique to each media distribution vendor, party Vn, a unique vendor secret key, SeK-Vn Party G will give this vendor secret key to the central public key distribution authority for eventual distribution to each media distribution vendor.

{VIN, MAC(VIN), ------, SeK-Vn},
{VIN, MAC(VIN), ------, SeK-Vn},
etc.

Party D receives from party G who will embed the whole set of unique vendor secret keys, SeK-Vn, for every party Vn into each and every cryptographic digital signal processor (C-DSP) for eventual manufacturing into cryptographic media players.

{VIN, MAC(VIN), ------, SeK-Vn},
{VIN, MAC(VIN), ------, SeK-Vn},
etc.

Party D receives from party G the pre-factory programmed cryptographic digital signal processor integrated circuits and party D will in turn distribute the chips to the media distribution companies, parties Vn, for manufacturing into cryptographic media players and for further factory use and eventual customer distribution at retail stores.

2) Party D keeps a top secret computer database record of:

{

authorized media distribution vendor

index number (top secret) (VIN),

public vendor identification number =

message authentication cipher (MAC) of vendor
index number (MAC(VIN)),

{---,
MAC(CIN),
-----,
PuK-n,
eventual registered customer name

(retail store registered, Web registered, or
registration postcard, or media distribution vendor
database updates)

},

}

Party D look-up of customer name in this top secret database will give the top secret customer index number (CIN). Use of the message authentication cipher (MAC) seeded with the initialization vector (IV) upon the customer index number (CIN) will produce a message authentication cipher code (MAC code) which can be handed to the central public key escrow authorities, parties En, to retrieve key split cryptographic keys and family keys and also used to index the initial smart media card access code database held by the Central Public Key Access Code Authority (C-PuKAC), party EA for mailing or transmitting the initial access code to customers.

3). Party D pre-factory distributes the smart media card system authority system family key, FaK-F, to the media distribution companies, parties Vn.

4). Party D gives the programmed cryptographic digital signal processing (DSP) integrated circuits to the authorized media distribution vendors who will factory manufacture them into cryptographic media players.

Party D keeps a top secret computer database record of:

{

{VIN,
MAC(VIN),
------,
PuK-Vn,
------,
vendor identification such as name, address,

etc.

},

}

5). Party D distributes to each media distribution vendor, Vn, his own, unique secret key (SeK-Vn). Party G has already key split these secret keys for deposit with the neutral, key escrow parties, party E1 and party E2.

Party D distributes to each media distribution vendor, Vn, his own, unique vendor private key (PrK-Vn) with a message authentication cipher of vendor identification number (MAC(VIN)). Party G has already key split these secret keys for deposit with the neutral, key escrow parties, party E1 and E2.

Party D distributes to each media distribution vendor, Vn, his plain text vendor identification number which consists of the message authentication cipher of the vendor index number (MAC(VIN)) (for system family key encryption and download with encrypted media to customers to identify the vendor).

6). Party D publishes the customer public key database for use by the media distribution vendors, Vn:

{---, MAC(CIN), -----, PuK-A},
{---, MAC(CIN), -----, PuK-B},
etc.

7). Party D gives to the Central Public Key Access Code Authority (C-PuKAC), Party EA, a top secret computer database record to help in mailing initial access codes to customers of:

{

--------,
public media distribution vendor

identification = message authentication cipher
(MAC) of vendor index number MAC(VIN)),

{---,
MAC(CIN),
-----,
PuK-n,
eventual registered customer name

(retail store registered, Web registered, or
registration postcard)

},

}

### Central Public Key Escrow Authorities (C-PuKEA)—Parties En

The smart media card system authority, party S, has a dedicated function of a central public key escrow authority (C-PuKEA), parties En:
which has knowledge of split cryptographic keys, but, no knowledge of whole cryptographic keys, customer identifications and vendor identifications!!!!

1). Input.

The parties En may optionally receive from the party G (with a minimum of two escrow parties to hold the front half and the back half of split cryptographic keys, to hold split cryptographic keys):

{---, MAC(CIN), key split PrK-A, PuK-A},
{---, MAC(CIN), key split PrK-B, PuK-B},
etc.

The parties En may optionally receive from the party G (with a minimum of two escrow parties to hold the front half and the back half of split cryptographic keys, to hold split cryptographic keys):

{---, MAC(VIN), key split PrK-Vn, PuK-Vn},
{---, MAC(VIN), key split PrK-Vn, PuK-Vn},
etc.

The parties En may optionally receive from the party G (with a minimum of two escrow parties to hold the front half and the back half of split cryptographic keys, to hold split cryptographic keys):

{---, MAC(VIN), key split SeK-Vn},
{---, MAC(VIN), key split SeK-Vn},
etc.

2). An independent function of the smart media card system authority (C-PuKEA), party S, is the central public key escrow authorities, parties En (a minimum of parties E1 and E2),

3). This authority takes care of customer lost, stolen, and legally disputed smart media cards.

Party E1 receives (front key split halves of):
key split smart media card system family key (FaK-F),
key split initialization vector (IV) used as a secret key (SeK) for the message authentication cipher (MAC) used upon the top secret, customer index number
(whole message authentication cipher code of customer index number (MAC(CIN)),
key split public key pair n (PuK-n, N),
key split private key pair n (PrK-n, N)).

Party E2 receives (back key split halves of):
key split smart media card system family key (FaK-F),
key split initialization vector (IV) used as a secret key (SeK) for the message authentication cipher (MAC) used upon the top secret, customer index number (CIN).
(public customer identification code=whole message authentication cipher (MAC) code of customer index number (MAC(CIN)),
key split public key pair n (PuK-n, N),
key split private key pair n (PrK-n, N)).

4). Customer smart media cards which are lost, stolen, or of disputed legal ownership must be handled to preserve use of custom, encrypted digital media still in customer ownership. This is initiated by customers, party A, contacting the central public key distribution authority (C-PuKDA), party D who in turn will contact the parties En using the public customer identification number or MAC(CIN) to retrieve split cryptographic customer keys.

### Central Public Key Access Code Authorities (C-PuKAC)—Parties EAn

The smart media card system authority, party S, has a dedicated function of a central public key access code authority (C-PuKAC), parties EAn:
which has knowledge of smart media card initial access codes and customer identifications in order to mail initial access codes to customers, but, has absolutely no access to smart media cards and no knowledge of whole cryptographic keys!!!!

1). Input.

Party EA receives from the Central Public Key Generation Authority (C-PuKGA), party G, the initial access code database.

{

{-----, MAC(CIN), -----, PuK-A,

initial access code},

{-----, MAC(CIN), -----, PuK-B,

initial access code},

etc.

}

Party EA receives from the Central Public Key Distribution Authority (C-PuKDA), Party D, a top secret computer database record to help in mailing initial access codes to customers of:

{

authorized media distribution vendor id

(VIN),

{---,
public customer identification number

(MAC(CIN)),

-----,
customer n's public key (PuK-n),
eventual registered customer name

(retail store registered, Web registered, or
registration postcard)

},

}

2). The Public Key Access Code Authority (PuKAC), party EA, will later mail in secure certified mail or transmit over Secure Sockets Layer (SSL) to each customer his own initial access code. The initial access code gives customer access to use of his private key field and does not compromise session keys or digital masters.

### Authorized Media Distribution Vendors—Parties Vn

The authorized media distribution vendors, parties Vn:
have no knowledge of whole customer cryptographic keys, but, have knowledge of customer identifications!!!!!

A cryptographic algebra notation implemented in the central media world wide web (WWW) server, party Vn (distribution), for each customer, party A, party B, party C, party E (reserved for key escrow companies), party F (reserved for the common secret family key), party G, party H, etc. is as follows:
1). Input
   Party Vn receives from the public key distribution authority (C-PuKDA), party D, pre-factory distributed cryptographic keys:
   A). The distribution party, party Vn, the smart media card used by the customer party A (unavailable to the customer himself in secure, tamper resistant, non-volatile, electrically erasabel programmable read only memory (TNV-EEPROM), in short called cryptographic memory) has a pre-factory, party G installed system family key (FaK-F). The cryptographic media player [REF 508] has a pre-existing, pre-factory, party G installed system family key (FaK-F) in cryptographic memory.
   B). The media distribution company, Vn, has a party G, pre-factory distributed unique vendor secret key (SeK-Vn), stored in cryptographic memory. Any authorized cryptographic media player [REF 508] also receives from party G an entire set of pre-factory distributed unique secret keys, SeK-V1 to Vn for all vendors stored in its cryptographic memory.
   C). The media distribution company, Vn, has a party G, pre-factory distributed unique vendor private key (PrK-Vn), stored in cryptographic memory.
      Any authorized cryptographic media player [REF 508] also receives from party G an entire set of pre-factory distributed unique public keys, PuK-V1 to Vn for all vendors stored in its cryptographic memory.
2). The distribution party Vn's computation in his physically secure, media distribution company central office:
   These following steps are done in a secure office computer with only a proxy server local area network connection to an internet server (hacker accessible) and also with no phone line access to protect the unencrypted digital masters.
   The media distribution party, party Vn, uses his unique message authentication code (MAC) of vendor index number (MAC(VIN)) (the message authentication cipher is not known by the party Vn) as the public vendor identification number (MAC(VIN)) in order to download his public vendor identification number along with an incremented session id number to customers for indexing of the downloaded custom encrypted digital media and also cross-indexing with the encrypted play code with header and encrypted play count with header.

The custom encrypted digital media is defined as:

{
vendor identification number MAC(VIN)),
session id number,
play code (SsK-A) encrypted digital media,
}

The encrypted play code with header is defined as:

{vendor identification number (MAC(VIN)),
session id number,
customer public key (PuK-A) encrypted,
{
vendor secret key (SeK-Vn) encrypted

{vendor digitally signed (PrK-Vn) play

code,

sequence number},

---------,
}
}

The play code is defined as the session key (1-time secret key) used to custom encrypt the digital media.
The play count is defined as:
   play count=paid for number of plays, −1 for an infinite count, or count of free trial plays.

The encrypted play count with header is defined as:

{vendor identification number MAC(VIN)),
session id number,
customer public key (PuK-A) encrypted

{
vendor secret key (SeK-Vn) encrypted
{vendor digitally signed (PrK-Vn) play count,
sequence number},
---------,
}

}

The media distribution vendor, Vn, uses his smart media card system authority issued system family key, FaK-F, to family key pass-thru encrypt the encrypted play count with header, the encrypted play code with header all with sequence numbers to stop recorded replay attacks for download to the customer, party A.

$$Vn - FaK - F ( ( encrypted play count with header ) ) = V .$$
The media distribution vendor, party Vn, electronically web bills the customer, party A, over the internet to the prior art customer personal computer A by using credit card numbers transacted over a secure sockets layer (SSL) non-cryptographically secure transaction line.
Sequence numbers—The sequence number is needed to prevent recorded replay attacks on wiretappable buses of pass-thru encrypted signals inside of the cryptographic media player. The sequence number can only be incremented by a party with the vendor secret key (SeK-Vn), customer private key (PrK-n), and system family key (FaK-F) who are the party G for any vendor, the party Vn only for his own play codes and play counts, or the cryptographic media player, party P, for any vendor which player has a collection of all vendor secret keys (SeK-V1 to Vn) and a collection of all vendor public keys (PuK-V1 to Vn). The cryptographic media player, party P, can also check the vendor digital signature, and can obtain the customer A's private key (PrK-A) and public key (PuK-A) from customer's inserted smart media card A.
The party Vn pass-thru encrypts the play count with header for transfer as:

system family key encrypted (Vn-FaK-F):

{vendor identification number MAC(VIN),
session id,
customer public key (PuK-A) encrypted
{
vendor secret key (SeK-Vn) encrypted

{vendor digitally signed (PrK-Vn) play count,
sequence number
},

----------,
}
}= V.

which is in cryptographic algebra short-hand notation:

Vn-FaK-F

(
MAC(VIN),
session id,
PuK-A(
SeK-Vn(

PrK-Vn(play count), sequence number),

))

The media distribution vendor, party Vn, uses a true random number generator to create a play code or session key (SsK-A), for customer, party A. The session key is database recorded by party Vn, indexed by the public vendor identification number (MAC(VIN)) along with the digital media title downloaded and date and time.

{
vendor identification number (MAC(VIN)),
play code or session key (SsK-A),
customer A public key (PrK-A),
digital media title downloaded,
day of distribution,
month of distribution
year of distribution,
time of distribution,
------,
}

The media distribution company, party Vn, digitally signs the play code or session key (Vn-SsK-A), with its own top secret media distribution vendor private key (PrK-Vn), (this is not an encryption step because any holder of the public key (PuK-Vn) can de-scramble the session key):
   Vn-PrK-Vn(Vn-SsK-A)=W.
The media distribution company, party Vn, wishes to keep this play code or session key (SsK-A),
   top secret from any customers and from any other vendors
which will reveal his multi-million dollar digital masters to digital media competitors.
Party Vn also uses his top secret, unique, secret key (SeK-Vn), to encrypt (1st encryption) the result W and an incremented sequence number to prevent recorded replay hacker attacks. A recorded replay hacker attack is a hacker who wiretaps open computer buses for digital recording and then simply re-introduces the value at a later time without ever decrypting it. Pass-thru encryption of fixed values is vulnerable to recorded replay hacker attacks.
Sequence Number—The sequence number is needed to prevent recorded replay attacks on wiretappable buses of pass-thru encrypted signals inside of the cryptographic media player. The sequence number can only be incremented by a party with the vendor secret key (SeK-Vn), customer private key (PrK-n), and system family key (FaK-F) who are the party G for any vendor party Vn only for his own play codes and play counts, or the cryptographic media player, party P, for any vendor which player has a collection of all vendor secret keys (SeK-V1 to Vn) and a collection of all vendor public keys (PuK-V1 to Vn). The cryptographic media player, party P, can also check the vendor digital signature, and can obtain the customer A's private key (PrK-A) and public key (PuK-A) from customer's inserted smart media card A.
The vendor's own secret key is shared only with the key escrow agents, parties E1 and E2, and a copy kept in the cryptographic media player [REF 508]:
   Vn-SeK-Vn(W, sequence number)=X.
The media distribution company, party Vn, can use the play code or unique session key, SsK-A, to uniquely encrypt only party A's digital media masters on the secure office computer before proxy server transfer to a publicly (hacker) accessed internet server or world wide web server.
   Vn-SsK-A(digital media)
   where:
   Vn-SsK-A(data) means party Vn doing session key encryption using party A's play code or session key (1-time secret key) upon digital data.
The following steps can be done by using a proxy server local area network connection to move the encrypted result X and also the uniquely encrypted digital media masters to a world wide web server (with a firewall).
3). 1-way transfer and custom session key encrypted media's unique session key (1-time secret key), SsK-A, used only for customer party A's digital medium:
   The following steps can be done by using a proxy server local area network connection to move the encrypted result X and also the uniquely encrypted digital media masters to a world wide web server (with a firewall and anti-viral software updated weekly and run daily).
   The media distribution company, party Vn, wishes to restrict this result X uniquely to customer A's smart media card. Party Vn encrypts (2nd encryption) the result X with the public key of Party A (PuK-A) which only Party A can decrypt with his private key A (PrK-A) stored inside of his smart media card:
      Vn-PuK-A(X)=Y.
   The media distribution company, party Vn, wishes to restrict result Y to trusted system parties. The media distribution company, party Vn, system family key (common secret key) to pass-thru encrypt (3rd encryption) the result Y with the system family key, FaK, while careful not to pass-thru encrypt the result twice which will undo the pass-thru encryption:
      Vn-FaK-F(Y)=Z.

The summation Z of these cryptographic operations becomes the encrypted play code or encrypted session key part of the encrypted play code with header:

encrypted play code with header =
pass-thru encrypted:
{vendor indentification number (MAC(VIN)),
session id,
customer A public key encrypted,
vendor secret key encrypted

{vendor digitally signed play code,
sequence number},

--------,
}

or in cryptographic algebra short-hand notation is:

Vn-FaK-F(
MAC(CIN),
session id,
PuK-A(

Vn-SeK-A
(Vn-PrK-Vn(Vn-SsK-A), sequence no)

))

Sequence numbers—The sequence number is needed to prevent recorded replay attacks on wiretappable buses of pass-thru encrypted signals inside of the cryptographic media player. The sequence number can only be incremented by a party with the vendor secret key (SeK-Vn), customer private key (PrK-n), and system family key (FaK-F) who are the party G for any vendor, the party Vn only for his own play codes and play counts, or the cryptographic media player, party P, for any vendor which player has a collection of all vendor secret keys (SeK-V1 to Vn) and a collection of all vendor public keys (PuK-V1 to Vn). The cryptographic media player, party P, can also check the vendor digital signature, and can obtain the customer A's private key (PrK-A) and public key (PuK-A) from customer's inserted smart media card A.
where the notation used is:
A-SeK-B(data) means party A doing secret key encryption using party B's secret key upon the clear text data.
SeK means a secret key
FaK means a family key
(common secret key)
PuK means a public key
PrK means a private key
SsK means a session key (1-time secret key)
Party F is the family party or set of parties holding the family key (common secret key)

4). Establishment of a media header to help retrieve data from a customer, party A's, smart media card:

{vendor indentification number (MAC(VIN)),
session id number,
encrypted {play count, sequence number},
,
}
{vendor indentification number (MAC(VIN)),
session id number,
encrypted {play code, sequence number},
,
}
pair to download as an identification header at the start
of custom encrypted digital media.
Followed by the custom encrypted digital media of:
{vendor indentification number (MAC(VIN)),
session id number,
play code encrypted digital media,
,
}

5). Media distribution vendor, Party Vn, internet world wide web (WWW) download of the encrypted play code with header and encrypted play count with header to the customer A's smart media card A inserted into a smart card reader attached to his personal computer, followed by download of the custom encrypted digital media to the customer A's physical digital media inserted into a drive on his personal computer.

6). Database records for each customer A, party A:

{vendor identification number (MAC(VIN)),

{customer identification of party A such

as name, address, etc.,
MAC(CIN),
PuK-A,
{date/time,
date, month, year,
title of digital media downloaded,
session id number,
play code or session key,
paid for amount,
},
{date/time,
date, month, year,
title of digital media downloaded,
session id number,
play code or session key,
paid for amount,
},
etc.

}

7). Only if a smart media card is directly purchased and registered with the party Vn, a media distribution vendor database of customer identifications must be kept and updates sent to the Central Public Key Distribution Authority (C-PuKDA) who will notify the Central Public Key Access Code Authority (C-PuKAC), party EA, such that party EA can certified mail or securely electronically transmit an initial smart media card access code to the customer.

### Customers—Party A

The customers, party n, such as party A, party B, etc. (party D, E, F, G, P, S already in use)
which has knowledge of customer identifications and vendor identifications and his own access code to a particular smart media card for toggle field entry into a cryptographic media player, but, no knowledge of whole cryptographic keys stored in cryptographic memory!!!!

Unique customer A, party A, only once must:
1). Pick up at the retail store a cryptographic media player, a smart media card, and registers the smart media card indirectly with the media distribution vendor or else directly with the Central Public Key Distribution Authority (C-PuKDA), party D, giving his customer name, customer address, etc.
2). Receive from the Central Public Key Access Code Authority (C-PuKAC), party EA, his initial access code to the smart media card which may be changed later.

Unique customer A, party A, upon every custom encrypted digital media download at his prior art world wide web (WWW) connected personal computer:
1). The system family key encrypted vendor indentification number (MAC(VIN)), is downloaded to the customer A's personal computer and to his smart media card (as part of the encrypted play code with header:

play code with header=

{vendor identification number (MAC(VIN)),
session id,
encrypted {play code, sequence number},
)

to ultimately identify the media vendor to the cryptographic media player.

2). This custom encrypted digital media data which is preceeded by a media identification header:

{vendor indentification number (MAC(VIN)),
session id number,
play code encrypted digital media
}

This custom encrypted digital media with media header is internet world wide web downloaded by party Vn to party A's personal computer which transfers the encrypted digital media to a prior art personal computer's prior art peripheral drive containing either digital versatile disk read/write, or compact disk record once, or FLASH memory card. The unique encrypted session key, SsK-A, is transferred through the personal computer smart card reader to an inserted smart media card A.
3). The encrypted physical media and the smart card are transferred by party A to his cryptographic media player [REF 508].

### Authorized Cryptographic Media Player—Party P

The authorized cryptographic media players, party P [REF 508]:
which have knowledge in cryptographic key memory of the system family key for pass thru encryption, all vendor public keys, and all vendor secret keys, but, no knowledge of customers or cryptographic media!!!!

A cryptographic algebra notation implemented in party A's cryptographic media player [REF 508] having a built-in smart media card reader with party A's smart media card inserted which plays the custom encrpyted digital media using a cryptographic digital signal processor [REF 500], [REF 504] as follows:
1). the custom encrypted physical digital media is installed by customer A in his cryptographic digital media player (e.g. compact disk record once, digital versatile disk read/write, flash bank programmable solid state memory cards, digital cassette tape, etc.).
2). the customer A's own smart media A is installed into the built-in smart media card reader in the cryptographic media player.
3). the cryptographic digital signal processor in the cryptographic media player, party P, retrieves the plain text media header:
   {vendor indentification number (MAC(VIN)), session id, play code encrypted digital media}
at the start of the media.
4). the cryptographic digital signal processor in the cryptographic media player, party P, does customer triangle authentication to prevent use of lost or stolen smart media cards from:
   point 1, smart media card A,
   point 2, authorized cryptographic media player, party P, and
   point 3, authorized customer A, party A, from a toggle field entered passcode with a mini-display (e.g. one line liquid crystal display).
Passphrase/passcode entry into a prior art computer keyboard or else a toggle field device with I-line display such as a liquid crystal display on the cryptographic media player [REF 508].
5). the cryptographic digital signal processor in the cryptographic media player, party P, checks for the correct physical custom encrypted media matched with the correct smart media card by doing media triangle authentication:
   point 1, smart media card A with payed for encrypted play codes and encrypted play counts,
   point 2, authorized cryptographic media player,
   point 3, custom encrypted media A.
6). the cryptographic digital signal processor in the cryptographic media player, party P, retrieves using system family key pass-thru encryption with sequence numbers to avoid recorded replay hacker attacks, the party A's private key, PrK-A, from party A's smart media card A to its own tamper resistant memory. This should be the only private key on the smart media card.
7). the cryptographic digital signal processor in the cryptographic media player, party P, retrieves the encrypted play count with sequence numbers to avoid recorded reaply hacker attacks, from smart media card A, and decrypts it. Where:
   play count =paid for number of plays, or =1 for infinite play, or count of free trial plays.
If the decrypted play count is greater than one,
   play count)>0 indicates paid for or free trial plays still remaining

The play count is decremented for accounting purposes, re-encrypted with a increased sequence number to avoid recorded replay hacker attacks):

$$P - FaK - F ( P - SeK - Vn ( P - PrK - Vn ( decremented play count , incremented sequence number ) ) )$$

and then sent back to the smart media card A for storage. If the play count is zero, further media plays or custom decryptions are disallowed.

8). the cryptographic digital signal process in the cryptographic media player, party P, using the

{
vendor identification number (MAC(VIN)),
session identification number,
play code encrypted digital media
}

identification header from the encrypted digital media, retrieves the encrypted play code with header:

{
vendor identification number (MAC(VIN)),
session identification number,
encrypted {play code, sequence number},
}

which may be one of many encrypted play codes even from different vendors stored in his smart media card A which is transferred to the cryptographic media player's own tamper resistant memory. The encrypted play code with sequence number is already digitally signed by the media distribution vendor's private key, PrK-Vn, and then 3-way encrypted:

```
Vn-FaK-F(Vn-PuK-A(Vn-SeK-Vn
  (Vn-PrK-Vn(Vn-SsK-A, sequence number)))) =
    encrypted play code or
    encrypted session key
NOTE:
Sequence Number—The sequence number is needed to prevent recorded replay attacks on wiretappable buses of pass-thru encrypted signals inside of the cryptographic media player. The sequence number can only be incremented by a party with the vendor secret key (SeK-Vn), customer private key (PrK-n), and system
# family key (FaK-F) who are the party G for any vendor, the party Vn only for his own play codes and play counts, or the cryptographic media player, party P, for any vendor which player has a collection of all vendor secret keys (SeK-V1 to Vn) and a collection of all vendor public keys (PuK-V1 to Vn). The player
# can also check the cryptographic media player, party P, digital signature, and can obtain the customer A's provate key (PrK-A) and public key (PuK-A) from customer's inserted smart media card A.
```

cryptographic media player. The sequence number can only be incremented by a party with the vendor secret key (SeK-Vn), customer private key (PrK-n), and system family key (FaK-F) who are the partly G for any vendor, the party Vn only for his own play codes and play counts, or the cryptographic media player, party P, for any vendor which player has a collection of all vendor secret keys (SeK-V1 to Vn) and a collection of all vendor public keys (PuK-V1 to Vn). The player can also check the cryptographic media player, party P, digital signature, and can public key (PuK-A) from customer's inserted smart media card A.
9). The cryptographic digital signal processor inside of the cryptographic media player, party P, having all authorized system vendor public keys, PuK-Vn, and all authorized system vendor secret keys, SeK-Vn, which are pre-factory installed by the public key generation authority, party G, must retrieve only the unique vendor's Vn's public key, PuK-Vn, and secret key, SeK-Vn, using the vendor identification number from step 1) and step 5).

10). The cryptographic digital signal processor inside of the cryptographic media player, party P, uses the system family key (FaK-F), for pass-thru decryption, the customer's private key (PrK-A) obtained from the inserted smart media card A, the vendor Vn's unique secret key (SeK-Vn), to decrypt the digitally signed play code with sequence number, and finally the vendor Vn's unique public key (PuK-Vn) to digitally descramble the play code to give the fully unencrypted play code or session key (1-time secret key):

```
P-SeK-Vn
  (P-PuK-A
  (P-FaK-F
    (encrypted play code with header)
  )) =
  vendor digitally signed play code
    (PrK(play code)),
  sequence number.
P-PuK-Vn(vendor digitally signed play code) =
  play code.
NOTE:
Sequence Number—The sequence number is needed to prevent recorded replay attacks on wiretappable buses of pass-thru encrypted signals inside of the cryptographic media player. The sequence number can only be incremented by a party with the vendor secret key (SeK-Vn), customer private key (PrK-n), and system
# family key (FaK-F) who are the party G for any vendor, the party Vn only for his own play codes and play counts, or the cryptographic media player, party P, for any vendor which player has a collection of all vendor secret keys (SeK-V1 to Vn) and a collection of all vendor public keys (PuK-V1 to Vn). The cryptographic media player,
# party P, can also check the vendor digital signature, and can obtain the customer A's private key (PrK-A) and public key (PuK-A) from customer's inserted smart media card A.
```

11). The party A's cryptographic digital signal processor, party P, uses the unencrypted play code or session key (D-SsK-A), to decrypt the session key (1-time secret key) encrypted digital medium from party Vn.
12). The party A's cryptographic digital signal processor will artifically digitally degrade video and audio signals before conversion to analog signals for output to speakers or video displays. This effect will help counter digital recorders wiretapping analog output for music and movie piracy criminal intentions.

A fully digital movie projector using micro-mirror machine (MMM) modules can input encrypted media directly if it has its own decryption digital signal processor function without wiretapping points.

Fully digital loudspeakers can work in a likewise manner with encrypted media.

### Customers—Party A

The customers, party n, such as party A, party B, ect. (party D, E, F, G, P, S already in use)
which has knowledge of customer identifications and vendor identifications and his own access code to a particular smart media card for toggle field entry into a cryptographic media player, but, no knowledge of whole cryptographic keys stored in cryptographic memory!!!!
   for use in lost, stolen, or legally disputed ownership smart media cards.
1). Must contact the central public key distribution authority (C-PuKDA), party D, with his customer name and public customer identification number (MAC(CIN)) to cancel the old smart media card.

2). Party D will mark the old smart media card as cancelled in his database.

{

authorized media distribution vendor

identification number (MAC(VIN)),

{---,
customer identification number (MAC(CIN)),
-----,
customer's public key (PuK-n),
eventual registered customer name

(retail store registered,
Web registered, or
registration postcard),

lost/stolen/disputed legal ownership field,
},

}

3). Party D will use the public customer identification number (MAC(CIN)) to contact the central public key escrow authorities, parties En, to obtain the split customer private keys from their databases which are indexed by this number, since, the parties En have absolutely no knowledge of customer identities.
4). Party D will use the public customer identification number (MAC(CIN)) to contact the media distribution vendors, parties Vn, to obtain all the issued encrypted play codes with header (encrypted session keys (SsK-A) also known as 1-time secret keys) and encrypted play counts used by customer A. The encrypted play counts may not be up to date or matching of the encrypted play counts in the lost or stolen smart media card, but, if infinite plays are allowed this is acceptable.

The parties Vn have the database records:

{vendor index number (VIN),
vendor identification number (MAC(VIN)),

{customer identification party A such

as name, address, etc.
---,
customer identification number (MAC(CIN)),
public key of customer A (PuK-A),
{date/time,
download date,
download month,
download year,
download time,
title of digital media downloaded,
session id number,
paid for amount,
play code or session key,
play count,
},
{date/time,
download date,
download month,
download year,
download time,
title of digital media downloaded,
session id number,
paid for amount,
play code or session key,
play count,
},
etc.

}

5). Party D will issue a new smart media card with the previous customer A, private key A, PrK-A, and matching public key A, PuK-A, with the previously issued play codes and play counts. The new smart card will work with existing custom encrypted physical media.

For use in legal transfer of entire ownership of a smart media card A and all custom cryptographic media associated with it from party A to party B. This is called legal “first use.”

This is accomplished by use of a cryptographic media player [REF 508] to read from customer party A's smart media card the tamper resistant memory the encrypted 3-way encrypted and digitally signed play code or session key (SsK) with header:

```
Vn-Fak-F(Vn-PuK-A(Vn-SeK-Vn(
  play code with header)
  )) =
  3-way encrypted and digitally signed play
    code with header,
NOTE:
Sequence Number—The sequence number is needed to prevent recorded replay attacks on wiretappable buses of pass-thru encrypted signals inside of the cryptographic media player. The sequence number can only be incremented by a party with the vendor secret key (SeK-Vn), customer private key (PrK-n), and system
# family key (FaK-F) who are the party G for any vendor, the party Vn only for his own play codes and play counts, or the cryptographic media player, party P, for any vendor which player has a collection of all vendor secret keys (SeK-V1 to Vn) and a collection of all vendor public keys (PuK-V1 to Vn).
# The cryptographic media player, party P, cna also check th evendor digitla signature, and can obtain the customer A's provate key (PrK-A) and public key (PuK-A) from customer's inserted smart media card A.
```

where
   Vn=the media distribution party
   F=family key or group secret key
   A-PuK-B=party A using the public key for party B

The cryptographic media player [REF 508], party P, can partially decrypt party A's play codes or session key (SsK-A) in his smart media card A, and re-encrypt it over to party B's play codes or session key (SsK-B),

by the decryption steps:

```
P-SeK-Vn(P-PrK-A(P-FaK-F(
  encrypted play code with header)
  ))
  =
    {
    vendor identification number (MAC(VIN)),
    session identification number,
    vendor digitally signed play code,
    incremented sequence number
    }
    = Y.
```

and then the re-encryption steps:
P-FaK-F(P-PrK-B(P-SeK-Vn(Y)))=Z,
   which changes the private key encryption of customer A to the private key encryption of customer B. The re-encrypted play code with header, Z, can be returned to the smart media card of party B.

1-28. (canceled)

29. A specific method of or process for doing public key cryptography over an open systems networking architecture in a totally cryptographically secure manner meant for safeguarding multi-million dollar digital masters which open systems network architecture includes existing prior art components integrates into a specific new invention system process of or methods patent of public key cryptography comprising of the steps of:
providing of prior art, a tamper-resistant non-volatile electrically erasable programmable read-only memory (TNV-EEPROM) which can be in an external dedicated chip and also in an on-chip micro-controller design, which is used to hold embedded, brief in length, cryptographic computer programs, cryptographic system keys with first example cryptographic keys being family keys or shared secret keys, second example cryptographic keys being cryptographic private keys, third example cryptographic keys being secret keys, fourth example cryptographic keys being session keys, and fifth example cryptographic keys being cryptographic public keys,
providing of prior art, an electrically erasable programmable read-only memory (EEPROM) which can come in a larger dedicated chip and also in an on-chip micro-controller design, used to hold, non-secure, computer programs (firmware) which are usually stored on separate and dedicated EEPROM memory chips which are connected to the digital computer processor through an input-output (I/O) bus with an on-processor instruction cache usually made of two layers: a L1 cache of faster, static RAM, and a L2 cache of very fast, associative memory or on-chip banked registers used to locally hold pages of operational codes (op codes) for fast execution,
providing of prior art, a static random access memory (SRAM) which can come in a larger dedicated chip and also in an on-chip micro-controller design with an on-chip input-output (I/O) bus with SRAM preferred over DRAM on-chip for faster speed and no need of a memory refresh cycle at the cost of one-fourth less bit density, for faster temporary storage of dynamic data which is usually in the form of separate and dedicated SRAM memory chips which are connected to the digital computer processor through an input-output (I/O) bus with an on-processor data cache of one or more levels (L1 cache being SRAM and L2 cache being associative memory or registers) used to locally hold pages of dynamic computer data for fast data cache access,
providing of prior art, a dynamic random access memory (DRAM) which can come in a larger dedicated chip and also in an on-chip micro-controller design using an on-chip input-output (I/O) bus with on-chip SRAM preferred over DRAM in micro-controllers for faster speed and no memory refresh cycle, with the latest example of fast DRAM being duo-data rate, synchronous, dynamic random access memory (DDR-SDRAM) which can hold either operational codes (for non-firmware based computer programs) or dynamic data (especially large arrays and large chunks of data such as video ‘frame buffers’), with the DRAM being an acknowledged bottle-neck on the central processor unit (CPU) bus with another greater bottle-neck being the transfer of digital data over the peripheral device or input-output (I/O) bus and its much slower often electromechanical input-output (I/O) devices,
providing of prior art, a low-cost, low-throughput, cryptographic embedded micro-controller (c-uCtlr) with scalar control operations, slow fixed-point arithmetic processing, and very slow, floating point interpreter based floating point processing (lacking a hardware floating point unit (FPU)), as used in a prior art, 8-bit, single chip solution, micro-controller based, smart card as widely used in Europe for over twenty years with universal success over-coming in all forms of human abuse and adverse weather conditions, with said tamper resistant non-volatile memory, random access memory (TNV-EEPROM), holding both cryptographic keys and very limited amounts of embedded secure cryptographic algorithm firmware for the entirely on-chip execution of cryptographic algorithms (secret key encryption-decryption, public key encryption-decryption, message digest ciphers (MDC's), message authentication ciphers (MAC's)), furthermore, possessing an on-chip input-output (I/O) bus in a micro-controller architecture with on-chip limited, static random access memory (SRAM) for fast dynamic data storage, and on-chip limited electrically erasable programmable read only memory (EEPROM) for computer firmware program storage, furthermore, possessing a wiretapable (‘red’) smart card serial data bus to the external world which is used for initial unique customer access code communications from a digital computer into the smart card to activate it, and then is subsequently used for reverse direction communications of internal smart card secure memory values representing cash to debit and also accounting access counts used in pass-thru encryption to transfer encrypted (‘cipher-text’) data from the cryptographic micro-processor (c-uP) inside the smart card to a smart card reader and pass-by processing proceeding to a digital computer which must do pass-thru decryption and pass-thru encryption for the return closed feed-back response communications exchange of possibly debited monetary values or incremented access counts needing secure storage in the smart card,
providing of prior art, the smart card used for media ticket applications containing tamper resistant, non-volatile memory (TNV-EEPROM) for key storage as part of cryptographic embedded micro-processors (c-uP's),
providing of prior art, serial data computer communications interfaces such as a personal computer (PC) based, serial bus connected (e.g. Universal Serial Bus or USB bus, and the faster and longer distance but more expensive, IEEE 1394 serial bus (‘Fire wire bus’)), used to connect a personal computer (PC) to a digitized human fingerprint reader and for other computer peripheral purposes,
providing of prior art, a smart card reader means involving several invention processes which simply reads the customer inserted smart card's pass-thru encrypted data and passes it over wiretapable (‘red’) buses to the digital computer, furthermore, a first example form of smart card reader means has physical metallic contacts with a power pin used to re-charge any smart card internal battery from an additional AC power line going into the smart card reader and suitable voltage conversion and regulation electronics, furthermore, a second example smart card reader means is a popular class of prior art, smart cards which have an optical interface which lacks any form of smart card battery re-charging capability but has improved durability, a third example smart card reader is a prior art, integrated smart card reader with bio-identification (bio-ID) digitized fingerprint reader, furthermore, the smart card reader is a dumb and inexpensive computer serial data bus device with a first example serial communications interface being a prior art, serial data bus given as a universal serial bus (USB) providing maximum 3.0 Mega bits/second data transfer over a maximum 4.0 feet distance, which has no local area networking (LAN) interfaces which must be provided by the attached digital computer, a second example serial communications interface being a prior art, IEEE 1394 (‘Fire wire’) serial data bus which transfers a maximum of 10.0 Mega bits/second at a distance of up to a maximum of 10.0 feet,
providing of prior art, biological-identification (bio-ID) reader means which attach to personal computers (PC's) using a low-cost serial data bus such as a universal serial data bus (USB bus) with a first example bio-ID reader means being a smart card reader with piggy-backed, integrated, digitized fingerprint, bio-identification (bio-ID) reader for very customer convenient use, with an example customer use of a low security and unattended by a ‘warm-blooded’ authorized gate-keeper, bio-ID means of ‘warm-blooded’ index finger insertion into a digitized fingerprint reader and smart card insertion at the same time, a second example bio-ID reader means is a prior art, smart card reader with external AC power supply and power conversion and regulation transformers along with a piggy-backed ‘warm-blooded’ iris scan reader digital video-camera electronics which said iris scan reader is attached by IEEE 1394 (‘Fire wire’) digital cable to a digital video camera,
providing of prior art, an internet protocol (IP), wide area network (IP WAN),
providing of prior art, a world wide web server (WWW) or web or graphics rich portion of the Internet web server computer,
providing of prior art, a personal computer (PC), which is non-cryptographically secure,
providing of prior art, a personal computer (PC) web client,
providing of prior art, a personal computer (PC) peripherals,
providing of prior art, a data entry devices of an on-board protected electronic device, toggle field with a prior art liquid crystal display (LCD) for entry of the unique customer passphrase with closely corresponding passcode entry,
providing of prior art, a data entry device of computer keyboards used for unique customer password, and passphrase-passcode entry with wiretapable (‘red bus’) computer keyboard buses vulnerable to the known prior art, hacker tools of both software and hardware based keyboard capture buffers,
providing of prior art, a banked-EEPROM card reader-writer connected by a prior art, serial bus connected with first example serial bus being the Universal Serial Bus (R)(USB bus) connected banked non-volatile memory chip card reader-writer serial bus interface unit to an electronic device, with first example banked non-volatile memory chip card unit which inserts into the reader being a banked, electrically erasable programmable read only memory (banked-EEPROM) card unit (e.g. Sans Disk (R) card, or SD (R) card), and second example banked non-volatile memory chip card unit being a single, large chip tamper-resistant non-volatile electrically erasable programmable read-only memory (TNV-EEPROM) (e.g. Memory Stick (R) chip),
providing of prior art, a personal computer's (PC's) peripheral data storage devices such as hard disk drives (HDD's), compact disk (CD) record once (CD-R (R)) drives, compact disk read-write (CD-RW (R)) drives which all offer ‘backwards compatible’ CD media which can be used in read-only modes compatible with older, existing read-only CD drives (CD), also writable digital versatile disk (DVD) drives (e.g. DVD+RW (R), DVD-RW (R), DVD-RAM (R) which all offer ‘backwards compatible’ media which can be used in read-only modes compatible with older, existing read-only DVD drives (DVD-ROM),
providing of prior art, a personal computer's (PC's) based peripheral data storage media units (e.g. back-up devices, video devices, fast floppy drives (e.g. Iomega (R) Zip (R) drives), removable hard disk drives (removable HDD) (e.g. Iomega Jazz (R) drives)),
providing of prior art, a cryptographic digital signal processor (C-DSP) means designed for low-cost, very fast digital processing of fixed-point number array or arrays of fixed radix numbers having limited necessary precision typically less than 32-bits arranged in matrix arrays (32-bit integers with an assumed radix point which cannot move with a default assumed decimal point which cannot move) as popularly used in the Texas Instruments (TI) TMS-320 DSP and also the AT&T DSP-1, with major DSP features being an accumulator based design with arithmetic operation over-flow handling, no-overflow registers, pipelined design to DRAM connected over a central processor unit bus, constants held in registers for an ith round update to the (i+1)th round or fast iteration processing, and programming-time, programmable firmware libraries supporting flexible digital signal processing for different applications, furthermore, giving fast scalar control processing without a need for floating point operation re-normalization based upon exponents, with a floating point interpreter for limited floating point operations involving floating point number formats with exponents, furthermore, also having additional silicon compiler designed components of embedded tamper resistant non-volatile electrically erasable programmable read only memory (TNV-EEPROM) with a first example cryptographic digital signal processor (C-DSP) means being a standard DSP combined with the silicon compiler functions of the prior art, US National Institute of Standards and Technologies (NIST's) Clipper chip, which is the Skipjack algorithm implemented in a silicon compiler with tamper resistant non-volatile memroy (TNV-EEPROM), sub-circuit, single integrated circuit (‘single chip IC solution’) design giving stream cipher and block cipher encryption and decryption functions (additionally used in the prior art, Capstone program using a plug-in PC card (R) format once called PCMCIA having an embedded Clipper ASIC chip comparable to a prior art smart card program), which were both programs and standards were based upon the dedicated, custom designed ASIC, hardware integrated circuit (IC) implementation of the National Security Agency (NSA) developed, classified Clipper chip implementing the Skipjack secret key algorithm with on-chip tamper resistant non-volatile memory (TNV-EEPROM), second example cryptographic digital signal processor (C-DSP) means being standard digital signal processing (DSP) functions combined with silicon compiler functions implementing the Chandra patent (U.S. Pat. No. 4,817,140 issued on Mar. 28, 1989 and assigned to IBM Corporation), and third example cryptographic digital signal processor (C-DSP) means being numerous other US Patents and also public art, non-patented technical literature,
providing of prior art, a cryptographic digital signal processor (C-DSP) means intended for very fast processing of large fixed-point arrays of fixed-point or fixed radix numbers as shown in the prior art, Texas Instruments (TI) TMS-320 DSP and also the AT&T DSP-1, additionally containing a cryptographic hardware secret key algorithm sub-processor, tamper resistant non-volatile electrically erasable programmable read only memory (TNV-EEPROM), random access memory (RAM), analog to digital signal converters (ADC), moving picture electronics group standards X (MPEG X) hardware decompression only circuitry for digital audio/video, digital audio/video signal artificial degradation circuitry, digital to analog signal converters, and digital signal processing of digital audio/video signals circuitry,
providing of new art, cryptographic digital signal processor (C-DSP) means designed for low-cost, very fast, digital processing of fixed-point number arrays as shown in the prior art, popularly used, Texas Instruments TMS-320 DSP and also the AT&T DSP-1, furthermore, having additional silicon compiler designed components adding embedded tamper resistant non-volatile electrically erasable programmable read only memory (TNV-EEPROM) for secure cryptographic key storage, along with both tamper resistant to pin-probers, and cryptographically protected on-chip, firmware implemented new art, byte-oriented, secret key algorithm based secret key encryption and decryption for both stream oriented and block oriented encryption and decryption processes, with on-chip hardware and firmware library support for both secret key and public key algorithms such as an electronic true random number generator, an on-chip hardware floating point unit (FPU) for processing large blocks of secret key encrypted and decrypted data using newer y. 2003 firmware based, byte oriented, secret key algorithms such as Advanced Encryption Standard (AES), an extremely large integer to an extremely large integer exponentiation unit using the binary square and multiply method commonly used in public key cryptography, with additional on-chip silicon compiler designed hardware support for digital decompression (read-only) algorithms, with additional on-chip silicon compiler support for digital compression algorithms, with additional on-chip silicon compiler support for forward error detection and correction coding (e.g. Reed-Solomon or RS coding) done in the encoding process sequential order of digitally compress, encrypt, error detect and correct, with decoding done in the exact opposite sequential process order, with a first example C-DSP means being discussed broadly in the present inventor's present patent's technical material which is not subject to this present over-all system's or methods patent application which uses such a device as a provided hardware component,
providing of a new art, programmable gate array logic (GAL) form of high density, application specific integrated circuit (ASIC) with embedded cryptographic digital signal processor (C-DSP) means functions as mentioned in the paragraph just above,
providing of new art, a cryptographic digital signal processor (C-DSP) means designed for very fast execution of fixed-point number arrays such as the popular Texas Instruments TMS-320 and also the AT&T DSP-1, furthermore, having additional silicon compiler based embedded, prior art, cryptographic hardware secret key algorithm sub-processors based upon prior art, standardized, secret key algorithms with an example algorithm being given as IBM's patented Data Encryption Standard (DES), with on-chip firmware support, an on-chip hardware floating point unit (FPU) for processing large blocks of secret key encrypted and decrypted data using newer y. 2003 firmware based, byte oriented, secret key algorithms such as Advanced Encryption Standard (AES), an extremely large integer to an extremely large integer exponentiation unit using the binary square and multiply method commonly used in public key cryptography, with additional on-chip silicon compiler designed hardware support for digital decompression (decoding only or play-back only) algorithms, with additional on-chip silicon compiler support for digital compression algorithms, with additional on-chip silicon compiler support for forward error detection and correction coding (e.g. Reed-Solomon or RS coding) done in the encoding process sequential order of digitally compress, encrypt, and error detect and correct, with decoding done in the exact opposite sequential process order, which in turn are silicon compiler design embedded hardware sub-units inside of said prior art, cryptographic digital signal processors (C-DSP's),
providing of prior art, a cryptographic micro-processor (c-uP) or a central processing unit (CPU) such as an Intel Pentium (R) CPU with a control unit, and also with an integrated fast, hardware, floating point unit (FPU), integrated memory management unit (MMU), integrated instruction and data cache unit, integrated bus interface unit (BIU), and additional proposed subset functionality of a C-DSP means including integrated tamper resistant non-volatile electrically erasable programmable read only memory (TNV-EEPROM), all on a single chip, which has impedance monitored intermetallic deposition layers protecting the entire chip from illegal pin probers used by hackers targeting the on-chip architecture including the protected (‘black’) on-chip buses, and also for protecting the entire chip from wiretapping pin probers used to illegally read cryptographic keys stored on the on-chip said embedded, tamper resistant non-volatile electrically erasable programmable read only memory (TNV-EEPROM), with the main anti-tamper means being the automatic on-chip erasure of cryptographic memory (TNV-EEPROM) holding all cryptographic keys upon the fully automatic detection of any signs of chip tampering,
providing of new art, a cryptographic computing based unit (C-CPU) also having a subset of cryptographic digital signal processing (C-DSP) means having much more on-chip, hardware, floating point (FPU) throughput capacity than the C-DSP chip and a more powerful memory management unit (MMU) capability, while having subset security functionality as the cryptographic digital signal processor unit (C-DSP) means being on-chip tamper resistant non-volatile electrically erasable programmable read-only memory (TNV-EEPROM) or cryptographic memory for both cryptographic key storage and cryptographic algorithm firmware storage, automatic on-chip impedance monitoring of a whole chip inter-metallic layer with automatic erasure of cryptographic memory upon tamper detection, silicon compiler library designed on-chip functions with automatic placement and routing, on-chip support for read-only commercial players using an embedded C-CPU of a tamper protected, error detection or correction unit (e.g. Reed-Solomon unit), on chip support for read-only commercial players using an embedded C-CPU of a tamper protected (‘black unit’), embedded, secret key decryption sub-unit which supports both dedicated hardware and dedicated firmware secret key decryption of play-back mode only, uniquely secret key encrypted, commercial media, on-chip tamper protected digital de-compression only support in play-back only mode for standard form digital media (e.g. MP3 being discrete cosine transform (DCT) based, MPEG X being discrete cosine transform (DCT) based, fast wavelet transform (FWT) audio-video being convolutional coding based, JPEG being discrete cosine transform (DCT) based, JPEG 2000 being fast wavelet transform (FWT) or convolutional coding based, Fraunhoeffer Instititute fast wavelet transform (FWT) audio (R ) convolutional coding, AAC (R) brand convolutional coding) widely used in commercial media players, with more general bi-directional use in crypto-cell phones and crypto-hand-held computers for similar on-chip support respecting relevant process sequential orders being digitally compress media, encrypt media, error detection and correction bits added, which must be undone in cryptography in the exact reverse sequential order, for the hardware and firmware based encryption and decryption of digital media data, but, without current on-chip support for encrypted operation codes (c-op codes) usable in the future for cryptographic computer programs and cryptographic multi-media programs, with a first example C-CPU means being discussed in the present inventor's present invention,
providing of new art, a non-cryptographic media player (MP) based upon prior art, non-cryptographic digital signal processor (DSP) means with starting functionality of the popular Texas Instruments TMS-320 DSP, constructed with serial bus connections to customer insertable and removable prior art, smart card reader-writer unit interfaces, and a read-only drive unit for standard physical format, digital media which is very similar in computer architecture to prior art, electronic-book readers which have a built-in, very small, liquid crystal display (LCD), and are similar in physical form to non-cryptographic compact disk players,
providing of new art, a cryptographic media player (c-MP) constructed with said, prior art, cryptographic digital signal processor (C-DSP) means having serial bus connections to customer insertable and removable prior art, smart card reader-writer unit interfaces, and also having a read-only drive unit for standard media with first example, read-only, media means being compact disk record once (CD-R), second example read-only media means being compact disk compact disk read-write (CD-RW), and third example read-only media means being banked non-volatile memory card (banked EEPROM), and fourth example read-only media means being digital versatile disk record once (DVD-R),
providing of new art, a cryptographic personal computer (c-PC) which is created by using new art, said cryptographic digital signal processor (C-DSP) means based plug-in, peripheral or contention bus or input-output bus (I/O bus) cards for prior art, personal computers (PC's), with the peripheral bus giving an interface to the motherboard's said cryptographic central processing unit (C-CPU) which in turn has a Universal Serial Bus (USB) interface to a USB based smart card reader,
providing of new art, a cryptographic personal computer (c-PC) having a subset functionality of C-DSP means, which is created by using a prior art, standard off-the shelf personal computer (PC) design with a cryptographic central processing unit (C-CPU) with the goal of creating an internal secure bus hardware or ‘black bus’ computer architecture system also having insecure hardware bus or ‘red bus’ or open wiretapable buses, which furthermore requires a new art, cryptographic operating system (C-OS),
providing of new art, a cryptographic media player (c-MP) for playing back custom secret key encrypted, compressed digital, audio-video in standard format with first example compressed digital audio-video being given as prior art, Moving Picture Electronics Group Standards X (MPEG X) and second example compressed digital audio-video being given as prior art, fast wavelet audio-video digital compression also called convolutional coding, furthermore, said player contains embedded, cryptographic computing units (C-CPU's) with serial bus interfaces to built-in, prior art, smart card reader units, and also having built-in, prior art, input/output (I/O) peripheral bus connected, computer industry standard, peripheral data storage drives in first example drive being a compact disk read only (CD) drive which reads compact disk record once format (CD-R),
providing of new art, a universal cryptographic set-top box form of media players (c-MP's) for playing back custom secret key encrypted, high definition television (HDTV) broadcasts and standard definition television (SDTV) broadcasts, as well as for playing custom secret key encrypted, cable channel programming, as well as for playing custom secret key encrypted satellite television programming which are based upon a more powerful, cryptographic media player computer architecture (c-MP),
providing of new art, a cryptographic micro-mirror module (c-MMM)-commercial theater projection-theater sound units which are special cryptographic media players which use prior art, more than one drive, digital versatile disk read only (DVD) drive units which also read digital versatile disk record (DVD-X) formats, furthermore, the DVD-X disks contain custom encrypted compressed digital media which can be decrypted only with a corresponding, unique, smart card programmed in a prior art, standard, personal computer (PC) over the wiretapable (‘red bus’) Internet as a special media ticket smart card using the methods of the present inventor's patent,
providing of prior art, a modified secure operating system (secure-OS) for world wide web (WWW) server computers which will custom customer session key encrypt a vendor secret key encrypted digital master, and electronically distribute custom, encrypted digital media masters, using firewalls, using anti-viral software updated weekly, using network protocol converters, using standard layered security methods, and using ‘inner sanctum’ protection for vendor session key or one-time secret key encrypted digital media masters,
providing of prior art, a world wide web (WWW) transmission control protocol-internet protocol (TCP-IP) command protocol stack program for Internet connectivity,
providing of prior art, standard, a plurality of cryptographic mathematics algorithms,
providing of prior art, a plurality of public key cryptography algorithms which create public keys and private keys,
providing of prior art, a plurality of secret key cryptography algorithms which create secret keys and session keys (1-time secret keys) and also play counts or access counts or media decryption counts and play codes (session keys or 1-time secret keys),
providing of prior art, a plurality of hybrid key cryptography algorithms which are combined public key and private key cryptography algorithms (prior art),
providing of prior art, a plurality of private key and secret key splitting algorithms,
providing of prior art, a plurality of private key and secret key escrow techniques,
providing of prior art, a plurality of algorithms used to generate: cryptographic keys which are the collective public keys, private keys, secret keys, session keys (1-time use only secret keys), play counts, play codes, passphrases-passcodes,
providing of prior art, a plurality of computer cryptography protocols,
providing of prior art, a plurality of pass-thru encryption algorithms for transmitting secure data over wiretapable computer buses (‘red buses’),
providing of prior art, standardized form, a plurality of lossy compressed digital media algorithms with first example algorithm being given as MPEG X (R) based upon a SVGA (R) video format and also newer UXGA (R) higher resolution video formats, second example algorithm being given as MP3 (R) based upon pulse code modulated (PCM's) audio sound only, third example algorithm being given as JPEG X (R) for still color photography only with JPEG being discrete cosine transform (DCT) based and JPEG 2000 being fast wavelet transform (FWT) compression based, fourth example algorithm being given as fast wavelet transform (FWT) audio-video, fifth example algorithm being given as proprietary Advanced Audio CODEC (R) (AAC (R)) using a FWT algorithm variant, sixth example algorithm being given as Fraunhoeffer Institute fast wavelet transform (FWT) audio (R ) who are the original international patentees for convolutional coding based lossy digital compression,
providing of prior art, a transmissions control protocol/internet protocol (TCP/IP) for Internet connectivity,
providing of prior art, a secure internet protocol layer (secure IP layer) layer of Internet data encryption,
providing of prior art, a secure sockets layer (SSL) layer of Internet data encryption,
providing of prior art, a plurality of world wide web (WWW) server standard interchange file language with first example protocol being hyper-text mark-up language (HTML), second example protocol being extensible business mark-up language (XBML or XML), and third example protocol being generalized-text mark-up language (GTML),
providing of a plurality of world wide web (WWW) client standard interchange file languages with first example being hyper-text mark-up language (HTML),
generating of a set of common system keys which is the process done by the media ticket smart card system authority's, party S's, dedicated public key generation authority, party G, using provided prior art said public key and secret key cryptography algorithms to generate system cryptographic keys, while having absolutely no access to any vendor identifications, furthermore, the sub-process of embedding of generated said common system keys into each and every provided, cryptographic digital signal processor (C-DSP) means, furthermore, embedding said common system keys into each and every provided smart card,
generating of a set of unique per vendor, commonly distributed only in provided tamper resistant hardware, media distribution vendor cryptographic keys eventually used in a prior art, provided cryptographic digital signal processor (C-DSP) means involving several processes with a first example prior art, provided cryptographic digital signal processor (C-DSP) means being the US National Institute for Standards and Technology's Clipper-Capstone chip with embedded tamper resistant non-volatile electrically erasable programmable read-only memory (TNV-EEPROM), and a second example provided, cryptographic digital signal processor (C-DSP) means being a prior art, digital signal processor having a silicon compiler designed equivalent of the former's functions (C-DSP) means with added silicon compiler functions for prior art algorithm means for subsequent customer uses of digital signal compression audio-video digital compression means involving several processes and components with first example audio-video digital compression means involving several processes being given as prior art, Moving Picture Electronics Group standards X (MPEG X), second example audio-video digital compression means being given as prior art, fast wavelet audio-video compression or convolutional coding compression, third example audio only digital compression means being given as prior art, MPEG I audio layer 3 (MP3), and fourth example audio only digital compression means being given as prior art, fast wavelet audio only compression (AAC (R)), furthermore, with subsequent customer uses of a prior art, pass-thru encryption means involving several processes and components which are used to transfer said unique customer cryptographic keys over wiretapable or open computer buses (‘red buses’) with a first example pass-thru encryption means given as common, family key, secret key encryption, a second example pass-thru encryption means given as common family key encryption of an index to the unique active vendor which references a pre-embedded, common look-up table of unique vendor public keys followed by the relevant vendor public key encrypted data which is received on the other end of the computer bus by family key decryption of the vendor index to the same pre-embedded, common look-up table of unique vendor public keys followed by relevant vendor private key decryption of the received data block, and a third example pass-thru encryption means being a family key encryption of an index to the unique active vendor which references a pre-embedded, common look-up table of unique vendor secret keys followed by the relevant vendor secret key encrypted data which is received on the other end of the computer bus by family key decryption of the vendor index to the same pre-embedded, common look-up table of unique vendor secret keys followed by relevant vendor secret key decryption, for eventual manufacturing into a cryptographic media player, which is the process done by the media ticket smart card system authority's, party S's, dedicated public key generation authority, party G, using prior art algorithms for both public key and secret key cryptography to generate a unique set of vendor cryptographic keys, while having absolutely no access to any vendor identifications, furthermore, the sub-process of embedding in entirety, said unique set of vendor cryptographic keys in an organizational table form means involving several processes with first example organizational table form means being a unique vendor system key table which is indexed by a vendor identification number, furthermore, said organizational table form means is semi-conductor foundry factory embedded into each and every cryptographic digital signal processor (C-DSP) means, while specific vendor private keys and vendor secret keys including a minimum count of one vendor key of the private key of vendor party X, are factory time embedded into each and every one of vendor party X's eventually distributed media ticket smart cards inside of its embedded cryptographic micro-processor (C-uP) for use in a pass-thru encryption means of several example pass-thru encryption means as explained in a separate process,
generating of a unique media ticket smart card cryptographic key set or also known as a unique customer party cryptography key set, which is the process done by the media ticket smart card system authority's, party S's, dedicated public key generation authority, party G, using provided, prior art algorithms for both public key and secret key cryptography to generate unique customer cryptographic keys, while having absolutely no access to customer identifications, furthermore, the sub-process of embedding into a provided, single said unique media ticket smart card with an embedded cryptographic micro-processor (c-uP), a unique customer party Y's cryptographic key into party Y's eventually distributed said media ticket smart card with its said embedded cryptographic micro-processor (C-uP),
distributing of provided, said cryptographic digital signal processor (C-DSP) means, furthermore, the distributing of said cryptographic digital signal processor (C-DSP) means is based upon the process done by the media ticket smart card system authority's, party S's, dedicated public key distribution authority, party D, distributing cryptographic digital signal processor (C-DSP) means to individual media distribution vendors for manufacturing into vendor Z cryptographic media players while having absolutely no access to whole cryptographic keys and having unique vendor party Z access to only his own unique vendor secret key Z and unique vendor private key Z with its unique, matching public key Z,
distributing of the provided, factory cryptographically programmed, said media ticket smart cards which is the process done by the media ticket smart card system authority's, party S's, dedicated public key distribution authority, party D, distributing media ticket smart cards to media distribution vendors for selling to customers while having absolutely no access to whole cryptographic keys,
escrowing of the split cryptographic keys which is the process done by the central public key generation authority, party G, safe-guarding the split cryptographic customer keys, and split cryptographic vendor keys in an entirely-secure and confidential manner for achievement of legal means involving several processes, with a first example legal means being simple customer identification and lost cryptographic key recovery, a second example legal means being court ordered only, disputed ownership cryptographic key recovery, and a third example legal means being court ordered only cryptographic key recovery use by law enforcement,
layering for a federated cryptography architecture which is the process done by the media ticket smart card system authority, party S, creating a federated architecture of cryptographic authority with 3-layers, a central layer composed of the media ticket smart card system authority, a local layer composed of authorized media distribution companies labeled as parties Vn, and a user layer composed of customers,
preparing of a unique play code and a unique play count which is the process done by the authorized digital media distribution company, party Vn, preparing said unique play code (a session key or one-time use secret key), and said unique play counts (a paid for number of plays or count of free trial plays), and preparing of the custom encrypted digital media for downloading to each customer,
downloading to customer, party A, at a private dwelling, prior art, insecure (‘red bus’), personal computer (PC) which is the process done by the authorized digital media distribution vendor, party Vn, using hybrid key cryptographing steps of hybrid key cryptographic digital media distribution from a central media distribution authority hosted on a prior art, provided, world wide web (WWW) server over the global Internet to multiple prior art, provided, personal computer (PC) based web clients, one of whom is customer party A, of encrypted play codes (one-time secret keys or session keys) with header and encrypted play counts (paid for counts of plays or decryptions, or else counts of free trial plays) with header for deposit into said factory cryptographically programmed, prior art, provided, media ticket smart cards attached to prior art, provided, personal computer (PC based) media ticket smart card readers, and one-way transfer of custom session key or one-time use only secret-key encrypted pre-unique vendor secret key encrypted digital media for deposit into physical digital media inserted into media drives attached to prior art, provided, customer personal computers (PC's),
delivering by foot which is the process done by the customer, party A, of physically transferring both physical custom encrypted digital media and the customer, party A's, programmed media ticket smart cards from the customer's, party A's, prior art, provided, personal computer (PC) to any person's said cryptographic media player with its embedded said cryptographic digital signal processor (C-DSP) means, also with a built-in media ticket smart card reader,
encrypting in a pass-thru manner for media ticket smart card upload to a prior art, provided, cryptographic media player means with its embedded, provided said cryptographic digital signal processor (C-DSP) means using pass-thru encrypting means involving several processes and components for transferring any type of digital data securely from originating said media ticket smart card up to answering said cryptographic digital signal processor (C-DSP) means, with a first example pass-thru encrypting means being said common family key or shared secret key encryption which is known to be vulnerable to a single point of attack, a second example pass-thru encrypting means being originate vendor, unique, vendor private key digital signaturing to ‘signatured-text (not encrypted text thus readable by any party)’ followed by answering vendor, unique, vendor public key digital public key encryption to ‘cipher-text (encrypted text)’ using said pre-embedded, common look-up table of unique vendor public key and matching private keys with organizational means involving several processes and components such as first organizational means being a row, column table indexed by a vendor identification number, a third example pass-thru encrypting means being originate vendor, unique, vendor secret key encryption to ‘cipher-text (encrypted text which combines signaturing)’ using said pre-embedded common look-up table of unique vendor secret keys with organizational means involving several processes and components with first organizational means being a row, column table indexed by a vendor identification number,
encrypting in a pass-thru return manner for said cryptographic media player's prior art, provided, embedded said cryptographic digital signal processor (C-DSP) means download to said media ticket smart card using pass-thru encrypting return means involving several processes and components for transferring any type of digital data securely from said cryptographic digital signal processor (C-DSP) means to said media ticket smart card with a first example pass-thru encrypting return means being common family key or shared secret key encryption which is known vulnerable to a single point of failure, second example pass-thru encrypting return means being answer vendor unique private key digital signaturing to ‘signatured-text (non-encrypted thus readable by any party)’ followed by originate vendor unique public key encryption to ‘cipher-text (encrypted text)’ using said pre-embedded, common look-up table of unique vendor public key and matching private keys with organizational means involving several processes and components such as first organizational means being the row, column table indexed by a vendor identification number, a third example pass-thru encrypting return means being answer vendor unique secret key encryption to ‘cipher-text (encrypted text which combines signaturing)’ using said pre-embedded common look-up table of unique vendor secret keys with organizational means involving several processes and components with first organizational means being the row, column table indexed by a vendor identification number,
initializing before playing which is the process done by the customer, party A, of preparing any party's cryptographic media player with its prior art, provided, embedded said cryptographic digital signal processor (C-DSP) means by inserting his own unique custom encrypted digital media, and also by inserting his own unique media ticket smart card,
identifying of high security applications in need of a high degree of authentication of the customer where high security needs are more important than customer extra time and effort,
authenticating by customer triangle authentication which is the process done by new art, provided, said cryptographic media player with its prior art, provided, embedded said cryptographic digital signal processor (C-DSP) means which process step may be skipped for low security only when customer time and effort is of the essence,
transferring of the cryptographic keys from the prior art, provided, said media ticket smart card to new art, provided, said cryptographic media player having its prior art, provided, embedded said cryptographic digital signal processor (C-DSP) means by said pass-thru encrypting means of the unique customer cryptographic keys over wiretapable or open computer buses (‘red buses’) which is the process done by the cryptographic media player to receive encrypted play codes with header and encrypted play counts with header from the media ticket smart card n which are pass-thru encrypted by the several pass-thru encryption means involving several processes and components for transfer over wiretapable computer buses (‘red buses’) to the player's own cryptographic memory (TNV-EEPROM) for access by its cryptographic digital signal processor (C-DSP) means, with said first example pass-thru encryption means being the common family key encryption vulnerable to a single point of attack, a said second example pass-thru encryption means being the pre-embedded, common, look-up table of vendor private keys and matched public keys which uses a family key encrypted, common table index for efficient active table entry access, a said third means of pass-thru encryption being the unique vendor secret key encryption with use of a common, look-up table of vendor secret keys which uses a family key encrypted, common table index or vendor ID number for efficient active table entry access,
transferring of the cryptographic keys away from new art, provided, said cryptographic media player having its embedded said cryptographic digital signal processor (C-DSP) means to said media ticket smart card by pass-thru encrypting return means of the unique customer cryptographic keys over wiretapable or open computer buses (‘red buses’) which is the process done by the cryptographic media player which are pass-thru encrypted by the several pass-thru encryption means for transmit using it's cryptographic digital signal processor (C-DSP) means, the encrypted play codes with header and encrypted play counts with header both with cryptographic digital signal processor (C-DSP) means incremented sequence counts (to avoid recorded replay attacks without the use of synchronized digital clocks) to the media ticket smart card A transferred over wiretapable computer buses, with said first example pass-thru encryption means being the common family key encryption vulnerable to a single point of attack, a said second example pass-thru encryption means being the pre-embedded, common, look-up table of vendor private keys and matched public keys which uses a family key encrypted, common table index for efficient active table entry access, a said third means of pass-thru encryption being the unique vendor secret key encryption with use of a common, look-up table of vendor secret keys which uses a family key encrypted, common table index or vendor ID number for efficient active table entry access,
authenticating using media triangle authentication which is the process of matching the unique digital media with its matching unique play code by the method done by said cryptographic media player's embedded said cryptographic digital signal processor doing digital media triangle authentication using sample reads of test data with successful decryption,
cryptographing using hybrid key cryptography which is the process done by new art, provided said cryptographic media player's embedded said cryptographic digital signal processor (C-DSP) means using hybrid key cryptography which is the process of using hybrid key cryptography which uses public key cryptography to authenticate remote parties, do digital signatures to authenticate digital media and establish media integrity with a remote party, and encrypt one-time secret keys known as session keys (ssk-n), used for only one session, which said session keys are sent to a remote party who decrypts them for storage in his own tamper resistant, non-volatile memory (TNV-EEPROM) embedded on his black, cryptographic digital signal processing (C-DSP) means with a first example means of the prior art cryptographic digital signal processor (C-DSP), and a second example means of a cryptographic central processing unit (C-CPU), which said session keys may be later stored in tamper resistant non-volatile memory (TNV-EEPROM) embedded in a media ticket smart card where they are referred to as play codes with paid for and authorized play counts,
accounting by provided said cryptographic media player's embedded, said cryptographic digital signal processor (C-DSP) means which is the process done using hybrid key cryptography digital media playing of one-way transfer of custom session key encrypted digital media owned by party n in a controlled access manner mostly for financial accounting purposes which uses the play codes (session key or one-time secret key) and play counts (paid for number of plays or count of free trial plays) contained in media ticket smart cards,
playing by provided, said cryptographic media player having its embedded, provided, said cryptographic digital signal processor (C-DSP) means which is the process done using hybrid key cryptography which is the process of using hybrid key cryptography to do digital media playing in a controlled access manner using play codes (session key or one-time secret keys) and play counts (now contained within registers in the cryptographic digital signal processor (C-DSP) means and also the hardware secret key double decryption directly used upon the custom encrypted, one-way transfer of custom session key encrypted digital media which is pre-unique vendor secret key encrypted, using first the unique customer session key decryption and then the unique vendor secret key decryption with sequence number checks for countering recorded replay attacks,
escrowing retrieval of lost, stolen, or disputed ownership media ticket smart cards which is the process done by the customer, party n, which collection of processes of or methods of invention sets systems standards and integrates components into a system which can be used in the future for new forms of internationally standardized cryptography sanctioned by industry trade groups such as the Recording Industry Association of America's (RIAA's) Secure Digital Music Initiative (SDMI), the National Association of Broadcaster's (NAB's) Secure Digital Broadcast Group (SDBG), and also national standards agencies such as the American National Standards Institute (ANSI), National Institute for Standards and Technology (NIST), or international telegraphy union (ITU),
whereby the present invention creates several processes for doing unique, customer custom session key or one-time secret key encrypted copies of initially unique, vendor secret key encrypted, digital media distribution over the prior art, insecure (‘red bus’) Internet using secure, World Wide Web (WWW) (‘black’) servers involving the cryptographically secure transfer (‘download’) from Web server to customer prior art, personal computers (PC's) over insecure (‘red bus’) Internet connection lines, of custom encrypted, digital media to prior art, standard form recordable media, and also custom decryption cryptographic keys (‘play codes’) and custom pre-programmed accounting counts (‘play counts’) for deposit onto prior art, smart cards called media ticket smart cards,
whereby the present invention creates several processes for securely physically transferring (‘footprint download’) of both said custom, encrypted digital media on standard form recordable media along with the customer's universal media ticket smart card for all vendors and all digital media to said cryptographic media players having embedded pre-programmed prior art, said cryptographic digital signal processors (C-DSP's) for media playing which are universally and uniquely, pre-programmed for every authorized vendor participating in the system, and can also accept any authorized, unique customer's smart card which must have relevant play codes and play counts for upload and use which are both uniquely matched to the authorized custom encrypted digital media inserted for playing,
whereby the present invention allows using several of the above systems processes in safeguarding multi-million dollar digital masters released by vendors through World Wide Web (WWW) distribution.

30. The invention and processes of claim 29 whereby the process or methods steps of generating of a set of common system keys which is the process done by the media ticket smart card system authority's, party S's, dedicated public key generation authority, party G, using prior art algorithms for both public key and secret key cryptography to generate system cryptographic keys, while having absolutely no access to any vendor identifications, furthermore, the sub-process of embedding said common system keys into each and every cryptographic digital signal processor (C-DSP) means, furthermore, embedding said common system keys into each and every smart card, which is accomplished by the sub-steps of:
generating from completely random noise a system family key (fak-F) used as a first example means for pass-thru encryption,
generating of an initialization vector (iv) for use in a system message authentication cipher (mac).

31. The invention and processes of claim 30 whereby the process or generating of a set of unique per vendor, commonly distributed only in tamper resistant hardware (TNV-EEPROM), media distribution vendor cryptographic keys eventually used in a prior art, provided, said cryptographic digital signal processor (C-DSP) means involving several processes with a first example cryptographic digital signal processor (C-DSP) means being a prior art, provided cryptographic digital signal processor (C-DSP) means being the prior art, popular Texas Instrument's TMS-320 DSP along with additional silicon compiler designed functions for the US National Institute for Standards and Technology's Clipper-Capstone chip with embedded tamper resistant non-volatile electrically erasable programmable read-only memory (TNV-EEPROM), and a second example said new art cryptographic digital signal processor (C-DSP) means being a prior art, digital signal processor (DSP) such as the Texas Instruments TMS-320 having additional silicon compiler designed functions for prior art algorithm means for subsequent customer uses of digital signal compression audio-video digital compression means involving several processes and components with first example audio-video digital compression means being given as prior art, international patent pool protected, Moving Picture Electronics Group standards X (MPEG X), second example audio-video digital compression means being given as prior art, fast wavelet transform (FWT) audio-video compression or convolutional coding compression, third example audio only digital compression means being given as prior art, MPEG I audio layer 3 (MP3) audio only compression patented by the Fraunhoeffer Institute, and fourth example audio only digital compression means being given as prior art, fast wavelet transform (FWT) audio only compression (AAC (R)) internationally patented by the 3-C Group (R) led by Panasonic/Matsushita (R) Corporation, furthermore, with subsequent customer uses of a prior art, pass-thru encryption means involving several processes and components which are used to transfer said unique customer cryptographic keys over wiretapable or open computer buses (‘red buses’) with a first example pass-thru encryption means given as common, family key, secret key encryption, a second example pass-thru encryption means given as common family key encryption of an index to the unique active vendor which references a pre-embedded, common look-up table of unique vendor public keys followed by the relevant vendor public key encrypted data which is received on the other end of the computer bus by family key decryption of the vendor index to the same pre-embedded, common look-up table of unique vendor public keys followed by relevant vendor private key decryption of the received data block, and a third example pass-thru encryption means being a family key encryption of an index to the unique active vendor which references a pre-embedded, common look-up table of unique vendor secret keys followed by the relevant vendor secret key encrypted data which is received on the other end of the computer bus by family key decryption of the vendor index to the same pre-embedded, common look-up table of unique vendor secret keys followed by relevant vendor secret key decryption, for eventual manufacturing into a cryptographic media player, which is the process done by the media ticket smart card system authority's, party S's, dedicated public key generation authority, party G, using prior art algorithms for both public key and secret key cryptography to generate a unique set of vendor cryptographic keys, while having absolutely no access to any vendor identifications, furthermore, the sub-process of embedding in entirety, said unique set of vendor cryptographic keys in an organizational table form means involving several processes with first example organizational table form means being a unique vendor system key table which is indexed by a vendor identification number, furthermore, said organizational table form means is semi-conductor foundry factory embedded into each and every cryptographic digital signal processor (C-DSP), while specific vendor private keys and vendor secret keys including a minimum count of one vendor key of the private key of vendor party X, are factory time embedded into each and every one of vendor party X's eventually distributed media ticket smart cards inside of its embedded cryptographic micro-processor (C-uP) for use in a pass-thru encryption means of several example pass-thru encryption means as explained in a separate process, which is accomplished through the sub-steps of:
generating of vendor secret keys (sek-Vn), unique to each media distribution vendor, party Vn, for later use in embedding a complete set of media distributor secret keys (sek-V1 to sek-Vn) (y. 2002 considered secure secret key, secure key bit lengths are from 56-bits excluding parity bits in triple key modes equivalent to 168-bits up to non-triple key mode use of a secret key length of 256-bits without parity bits with a constant need for key strength increases to counter scalable computer technology improvements), into every cryptographic media player along with a system family key (fak-F), and also for eventual indirectly passing out to each media distribution vendor, party Vn, only his own secret key (sek-Vn),
generating of unique vendor private key (prk-Vn), public key (puk-Vn) pairs, for each media distribution vendor, party Vn, for embedding a system family key (fak-F) (y. 2002 considered secure system key bit lengths are 512-bits for secret key encryption and 3048-bits for public key encryption with adjustments for each type of application with a minimum ten year field use before upgrade assumption requiring a linear yearly increase in minimum key lengths giving exponential key strength improvements by a power of two), a complete set of vendor public keys (puk-V1 to puk-Vn) (y. 2002 considered secure public key, secure key bit lengths are from 1024-bits up to 2048-bits with a constant need for linear key length increases to counter constant exponential improvements in computer technology), and a complete set of vendor private keys (prk-V1 to prk-Vn) (y. 2003 considered secure at the same bit lengths as the public keys for most public key algorithms), in a pre-embedded, common, vendor look-up table form using an efficient vendor table look-up index to the vendor which is family key encrypted for transit, into each and every cryptographic digital signal processor (C-DSP) means for eventual manufacture into every authorized cryptographic media player,
escrowing of all vendor split cryptographic keys generated with a minimum of two central public key escrow authorities, parties en, and other escrow actions.

32. The invention and processes of claim 31 whereby the process or methods steps of generating of a unique media ticket smart card cryptographic key set or also known as a unique customer party cryptography key set, which is the process done by the media ticket smart card system authority's, party S's, dedicated public key generation authority, party G, using prior art algorithms for both public key and secret key cryptography to generate unique customer cryptographic keys, while having absolutely no access to customer identifications, furthermore, the sub-process of embedding into a single provided, said unique media ticket smart card a unique customer party Y's cryptographic key into its provided, said cryptographic micro-processor (C-uP), which is accomplished through the sub-steps of:
generating of public key pairs for different customers, parties A-Z (excepting reserved notation use of already assigned letters D, E, F, P, S) comprising of private keys (prk-n) and corresponding public keys (puk-n), while having absolutely no access to customer identifications and using prior art public key cryptography,
generating of an incremented, top secret customer index number (cin) also a related public citizen identification number (cin) composed of the message authentication cipher (mac), which is a secret initialization vector (IV) based message digest cipher (MDC), of customer index number (mac(cin)) which is publicly printed upon the exterior of each media ticket smart card,
generating of a customer public key database which indexes message authentication cipher (mac) of customer index number (mac(cin)) to the blank private key field, to the corresponding public key for passing to the central public key distribution authority, party D,
embedding into media ticket smart card a, a means for pass-thru encryption with first example pass-thru encryption means being a single, common, system family key (fak-F) (known as being vulnerable to a single point hacker attack to breach the entire system), and second example pass-thru encryption means being a complete pre-embedded, common, vendor public and private key table which is accessed with a vendor index, furthermore, the private key (prk-a) for customer party A indexed by message authentication cipher (mac) of customer index number (mac(cin)) also known as the public customer identification number, also
embedding into media ticket smart card b a system family key (fak-F), the private key (prk-b) for customer party b indexed by message authentication cipher (mac) code of customer index number (mac(cin)), etc.,
generating of an initial media ticket smart card access code means involving several processes and components such as a first access code means of a unique password, a second access code means of a unique passphrase-passcode, a third access code means of a unique bio-identification, with storage into a common database organizational means involving several processes and components with first example common database organizational means being a data structure indexed by message authentication code (mac) of customer index number (mac(cin)) for release to the central public key escrow, access code authority, party EA, who will later on release it to the registered customer for initial media ticket smart card use,
handing the media ticket smart cards to the public key distribution authority, party D, and furthermore,
escrowing of all customer split cryptographic keys generated with a minimum of two central public key escrow authorities, parties en, and other escrow actions.

33. The invention and processes of claim 32 whereby the process or method or steps to do distributing of said cryptographic digital signal processors (C-DSP's) based upon a starting point, provided said, hardware cryptographic digital signal processor (C-DSP) means, furthermore, the distributing of cryptographic digital signal processors (C-DSP's) is based upon the process done by the media ticket smart card system authority's, party S's, dedicated public key distribution authority, party D, distributing cryptographic digital signal processors (C-DSP's) to media distribution vendors for manufacturing into cryptographic media players while having absolutely no access to whole cryptographic keys, which consists of the sub-steps of:
distributing of the cryptographic digital signal processors (C-DSP's) in a physically secure transport and audit trailed chain of control by the central public key distribution authority, party D, only to authorized media distribution vendors, parties Vn,
manufacturing by the authorized media distribution vendors, parties Vn, of cryptographic digital signal processor (C-DSP) means into different forms of cryptographic media players with various specialized functions and applications,
retailing by the authorized media distribution vendors of cryptographic media players each having a vendor unique, embedded cryptographic digital signal processor (C-DSP) means with various specialized functions and applications to consumers.

34. The invention and processes of claim 33 whereby the process of or method of steps to do distributing of the media ticket smart cards which is the process done by the media ticket smart card system authority's, party S's, dedicated public key distribution authority, party D, distributing unique to each customer, cryptographically programmed, provided, media ticket smart cards to media distribution vendors for selling to customers while having absolutely no access to whole cryptographic keys, which consists of the sub-steps of:
assigning of media ticket smart cards eventually to media ticket smart card users which is the sub-step done by the central public key distribution authority, party D, assigning media ticket smart cards received from the public key generating authority from the methods of claim 32, to authorized media distribution vendors and eventually to media ticket smart card customers who will register names, addresses, etc. which can be mapped into a database by the publicly known message authentication cipher (mac) of customer index number (mac(cin)) on the exterior of the media ticket smart card,
imprinting of media ticket smart cards which is the sub-step done by the central public key distribution authority, party D, imprinting the media ticket smart cards with customer identification which fields are accessed by using the media ticket smart card customer identification field family key obtained from the public key generating authority,
distributing of media ticket smart cards to customers which is the sub-step done by the central public key distribution authority, party D, giving the media ticket smart cards to authorized media distribution vendors, parties Vn, for selling the media ticket smart cards to media ticket smart card customers through an appropriate secure physical channel such a retail store, express mail, and registered mail which media ticket smart cards are useless without registration with the central public key distribution authority, party D, and receiving of a temporary media ticket smart card access codes unless a wildcard access code was programmed by the public key generating authority,
possessing of media ticket smart cards which is the sub-step done by the customer, party A, receiving a media ticket smart card with exterior message authentication code (mac) of customer index number (mac(cin)) and registering the media ticket smart card at the retail store or by mailing back in a registration card with customer party n's name, address, phone number, e-mail address, etc. and public customer identification number which will allow the central public key distribution authority, party D, to use its customer database to map such identifications to the customer's public key,
publishing of the public keys which is the sub-step done by the central public key distribution authority, party D, openly publishing using internet protocol (IP) over the internet from a web server all public keys and appropriate user identities such as name and message authentication cipher (mac) of customer index number (mac(cin)) with a publishing example means using several process steps being the widely used, industry standards committee established, Consultative Committee for International Telephone and Telegraph's (CCITT's) (now called the International Telegraphy Union (ITU)) X.509 digital certificate format,
handling of media ticket smart card temporary user access codes which is the sub-step done by the central public key distribution authority, party D, handing only customer name, mailing address, and phone number indexed by a unique customer identification means involving several processes with a first unique customer identification means being a message authentication cipher (MAC) of the secret customer index number (CIN) to said public key escrow, access code authority (puk-EA) which said public key escrow, access code authority party (puk-EA), already has from process 32, the media ticket smart card temporary access codes also indexed by the same message authentication cipher (MAC) of the secret customer index number (CIN), furthermore, the public key escrow, access code authority party (puk-EA), has no media ticket smart cards or media ticket smart card reader family key from the claims of process 30,
distributing of media ticket smart card temporary user access codes which is the sub-step done by said public key escrow, access code authority, party EA, matching customer names, mailing address, and phone number to temporary media ticket smart card access codes in order to mail out media ticket smart card temporary access codes to media ticket smart card users, after which the public key access code authority promptly destroys all information it has used except for confirmation of the mailing.

35. The invention and processes of claim 34 whereby the process of or method of steps to do escrowing of the split cryptographic keys which is the process done by the central public key generation authority, party G, safe-guarding the split cryptographic customer keys, and split cryptographic vendor keys in an entirely secure and confidential manner with legal first means for simple customer identification and lost key recovery, second means for disputed ownership court ordered recovery, and third means for court ordered only use by law enforcement, which is accomplished through the sub-steps of:
skipping of this complete process step where legal attributes of the cryptographic system are not necessary,
receiving of the split cryptographic customer key database of customer private keys, PrK-n (a minimum of a front half and a back half key) and also the split cryptographic vendor key database of vendor private keys, prk-Vn, and vendor secret keys, sek-Vn (a minimum of a front half and a back half key) which is the sub-step done by the central public key escrow authorities, parties en, receiving split key databases from the central public key generation authority, party G,
anti-collaborating prevention means which is keeping separate the key split customer and vendor cryptographic keys between a minimum of two (for a front half of key and a back half of key) independent key escrow authorities, parties En who have absolutely no access to customer identifications,
receiving of media ticket smart card initial media ticket smart card access codes which is the sub-step done by the independent public key access code authority, party EA, receiving from the public key generation authority, party G, a database of initial media ticket smart card access codes indexed by message authentication cipher (mac) of customer index number (mac(cin)) and also receiving from the central public key distribution authority, party D, customer names, mailing addresses, and e-mail accounts also indexed by message authentication cipher (mac) of customer index number (mac(cin)),
distributing of media ticket smart card initial access code means involving several processes and components with first example access code means being a unique password, and second example access code means being a unique pass phrase or pass code, and third example access code means being unique bio-identification which must be ‘warm-blooded’ authorized human agent programmed into the smart card after ‘warm-blooded’ human customer authentication, and fourth and the highest security access code means being a particular type of two-phase authentication means which involves both bio-identification authentication which must be ‘warm-blooded’ authorized human agent programmed into said media ticket smart card for bio-identification access code means retrieval along with initial default and subsequent unique customer passphrase-passcode programmed into said media ticket smart card for passphrase-passcode access code means done in addition) which is the sub-step done by the public key access code authority, party EA, secure means transmitting through first example means of certified mailing or secure e-mailing to customers of the initial access codes, after which receiving back confirmation it promptly destroys all knowledge of customer identifications.

36. The invention and processes of claim 35 whereby the process of or method of steps to do layering for a federated cryptography architecture which is the process done by the media ticket smart card system authority, party S, creating a federated architecture of cryptographic authority with three-layers, a central layer composed of the media ticket smart card system authority, a local layer composed of authorized media distribution company parties Vn, and a user layer composed of customers, through the sub-steps of:
layering into 3-layers of a federated architecture of cryptographic authority:
a central layer composed of a media ticket smart card system authority,
a local layer composed of authorized media distribution companies Vn, and
a user layer composed of customers.

37. The invention and processes of claim 36 whereby the process of or method of steps to do preparing of a unique play code and a unique play count which is the process done by the authorized digital media distribution company, party Vn, preparing said unique play code (a session key or one-time use secret key), and said unique play counts (a paid for number of plays or count of free trial plays), and preparing of the custom encrypted digital media for using provided algorithms for Web custom encrypted media downloading to each customer, through the sub-steps of:
preparing of the media header for each download media session which is:
unique vendor and customer encrypted play code with media header (and sequence numbers):
public vendor identification number (mac(vin)) =
message authentication cipher (mac) of top secret vendor
index number (vin),
session identification number,
customer A public key encrypted(
vendor secret key encrypted(
vendor digitally signed {play code
```
  (session key or one-time secret key),
vendor sequence number,
message authentication cipher (mac) of
  customer identification number})),
```
customer (pass-thru encryption use) sequence number,
} = temp-9a,
unique vendor and customer encrypted play count with media
header (and sequence numbers):
{
public vendor identification number (mac(vin)) =
message authentication cipher (mac) of top secret vendor
index number (vin),
session identification number,
customer A public key encrypted(
vendor secret key encrypted(
vendor digitally signed {play count
(paid for numbers of plays,
−1 for infinite plays,
count of free trial plays),
vendor sequence number,
message authentication cipher (mac) of
customer identification number})),
customer (pass-thru encryption use) sequence number,
} = temp-9b,
encrypting of the play codes (session keys or one-time secret keys) which are truly random numbers in a desired range with header is a process of first, the vendor digitally signs (prk-Vn) the decrypted play code, and then attaches the header and sequence number and secondly, the vendor three-way encrypts the result with the sequence of first encryption with the secret key of the vendor, sek-Vn, second encryption, with the public key of receiving customer, party A, puK-a, third encryption with the system family key, fak-F, for pass-thru encryption means with first example pass-thru encryption means being common family key encryption (a known single point of vulnerability if breached):
Vn-fak-F(temp-9a)=pass-thru encrypted play code with header (and sequence numbers),
which first pass-thru encryption means requires for pass-thru decryption on the receiving end, the common family key symmetric cryptography based decryption in an exactly similar manner,
second pass-thru encryption example means being using the public key of the transmitting end vendor, puk-Vn, with a pre-embedded, common, vendor private and public key table efficiently accessing by the receiving end vendor, party Vn′, with use of a table index which is family key encrypted to avoid tampering:
{Vn-fak-F (index to the vendor key table), Vn-Puk-Vn(temp-9a)}=pass-thru encrypted play code with header (and sequence numbers),
which second means of pass-thru decryption requires for pass-thru decryption both the common family key, Vn′-fak-F, and the unique vendor private key, Vn′-Prk-Vn,
third pass-thru encryption example means being the transmitting vendor, party Vn, using the transmitting vendor's unique secret key, seK-vN, and a family key encrypted table index to a pre-embedded, common table of unique, secret vendor keys in:
{Vn-fak-F (index to the vendor secret key table), vN-seK-vN (temp-9a)}=pass-thru encrypted play code with header (and sequence numbers),
which third pass-thru encryption means requires for pass-thru decryption both the common family key, Vn′-fak-F, and the unique vendor secret key, Vn′-Sek-Vn,
furthermore:
in the given in this system usual absence of an authorized and trusted system wide, synchronized system of clocks used with a time-stamping technique, the alternate method of sequence number use is needed to prevent ‘recorded replay hacker attacks’ or digital recordings of encrypted messages and complete digital re-plays in entirety without decryption, on wiretapable buses of pass-thru encrypted signals inside of the cryptographic media player, furthermore, the sequence number can only be incremented by a party with the vendor secret key (sek-Vn), customer private key (prk-n), and system family key (fak-F) who are the party G for any vendor, the party Vn only for his own play codes and play counts, or the cryptographic media player, party p, for any vendor which player has a collection of all vendor secret keys (sek-V1 to Vn) and a collection of all vendor private keys (prk-V1 to Vn), furthermore, used in key ownership re-assignment operations by the cryptographic digital signal processor (C-DSP) means in the cryptographic media player, party P, furthermore, the customer (family key) sequence number is used in media ticket smart card loop-back operations, furthermore, the player can also check the vendor digital signature, and can obtain the customer party a's private key (prk-a) and public key (puk-a) from customer's inserted media ticket smart card a,
encrypting of play counts (counts of paid for numbers of play, 1 for indefinite plays, or counts of free trial plays) which are encrypted by the sequence of using the first example pass-thru encryption means using the common family key (fak-F) which is known vulnerable to breaches:
Vn-fak-Vn(temp-9b)=pass-thru encrypted play count with header (and sequence numbers),
with the second example pass-thru encryption means using the vendor public key being obvious from the above example in this same claim, and third example pass-thru encryption means using the vendor secret key also obvious from the above example in this same claim.

38. The invention and processes of claim 37 whereby the process of or method of steps to do downloading to customer, party A, at a private dwelling, prior art, insecure (‘red bus’), personal computer (PC) which is the process done by the authorized digital media distribution vendor, party Vn, using hybrid key cryptographing steps of hybrid key cryptographic digital media distribution from a central media distribution authority hosted on a provided, world wide web (WWW) server over the provided, global Internet to prior art, provided, multiple personal computer (PC) based web clients of encrypted play codes (one-time secret keys or session keys) with header and encrypted play counts (paid for counts of plays or decryptions, or else counts of free trial plays) with header for deposit into media ticket smart cards attached to personal computer media ticket smart card readers, and one-way transfer of custom session key or one-time use only secret key encrypted digital media which is pre-unique vendor secret key encrypted, for deposit into physical digital media inserted into media drives attached to personal computers, through the sub-steps of:
encrypting for Web download from a trusted Web system server to the media ticket smart card in a personal computer (PC) using pass-thru encryption means involving several processes and components for transferring any type of pre-vendor unique secret key encrypted and sequence numbered digital data securely from any trusted Web server system source, over the wiretapable (‘red bus’) Internet, down to any trusted media ticket smart card inserted into a prior art personal computer (PC), with a first example pass-thru encrypting means being said common family key or shared secret key encryption which is known to be vulnerable to a single point of attack, a second example pass-thru encrypting means being a single unique originating vendor private key digital signaturing into ‘signatured text (non-encrypted and readable by anybody)’ and then the answer vendor's unique public key used for public key encryption on the trusted Web server assuming that the media ticket smart cards each have an entire common, embedded set of a unique vendor look-up table of both vendor public keys and vendor private keys with first organizational means involving several processes and components being a row and column look-up table indexed by unique vendor identification number, a third example pass-thru encrypting means being a unique vendor secret key used for secret key encryption (combined with secret key ligaturing) on the trusted Web server assuming that the media ticket smart cards each have an entire common, embedded set of a unique vendor look-up table of unique vendor secret keys with first organizational means being a row, column table indexed by a vendor identification number,
encrypting for Web upload from a media ticket smart card in a personal computer (PC) to a trusted Web system server using pass-thru encrypting return means involving several processes and components for transferring any type of closed-loop, feed-back path digital data securely from a trusted system destination from a trusted media ticket smart card inserted into a personal computer (PC) over the wiretapable (‘red bus’) Internet back to the trusted Web server, with a first example pass-thru encrypting return means being said common family key or shared secret key encryption which is known to be vulnerable to a single point of attack, a second example pass-thru encrypting return means assuming that each media ticket smart card has an entire common, embedded, said look-up table of unique vendor public keys and private keys, being an answer vendor's private key digital signaturing to ‘signatured text (non-encrypted text thus readable by any party)’ followed by the unique originating vendor's public key for public key encryption to ‘cipher-text (encrypted text)’ with use of the pre-embedded in each media ticket smart card, common look-up table of unique vendor public key and matching private keys with organizational means involving several processes and components such as first organizational means being the row, column table indexed by a vendor identification number, a third example pass-thru encrypting return means being said pre-embedded common look-up table of unique vendor secret keys with organizational means involving several processes and components with first organizational means being the row, column table indexed by a vendor identification number,
accounting by credit card if payment for the custom encrypted digital media is due to the media distribution vendor,
cryptographing from a media distribution vendor's secure media web server to a customer party A's personal computer (PC) using prior art, commercial, low security, secure sockets layer hybrid key cryptography of already pass-thru encrypted with incremented sequence numbers (to prevent recorded replay attacks), encrypted play codes (one-time secret keys or session keys) with header and encrypted play counts (paid for counts of plays or decryptions or else counts of free trial plays) with header for deposit into media ticket smart cards attached to built-in media ticket smart card readers,
cryptographing from a media distribution vendor's secure media web server to a customer party a's personal computer (PC) using prior art, commercial, low security, secure sockets layer hybrid key cryptography of already custom, encrypted digital media for deposit into physical media inserted into built-in media drives.

39. The invention and processes of claim 38 whereby the process of or method of steps to do delivering by foot which is the process done by the customer, party A, of physically transferring both physical custom encrypted digital media and the customer, party A's, programmed media ticket smart cards from the customer's, party A's, personal computer (PC) to any person's provided, cryptographic media player with a built-in provided, media ticket smart card reader, which consists of the sub-steps of:
transporting his own custom encrypted digital media to any cryptographic media player along with his own media ticket smart card A,
inserting of his own custom encrypted digital media and his own media ticket smart card A into any cryptographic media player with a built-in media ticket smart card reader.

40. The invention of claim 39 whereby the process of or method of steps to do said encrypting in a pass-thru means which involves several other processes for media ticket smart card upload to provided said cryptographic media player having an embedded, provided said cryptographic digital signal processor (C-DSP) means using pass-thru encrypting means involving several processes and components for transferring any type of digital data securely from originating said media ticket smart card up to answering said cryptographic digital signal processor (C-DSP) means, with a first example pass-thru encrypting means being said common family key or shared secret key encryption which is known to be vulnerable to a single point of attack, a second example pass-thru encrypting means being originate vendor, unique, vendor private key digital signaturing to ‘signatured-text (not encrypted text thus readable by any party)’ followed by answering vendor, unique, vendor public key digital public key encryption to ‘cipher-text (encrypted text)’ using said pre-embedded, common look-up table of unique vendor public key and matching private keys with organizational means involving several processes and components such as first organizational means being a row, column table indexed by a vendor identification number, a third example pass-thru encrypting means being originate vendor, unique, vendor secret key encryption to ‘cipher-text (encrypted text which combines signaturing)’ using said pre-embedded common look-up table of unique vendor secret keys with organizational means involving several processes and components with first organizational means being a row, column table indexed by a vendor identification number.

41. The invention of claim 40 whereby the process of or method of steps to do said encrypting in a pass-thru return means for said cryptographic media player's embedded said cryptographic digital signal processor (C-DSP) means download to said media ticket smart card using pass-thru encrypting return means involving several processes and components for transferring any type of digital data securely from said cryptographic digital signal processor (C-DSP) means to said media ticket smart card with a first example pass-thru encrypting return means being common family key or shared secret key encryption which is known vulnerable to a single point of failure, second example pass-thru encrypting return means being answer vendor unique private key digital signaturing to ‘signatured-text (non-encrypted thus readable by any party)’ followed by originate vendor unique public key encryption to ‘cipher-text (encrypted text)’ using said pre-embedded, common look-up table of unique vendor public key and matching private keys with organizational means involving several processes and components such as first organizational means being the row, column table indexed by a vendor identification number, a third example pass-thru encrypting return means being answer vendor unique secret key encryption to ‘cipher-text (encrypted text which combines signaturing)’ using said pre-embedded common look-up table of unique vendor secret keys with organizational means involving several processes and components with first organizational means being the row, column table indexed by a vendor identification number.

42. The invention and processes of claim 41 whereby the process of or method of steps to do initializing before playing which is the process done by the customer, party A, of preparing any party's provided cryptographic media player with its provided embedded cryptographic digital signal processor (C-DSP) means means by inserting his own unique custom encrypted digital media, and also by inserting his own unique media ticket smart card, accomplished by the sub-steps of:
verifying of insertion by some customer of some custom session key (one-time secret key) encrypted media into the cryptographic media player's media drive,
verifying of insertion by some customer of some media ticket smart card A into the built-in media ticket smart card reader on the cryptographic media player,

43. The invention and processes of claim 42 identifying of a high security application in need of a high degree of authentication of the customer where high security needs are more important than customer extra time and extra effort which consists of the sub-steps of:
programming at the factory for a high security application such as but not limited to: government use, banking, credit card transactions, automatic teller machines (ATM cards), high security facility card key access, vs. consumer digital media entertainment by pre-programming an embedded security level pre-determined digital field code for the smart card application,
prompting by the cryptographic media player of some customer to enter his access code through a first means such as a built-in cryptographic alphanumeric toggle field with liquid crystal display (LCD) with a minimum of one-line display, or through a second means of a computer keyboard, or through a third means of a biological identification (bio-id) reader with example means being a digital fingerprint reader.

44. The invention and processes of claim 43 whereby the process of or method of steps to do authenticating by customer triangle authentication which is the process done by provided said cryptographic media player and its provided embedded said cryptographic digital signal processor (C-DSP) means which process step may be skipped for low security only when customer time and effort is of essence, accomplished through the sub-steps of:
identifying of a low security application and skipping this sub-process step for low security applications only where customer time and effort is more critical than customer security,
initializing before playing of cryptographic media player through the process of claim 42,
transferring media ticket smart card access codes from input/output (I/O) access code entry device means on the cryptographic media player over wiretapable (‘red’) computer buses to the cryptographic digital signal processor (C-DSP) means with a first example access code means of passphrases/passcodes customer entered into a first device entry means of a built-in cryptographic media player toggle field with a minimum of one-line display, and a second example access code device entry means of being customer entered into a computer keyboard on a personal computer (PC), and a third example access code device entry means of a customer finger entered into a built-in bio-identification (bio-ID) unit such as a digital fingerprint reader, which all example access code device entry means are transferred over wiretapable buses (‘red buses’) to a cryptographic digital signal processing (C-DSP) means which is embedded inside of the cryptographic media player,
encrypting using pass-thru encryption means of digital data from the media ticket smart card meant for upload to the cryptographic digital signal processor (C-DSP) means with first example pass-thru encryption means being the use of the common and vulnerable, system family key, fak-F, and second example pass-thru encryption means being the pre-stored, unique vendor's private key used with a family key encrypted index to an embedded, common, vendor key look-up table for efficient table look-up which vendor key table pre-stored, on the other end holds the unique, matching public key, for pass-thru encryption by the media ticket smart card of the customer's media ticket smart card access code in first example access code means being passphrases/passcodes, and second example access-code means being passwords having automatically mixed in pseudorandom noise called salt, and third example access code means being bio-identification such as a digital fingerprint with an added incremented sequence number with means to avoid recorded replay attacks which is automatically added by the authorized media distribution vendor and the authorized cryptographic media player in order to prevent recorded replay attacks,
transferring using the encrypting using pass-thru encryption means of upload data from the media ticket smart card to the cryptographic digital signal processor (C-DSP) means, with the upload data being the unique embedded, media ticket smart card access code means with first example unique access code means being passphrases/passcodes, and second example unique access code means being passwords with vowels automatically replaced by pseudo-random noise, and a third example access code means being unique bio-identification such as a digital fingerprint transmitted over wiretapable (“red”) computer buses from the media ticket smart card to the cryptographic digital signal processor (C-DSP) means,
decrypting using decryption from the relevant pass-thru encrypting means from said media ticket smart card upload to said cryptographic digital signal processor (C-DSP) means with first example pass-thru decryption means by the cryptographic digital signal processor (C-DSP) means using the system family key, fak-F, and second example pass-thru decryption means being a family key encrypted index to a pre-embedded, common, vendor key look-up table to give efficient table look-up of the pre-stored, matching unique vendor public key, all sub-steps performed by the cryptographic media player of the customer's media ticket smart card access code in first example access code means being passphrases/passcodes, second example access code means being passwords with automatically mixed in pseudorandom noise called salt, and second example access code means being bio-identification such as digital fingerprints with added incremented sequence number used to prevent recorded replay attacks,
verifying against recorded replay attacks by said cryptographic digital signal processor (C-DSP) means inside of the cryptographic media player by checking for an incremented sequence number which can only be incremented by the media distribution vendor or else any cryptographic media player over the previous recorded sequence number in local cryptographic memory (TNV-EEPROM) which is the retrieved previous access of the same media ticket smart card sequence numbered play code and sequence numbered play count received from the media ticket smart card, and then the incrementing of the sequence number by the cryptographic media player,
doing the reverse step of encrypting using pass-thru encryption return means to download digital data from said cryptographic digital signal processor (C-DSP) means to said media ticket smart card with the digital data being the smart card access code with incremented sequence number,
authenticating by customer triangle authentication of the following points:
point 1 of customer, party A, smart card access code comprising of a first example access code means of a passphrase-passcode, a second example access code means of a password with automatic random noise (called ‘salt’) added to the entry, and a third example access code means of a bio-identification such as a digital fingerprint, to
point 2 of media ticket smart card a, to
point 3 of authorized cryptographic media player.

45. The invention and processes of claim 42 whereby the process of or method of steps to do transferring of the cryptographic keys from provided said media ticket smart card to provided said cryptographic media players with its provided embedded said cryptographic digital signal processor (C-DSP) means by said encrypting using pass-thru encryption means for the upload of digital data from said media ticket smart card to provided said cryptographic digital signal processor (C-DSP) means over wiretapable or open computer buses (‘red buses’) which is the process done by the provided, cryptographic media player to receive encrypted play codes with header and encrypted play counts with header from the media ticket smart card n which are pass-thru encrypted by the several pass-thru encryption means involving several processes and components for transfer over wiretapable computer buses (‘red buses’) to the player's own cryptographic memory (TNV-EEPROM) for access by its cryptographic digital signal processor (C-DSP) means, with said first example pass-thru encryption means being the common family key encryption vulnerable to a single point of attack, a said second example pass-thru encryption means being the pre-embedded, common, look-up table of vendor private keys and matched public keys which uses a family key encrypted, common table index for efficient active table entry access, a said third means of pass-thru encryption being the unique vendor secret key encryption with use of a common, look-up table of vendor secret keys which uses a family key encrypted, common table index or vendor ID number for efficient active table entry access, comprising of the sub-steps of:
requesting by the cryptographic digital signal processor (C-DSP) means sending a request digital code to the media ticket smart card A to request return of a pre-determined digital message code or else cryptographic key data which is pass-thru encrypted by various means with first pass-thru encryption means-being the common system family key (fak-F) which is a known weak point in the system if the shared family key is breached, second pass-thru encryption means being a specific vendor's private key (prk-Vn) encryption done by the media ticket smart card which is pre-programmed with a common, pre-embedded, vendor key look-up table using a family key encrypted index for efficiency in processing on the other end, thus it is preceded by a family key (fak) encrypted index to the pre-embedded, common, vendor key look-up table for fast table look-up of the matching vendor public key also pre-programmed in the cryptographic digital signal processor (C-DSP) means on the other end,
transferring by the media ticket smart card n to the cryptographic digital signal processor (C-DSP) means of said return pre-determined digital message code or else said requested cryptographic keys comprising of customer private key (prk-n), encrypted play codes (session keys or one-time secret keys) with header, encrypted play counts (paid for numbers of plays, −1 for infinite plays, or counts of free trial plays) with header all with sequence numbers to prevent recorded replay attacks,
decrypting by the cryptographic-digital signal-processor (C-DSP) means of the returned pass-thru encrypted cryptographic keys from the media ticket smart card using its pass-thru encryption means with first pass-thru encryption means being the trusted family key (which is vulnerable to leakage) to decrypt the pass-thru encrypted cryptographic keys, second pass-thru encryption means being the unique vendor public key which is pre-programmed using an embedded, common, vendor key look-up table for all vendors into the cryptographic digital signal processor (C-DSP) means and is preceded by a family key (fak) encrypted index to said vendor key look-up table for efficient table look-up without search time,
verifying by the cryptographic digital signal processor (C-DSP) means of incremented sequence numbers used to prevent a recorded replay attack (instead of requiring synchronized system clocks and time-stamped data) in the cryptographic keys returned from the media ticket smart card in order to prevent recorded replay attacks which is the sub-step done by the cryptographic digital signal processor (C-DSP) means using its locally cryptographically stored trusted family key (fak-F), customer private key (prk-n) retrieved from the customer's media ticket smart card, vendor public key (puk-Vn), and vendor secret key (sek-Vn) retrieved from local cryptographic memory (TNV-EEPROM), to pass-thru decrypt the sequence numbers and check for an incremented value over the previous values stored in local cryptographic memory (only an authorized cryptographic media player can increment the sequence number before storage as only an authorized media distribution vendor or any cryptographic-media player has the cryptographic keys to alter a sequence number),
storing by the cryptographic digital signal processor (C-DSP) means in its own local cryptographic memory (TNV-EEPROM) of the media ticket smart card's verified and decrypted cryptographic keys composed of the customer's private key, PrK-n, decrypted play count with header, decrypted play code with header in its own local tamper resistant non-volatile memory (TNV-EEPROM), this process must be followed by,
incrementing of sequence number function done by the cryptographic digital signal processor (C-DSP) means, and an opposite direction transferring function by the cryptographic digital signal processor (C-DSP) means to the media ticket smart card of the updated cryptographic keys with incremented sequence number in order to avoid their rejected use in the future,
n-way committing of the previous sub-step to ensure sub-step completion in the event of unexpected circumstances such as but not limited to: power outages, pre-maturely customer withdrawn smart cards, and hardware failures, furthermore, failure to minimum 2-way commit the above sub-step will completely void the entire operational step before anything is given the system go-ahead.

46. The invention and processes of claim 45 whereby the process of or method of steps to do transferring of the cryptographic keys away from provided said cryptographic media player and its embedded provided said cryptographic digital signal processor (C-DSP) means to provided said media ticket smart card by said encrypting using pass-thru return means for the download of digital data from the provided cryptographic digital signal processor (C-DSP) means to the provided, media ticket smart card over wiretapable or open computer buses (‘red buses’) which is the process done by the provided, cryptographic media player which are pass-thru encrypted by the several pass-thru encryption means for transmit using it's provided, cryptographic digital signal processor (C-DSP) means, the encrypted play codes with header and encrypted play-counts with header both with provided, cryptographic digital signal processor (C-DSP) means incremented sequence counts (to avoid recorded replay attacks without the use of synchronized digital clocks) to the media ticket smart card A transferred over wiretapable computer buses, with said first example pass-thru encryption means being the common family key encryption vulnerable to a single point of attack, a said second example pass-thru encryption means being the pre-embedded, common, look-up table of vendor private keys and matched public keys which uses a family key encrypted, common table index for efficient active table entry access, a said third-means of pass-thru encryption being the unique vendor secret key encryption with use of a common, look-up table of vendor secret keys which uses a family key encrypted, common table index or vendor ID number for efficient active table entry access, comprising of the sub-steps of:
transferring by pass-thru encrypting means by the crypto graphical digital signal processor (C-DSP) means to the media ticket smart card with first example pass-thru encryption means being common family key encryption which is known as being vulnerable to system breaching, and second example pass-thru encryption means using a unique vendor public key for encryption which is first identified by a family key encrypted index to a pre-embedded, common, vendor public key and private key look-up table, which furthermore, enables the unique and matching vendor private key table look-up on the receiving end, furthermore, pass-thru encryption means is used in the process of transferring cryptographic keys comprising of customer private key (prk-n), encrypted play codes with header, encrypted play counts with header, all with already incremented customer (family key) sequence numbers from itself to the media ticket smart card,
decrypting of pass-thru encrypted means for cryptographic key transfer by the media ticket smart card which is the process done in first example pass-thru decryption means by using its trusted family key, and second example pass-thru decryption means being the use of said unique vendor public key which is identified for efficiency by said family key encrypted index, to decrypt the pass-thru encrypted cryptographic keys from the cryptographic digital signal processor (C-DSP) means,
verifying of incremented customer (family key) sequence numbers to prevent recorded replay attacks which is the sub-step done by the cryptographic micro-processor (C-uP) embedded inside of the media ticket smart card using its local cryptographically stored (TNV-EEPROM) pass-thru encryption means first pass-thru encryption example means of a trusted family key, fak-F, and second example pass-thru encryption means example of a single vulnerable to breaching, pre-stored, family key, fak-F, indexed set of all vendor keys to efficiently retrieve the unique matching vendor public key to the unique vendor private key used, with pass-thru decryption means used to pass-thru decrypt the play code with header (and sequence numbers):
removing the message authentication code (mac code) of the public vendor identification number,
removing the session identification number,
removing the customer (pass-thru encryption use) sequence number,
leaving the last to first by initial vendor media distribution center operation, customer public key encrypted, vendor secret key encrypted, vendor digitally signed both of play code and vendor sequence number,
checking by the media ticket smart card for an incremented customer (pass-thru encryption use) sequence number to prevent a recorded replay attack,
storing of cryptographic keys which is the sub-step done by the cryptographic micro-processor (C-uP) embedded inside of the media ticket smart card storing the pass-thru decrypted keys including the customer's private key, PrK-n, decrypted updated play count with header, decrypted play code with header all with updated sequence numbers into its own local tamper resistant non-volatile memory (TNV-EEPROM),
returning of error status from the media ticket smart card's cryptographic micro-processor (C-uP) back to the cryptographic digital signal processor (C-DSP) means which are the sub-steps of the media ticket smart card composing a pre-determined digital error warning code or normal status warning with the looped back sequence number which is pass-thru encrypted and returned to the cryptographic digital signal processor (C-DSP) means.

47. The invention and processes of claim 46 whereby the process of or method of steps to do authenticating using media triangle authentication which is the process of matching unique digital media with matching unique play codes by the method of media triangle authentication which is the process done by provided, said cryptographic media player's embedded, provided, said cryptographic digital signal processor (C-DSP) means doing digital media triangle authentication using sample reads of test data with successful decryption, accomplished through the sub-steps of:
initializing before playing by the customer, party A, of the cryptographic digital signal processor (C-DSP) means through the process of claim 42,
authenticating by customer triangle authentication by the cryptographic digital signal processor (C-DSP) means through the process of claim 44,
reading by the cryptographic digital signal processor (C-DSP) means of the custom encrypted digital media to obtain the public vendor identification number and session identification number of the particular media indexed by cryptographic digital signal processor (C-DSP) means identification number,
```
{
    public vendor identification number (mac(vin)),
    session identification number,
    play code encrypted digital media,
}
```
encrypting by the cryptographic digital signal processor (C-DSP) means using pass-thru encryption means with the first example pass-thru encryption means (vulnerable to system breaching) being the system family key, fak-F, family key encryption, and the second example pass-thru encryption means being the unique vendor private key encryption with the additional family key encryption of an index used for efficiency to a pre-embedded, common, look-up table of vendor public and private keys, furthermore, with all pass-thru encryption means, the media's public vendor identification number and session identification number are used with an incremented sequence number to prevent recorded replay attacks,
transferring by the cryptographic digital signal processor (C-DSP) means to the media ticket smart card inserted into a built-in media ticket smart card reader of the media's pass-thru encrypted public vendor identification number and session identification number with an incremented sequence number,
decrypting by the media ticket smart card using pass-thru decryption means with first example pass-thru decryption means using said system family key, fak-F, and second example pass-thru decryption means using said unique vendor public key which is efficiently table look-up processed on the receiving end using the family key encrypted index to the common, pre-stored, vendor key table, furthermore, the pass-thru encryption means are used on the media's public vendor identification number and session identification number with an incremented sequence number to prevent recorded replay attacks,
verifying by the media ticket smart card against recorded replay attacks in the decrypted data by checking for an incremented sequence number over the local crypto graphical memory (TNV-EEPROM) stored previous recorded sequence number access indexed with the same cryptographic digital signal processor (C-DSP) means identification number,
retrieving by the media ticket smart card n from its local cryptographic memory in the public vendor identification number table, the session identification number of the matching encrypted play codes with header and encrypted play counts with header plus its own customer private key, prk-a,
notifying by the media ticket smart card back to the cryptographic digital signal processor (C-DSP) means of a custom encrypted digital media to media ticket smart card pre-determined digital code for a mismatch error status going back if the public vendor identification number and session identification number search produces no matches in local cryptographic memory (TNV-EEPROM),
decrypting by the cryptographic digital signal processor (C-DSP) means always in the exact reverse order of encryption in order to mathematically undo encryption operations in the proper sequential order, using pass-thru decryption means with first example pass-thru encryption means being the common system family key, fak-F, and second example pass-thru encryption means being the unique vendor public key with a family key encrypted index to a pre-embedded, common look-up table of vendor public and private keys for efficient table look-up, and decryption using the vendor private key, prk-Vn, and vendor secret key, sek-Vn, out of the set of all vendor public keys and vendor secret keys retrieved from local cryptographic memory by the cryptographic digital signal processor (C-DSP) means used upon the customer's encrypted play code with header, play count with header, and private key, prk-a, with sequence number to prevent recorded replay attacks,
verifying against recorded replay attacks by the cryptographic digital signal processor (C-DSP) means by checking for an incremented sequence number over the previous recorded sequence number access of the same media ticket smart card held in local cryptographic memory (TNV-EEPROM),
incrementing by the cryptographic digital signal processor (C-DSP) means of the customer (family key) sequence number received from the media ticket smart card,
encrypting by the cryptographic digital signal processor (C-DSP) means using pass-thru encryption means with first example pass-thru encryption means being the system family key, fak-F, and second example pass-thru encryption means being the unique vendor private key with a family key encrypted index to a table of vendor keys for efficiency, of the media ticket smart card's retrieved encrypted private key, prk-a, encrypted play codes with header, and encrypted play counts with header, all with an incremented sequence number to prevent recorded replay attacks,
transferring using pass-thru encrypting means by the cryptographic digital signal processor (C-DSP) means to the media ticket smart card of the updated cryptographic keys comprising of customer party a's private key, prk-a, encrypted play codes (session keys or one-time secret keys) with header and encrypted play counts (paid for numbers of plays, −1 for infinite plays, or counts of free trial plays) with header and all with sequence numbers by the process of claim 40,
authenticating of the media triangle authentication by the cryptographic digital signal processor (C-DSP) means which is the sub-step done by the cryptographic digital signal processor (C-DSP) means inside of the cryptographic media player decrypting a sample known test pattern of the digital media by using the decrypted play code (session key or one-time secret key) stored inside of local cryptographic memory (TNV-EEPROM) inside of the cryptographic digital signal processor (C-DSP) means also with using the vendor's public key, puk-Vn, and vendor's secret key, sek-Vn, in order to undo the pass-thru encrypting means processes of claim 40, using the following data structures:
unique vendor and customer play count with media header (and sequence number) is:
```
(
    public vendor identification number (mac(vin)),
    session identification number,
    customer A public key encrypted
            (vendor secret key encrypted
        (vendor private key digitally signed{
                    play count, sequence number}))
    customer (pass-thru encryption use) sequence number,
    ) = temp-16a,
```
vendor pass-thru encrypted play count with media header (and sequence numbers) is:
family key (temp-16a)=temp-16b,
unique vendor and customer play code with media header (and sequence numbers) is:
```
(
    public vendor identification number (mac(vin)),
    session identification number,
    customer A public key encrypted
        (vendor secret key encrypted
            (vendor private key digitally signed
                    {play code, sequence number})
        customer (pass-thru encryption use) sequence number,
        )
    ) = temp-16c,
```
vendor family key encrypted or pass-thru encrypted means of the play code with media header and sequence number is:
family key (temp-16c) temp-16d,
and then using the decrypted play code also known as a session key or one-time secret key for decrypting the custom encrypted digital media which known sample data area will only decrypt properly to a known test pattern with the proper untampered with play code,
authenticating with media triangle authentication by the cryptographic digital signal processor (C-DSP) means of the following points:
point 1 of custom, encrypted digital media a, to
point 2 of media ticket smart card a, to
point 3 of authorized cryptographic media player.

48. The invention and processes of claim 47 whereby the process of or method of steps to do cryptographing using hybrid key cryptography which is the process done by provided, said cryptographic media player with its provided, embedded said cryptographic digital signal processor (C-DSP) means using hybrid key cryptography which is the process of using hybrid key cryptography which uses public key cryptography to authenticate remote parties, do digital signatures to authenticate digital media and establish media integrity with a remote party, and encrypt one-time secret keys known as session keys (ssk-n), used for only one session, which said session keys are sent to a remote party who decrypts them for storage in his own tamper resistant, non-volatile memory (TNV-EEPROM) embedded on his black, cryptographic computing unit in the example of the prior art cryptographic digital signal processor (C-DSP) means which said session keys may be later stored in tamper resistant non-volatile memory (TNV-EEPROM) embedded in a media ticket smart card where they are referred to as play codes with paid for and authorized play counts, accomplished through the sub-steps of:
authenticating of play code digitally signed by the authorized media distribution vendor's private key to the cryptographic digital signal processor (C-DSP) means which is the sub-step done by the cryptographic digital signal processor (C-DSP) means which holds the complete public key set of all authorized media distribution vendors retrieving the play code from the media ticket smart card A and using the correct vendor public key to decrypt the session key which was digitally signed by the vendor private key to reveal the decrypted session key ready for use on the custom encrypted digital media,
decrypting of the custom encrypted digital media which is the sub-step done by the cryptographic digital signal processor (C-DSP) means using the decrypted session key (one-time secret key) for secret key decrypting means involving one or more processes and components, with the first example secret key decrypting means being slower, software algorithm secret key cryptographing, and the second example secret key cryptographing means being fast, hardware secret key cryptographing, with both example decrypting means loading the session key or one-time use only secret key into the cryptographic digital signal processor's (C-DSP's) hardware secret key unit which can decrypt the custom encrypted digital media.

49. The invention and processes of claim 48 whereby the process of or method of steps to do public key cryptographing which is the process done by provided, said cryptographic media player and its provided, embedded said cryptographic digital signal processor (C-DSP) means accomplished through the sub-steps of:
authenticating of play code digitally signed by the use of the unique and appropriate authorized media distribution vendor's private key which is pre-stored before factory release of the hardware chip in a common look-up table in the cryptographic digital signal processor (C-DSP) means which is the sub-step done by the cryptographic digital signal processor (C-DSP) means which holds the complete, pre-embedded, common look-up table, vendor indexed, private key and public key set of all authorized media distribution vendors, which cryptographic digital signal processor (C-DSP) means uses pass-thru encrypting process 15 and pass-thru encrypting return process 16, to first retrieve the play code from the media ticket smart card A, for customer party A, and pass-thru decrypt the play code, and then uses the correct vendor public key from the pre-embedded, common look-up table, vendor indexed, vendor private key and public key set of all authorized media distribution vendors, to digital signature verify the presently non-cipher text or presently signatured text of the unique, session key, which was already digitally signed by the use of the unique, media distribution vendor private key at downloading to customer A of process 10 or also called media distribution time, to reveal the decrypted session key ready for use on the custom encrypted digital media.

50. The invention or processes of claim 49 whereby the process of or method of steps to do secret key cryptographing which is the process done by provided, said cryptographic media player with its embedded, provided, said cryptographic digital signal processor (C-DSP) means through certain applicable sub-steps selected from the group consisting of:
decrypting of the custom encrypted digital media using software algorithm, slower, double secret key cryptographing, which is the sub-step done by the cryptographic digital signal processor (C-DSP) means using the decrypted session key (one-time secret key) from the matching unique play code for slower, software algorithm implemented by firmware computer program secret key cryptography, without use of a silicon compiler designed, dedicated fast hardware secret key unit, by loading said decrypted session key or one-time secret key into the cryptographic digital signal processor's (C-DSP) means which can software decrypt the custom encrypted digital media, furthermore, with exactly analogous firmware secret key decryption using the unique vendor secret key, and,
decrypting of the custom encrypted digital media which is actually double secret key encrypted, first with the unique originating vendor secret key and secondly with the unique customer session key or one-time use only secret key, using a silicon compiler designed duo-unit specifically doing, fast, hardware double secret key cryptographing, which is the sub-step done by the cryptographic digital signal processor (C-DSP) means using the unique customer decrypted session key (one-time secret key) from the unique relevant play code for fast, hardware secret key cryptographing by loading said decrypted session key or one-time secret key into the cryptographic digital signal processor's (C-DSP) means, silicon compiler designed, prior art, specific hardware secret key unit which can fast hardware decrypt the custom encrypted digital media, followed in an exactly similar manner by the hardware loading of the unique vendor secret key.

51. The invention or process of claim 50 whereby the process of secret key cryptographing uses standardized, algorithm means involving several processes and components of a first algorithm means being older and field and time proven but of growing obsolescence, bit oriented (approximately ten to one-hundred times faster when executed in a dedicated bit-manipulative digital hardware silicon compiler designed library component unit), US Patented (expired), IBM Data Encryption Standard (DES), which comes in several modes and secret key strengths measured in key bit-length, and a second algorithm means being newer, fully unproven algorithm in both field and time trials, a byte (8-bit) oriented, Advanced Encryption Standard (AES) cipher which was designed for faster, software algorithm implementation and scalability of the bit-length of increasing key strength with time to deter scalable computing attacks on fixed length secret key length, and third example secret key algorithm means being newer, field and time proven, fixed secret key length, IDEA (R), under European patent.

52. The invention and processes of claim 50 whereby the process of or method of steps to do accounting by said cryptographic media player with its provided, embedded said cryptographic digital signal processor (C-DSP) means which is the process done by the provided, cryptographic media player using hybrid key cryptography digital media playing of one-way transfer of custom session key encrypted digital media owned by party n in a controlled access manner mostly for financial accounting purposes which uses the play codes (session key or one-time secret key) and play counts (paid for number of plays or count of free trial plays) contained in media ticket smart cards, accomplished through the sub-steps of:
authenticating step done in high security applications which sub-process step is simply skipped as being unnecessary in low security applications for citizen/customer time and effort consideration, of customer triangle authenticating using the process of claim 47 of:
point 1 of customer a, to
point 2 of media ticket smart card a, to
point 3 of cryptographic media player,
authenticating of the media triangle authenticating by the process of claim 44 consisting of:
point 1 of one-way transfer of custom session key encrypted digital media, to
point 2 of media ticket smart card A with appropriate play codes and play counts, to
point 3 of cryptographic media player,
notifying of the customer of any errors in the above two sub-steps, transferring by the media ticket smart card to the cryptographic digital signal processor (C-DSP) means of the pass-thru encrypting means of cryptographic keys comprising of customer private key (PrK-n), play count with header, and play code with header all with sequence numbers using the process of claim 40,
verifying of decrypted play count greater than one which is the sub-step done by a cryptographic digital signal processor (C-DSP) means inside of a cryptographic media player checking the obtained decrypted play count for a greater than one number indicating authorized and paid for plays remaining while a −1 value for a count can be a means of indicating an infinite number of plays,
decrementing of play count which is the sub-step done by the cryptographic digital signal processor (C-DSP) means of decrementing of the play count,
incrementing of customer (pass-thru encryption use) sequence number by the cryptographic digital signal processor (C-DSP) means to prevent recorded replay attacks,
transferring by the cryptographic digital signal processor (C-DSP) means to the media ticket smart card of the pass-thru encrypting return means of process 41 of the updated for sequence number cryptographic keys comprising of customer private key (PrK-n), and the updated for sequence number and accounting decrements both the play count with header, and the play code with header all with incremented sequence numbers.

53. The invention and processes of claim 52 whereby the process of or method of steps to do playing by provided, said cryptographic media player with its provided, embedded said cryptographic digital signal processor (C-DSP) means which is the process using hybrid key cryptography to do digital media playing in a controlled access manner using play codes (session key or one-time secret keys) and play counts (now contained within registers in provided, said cryptographic digital signal processor (C-DSP) means) and also the secret key decryption directly used upon the custom encrypted one-way transfer of custom session key encrypted digital media which is pre-unique vendor secret key encrypted, accomplished through the sub-steps of:
detecting of non-copyrighted commercial or home-made material through an absence of encryption through the use of media triangle authenticating of process 47 which will allow hardware decompression of standard form compressed digital media through prior art digital compression means such as Moving Picture Electronics Group X (MPEG X) for audio/video, Moving Picture Electronics Group Standards I Audio Layer 3 (MP3) for audio only, fast wavelet compression (Fraunhoeffer Institute), artificial digital degradation, and digital to analog conversion (DAC) for analog output while skipping the following sub-steps,
cryptographing by the cryptographic digital signal processor (C-DSP) means using hybrid key cryptography playing of the custom encrypted digital media using the process of claim 48 for the unique vendor secret key,
cryptographing by the cryptographic digital signal processor (C-DSP) means using hybrid key cryptography playing of the custom encrypted digital media using the process of claim 48 for the unique session key or one-time only use secret key obtained by said cryptographic digital signal processor (C-DSP) means from said unique play code or the pass-thru encrypted, unique decryption key (this is a very fast, double secret key decryption process which secures the decrypted (‘plain text’) digital masters to the exclusive knowledge of the unique media origination vendor who may or may not be the media distribution vendor) (remember that the unique encrypted (‘cipher-text’) digital media is completely useless without the corresponding matching said play code or decryption keys, and said non-zeroed remaining play, play count, or accounting charges),
accounting by the cryptographic digital signal processor (C-DSP) means of the custom encrypted digital media using the process of claim 52.

54. The invention and processes of claim 53 whereby the process of or method of steps to do escrowing retrieval of lost, stolen, or disputed ownership media ticket smart cards which is the process done by the customer, party n, which collection of processes of or methods of invention sets systems standards and integrates components into a system which can be used in the future for new forms of internationally standardized cryptography sanctioned by industry trade groups such as the Recording Industry Association of America's (RIAA's) Secure Digital Music Initiative (SDMI), the National Association of Broadcaster's (NAB's) Secure Digital Broadcast Group (SDBG), and also national standards agencies such as the American National Standards Institute (ANSI), National Institute for Standards and Technology (NIST), or international telegraphy union (ITU), accomplished through the sub-steps of:
reporting of lost, stolen, or disputed legal ownership media ticket smart cards by the customer, party A, to the central public key distribution authority, party D,
canceling of the existing card by the public key distribution authority, party D, in its customer database,
retrieving by the central public key distribution authority, party D, from the central public key escrow authorities, parties En, of the old customer public key pair,
issuing of a new card by the public key distribution authority, party D, with a new customer public key pair,
retrieving by the central public key distribution authority, party D, from all media distribution vendors, parties Vn, of existing partially encrypted customer's, party A's, play codes and play counts stored in computer database (which will not have the latest play count of the lost card which does not matter for infinite plays or free trial plays and financial compensation can be made for finite play counts) from all download sessions which can be restored with customer's, party A's, new public keys done by the process of:
```
d-prk-a-old(
    remove mac(vin),
    remove session identification number,
    remove customer (pass-thru encryption use) sequence number,
    (d-fak-F
            (pass-thru encrypted play code with
                header (and sequence numbers)
            ),
    )) = temp-23a,
d-prk-a-old (
        remove mac(vin),
        remove session identification number,
        remove customer (pass-thru encryption use) sequence
        number,
    (d-fak-F
            (pass-thru encrypted play count (with
                sequence numbers)
            ),
        )) = temp-23b,
```
imprinting the customer's, party A's, old play codes and play counts into the new media ticket smart card,
d-fak-F(
mac(vin),
session identification number,
d-puk-a-new(temp-23a),
customer (pass-thru encryption use) sequence number+1)=(new encrypted play code with header (and sequence numbers), d-fak-F( mac(vin), session identification number, d-puk-a-new(temp-23b), customer (pass-thru encryption use) sequence number+1)=(new encrypted play count with header (and sequence numbers),
delivering of the reconstructed, new media ticket smart card to the customer which should work with existing custom encrypted media and it will still work with the lost, stolen, or legally disputed old media ticket smart card.

55. The invention and processes of claim 54 whereby the process of or method of steps to do legal re-assigning of play code and play count ownership from media ticket smart A of owner A to media ticket smart card B of owner B which is legally called “first use” involving US Copyrighted digital media which is accomplished through the sub-steps of:
inserting of media ticket smart card A into the cryptographic digital signal processor (C-DSP) means inside of a cryptographic media player (e.g. C-MP3 player),
authenticating using the already defined process 14 of authenticating by customer triangle authentication,
transferring of all customer A play codes and play counts from the media ticket smart card A into the cryptographic digital signal processor (C-DSP) means including the customer A's private key and public key,
decrypting of customer A's play code and play count,
updating of vendor sequence number and customer (pass thru encryption use) sequence number,
committing 2-way operations of several cyclic loops from cryptographic digital signal processor (C-DSP) means to media ticket smart card and back again before finalizing transaction computer operations,
permanently erasing in media ticket smart card A any removed play codes and play counts owned by customer A,
removing of the customer A's media ticket smart card from the cryptographic media player,
inserting of media ticket smart card B into the cryptographic digital signal processor (C-DSP) means inside of a cryptographic media player (e.g. C-MP3 player),
authenticating using customer triangle authentication,
transferring of all customer B play codes and play counts from the media ticket smart card B into the cryptographic digital signal processor (C-DSP) means including the customer B's private key and public key,
decrypting of customer B's play code and play count,
creating a super-set list of play codes and play counts and re-encrypting them for customer B,
updating of vendor sequence number and customer (pass-thru encryption use) sequence number,
transferring the super-set list of play codes and play counts back to media ticket smart card B for cryptographic storage,
committing a minimum of 2-way operations of several cyclic loops from cryptographic digital signal processor (C-DSP) means to media ticket smart card and back again before finalizing transaction computer operations,
permanently erasing all play codes and play counts of either party A or party B from the cryptographic media player,
removing of the customer B's media ticket smart card from the cryptographic media player.

56. The invention and processes of claim 55 whereby the process of or method of steps to do legal archiving of custom encrypted digital media and also play code and play count ownership from media ticket smart A of owner A to back-up copies known as legal “fair use” under US Copyright law for means of archival storage in case of fire, theft, vandalism, storm, flooding, for a convenient home and car copy for marketing applications of the “fair use” legal doctrine, which is accomplished by the sub-steps of:
copying of “cipher text (encrypted data)” digital media in digital to digital copying mode an unlimited number of times using a personal computer (PC) or other digital to digital copying device to create flawless digital archival copies which are usable only with media ticket smart card A primary card or media ticket smart card A back-up card,
updating of primary card to back-up card operations to allow both to be used for archival copy decryptions,
inserting of media ticket smart card A primary card into the cryptographic digital signal processor (C-DSP) means inside of a cryptographic media player (e.g. C-MP3 player),
authenticating using customer triangle authentication by the process of claim 44,
transferring of all customer A primary card play codes and play counts from the media ticket smart card A into the cryptographic digital signal processor including the customer A's private key and public key,
decrypting of customer A's primary card play code and play count,
updating of vendor sequence number and customer (pass-thru encryption use) sequence number,
committing 2-way operations of several cyclic loops from cryptographic digital signal processor (C-DSP) means to media ticket smart card A primary card's tamper resistant non-volatile memory (TNV-EEPROM) and back again before finalizing transaction computer operations,
permanently erasing in media ticket smart card A primary card's tamper resistant non-volatile memory (TNV-EEPROM) any removed play codes and play counts owned by customer A,
removing of the customer A's media ticket smart card primary card from the cryptographic media player,
inserting of media ticket smart card A back-up card into the cryptographic digital signal processor (C-DSP) means inside of a cryptographic media player (e.g. C-MP3 player),
authenticating using customer triangle authentication by the process of claim 44,
transferring by pass-thru encrypting means of all customer A back-up card play codes and play counts from the media ticket smart card A back-up card into the cryptographic digital signal processor (C-DSP) means including the customer A's private key and public key,
decrypting of customer A's play code and play count,
creating a super-set list of play codes and play counts and re-encrypting them for customer A,
updating of vendor sequence number and customer (pass-thru encryption use) sequence number,
transferring the super-set list of play codes and play counts back to media ticket smart card A back-up for cryptographic storage,
committing 2-way operations of several cyclic loops from cryptographic digital signal processor (C-DSP) means to media ticket smart card A's tamper resistant non-volatile memory (TNV-EEPROM) back-up before finalizing transaction computer operations,
removing of the customer A's media ticket smart card back-up from the cryptographic media player,
inserting of media ticket smart card A primary card again into the cryptographic digital signal processor (C-DSP) means inside of a cryptographic media player (e.g. C-MP3 player),
authenticating using customer triangle authentication by the process of claim 44,
re-accessing in the cryptographic media player the already created super-set list of play codes and play counts and re-encrypting them for customer A,
updating vendor sequence number and customer (pass-thru encryption use) sequence number,
transferring the super-set list of play codes and play counts back to media ticket smart card A back-up for cryptographic storage,
committing 2-way operations of several cyclic loops from cryptographic digital signal processor (C-DSP) means to media ticket smart card A back-up before finalizing transaction computer operations,
permanently erasing all play codes and play counts of either party A primary card or party A back-up card from the cryptographic media player,
removing of the customer A's media ticket smart card primary from the cryptographic media player.

57. A specific method of or process for doing public key cryptography over an open systems architecture in a totally cryptographically secure manner meant for safeguarding multi-million dollar digital masters which open systems architecture includes existing prior art components to give a new art system of processes or a process patent of public key cryptography comprising of the process steps of:
providing of prior art, a tamper-resistant non-volatile electrically erasable programmable read-only memory (TNV-EEPROM) which can be in an external dedicated chip and also in an on-chip micro-controller design, which is used to hold embedded, brief in length, cryptographic computer programs, cryptographic system keys with first example cryptographic keys being family keys or shared secret keys, second example cryptographic keys being cryptographic private keys, third example cryptographic keys being secret keys, fourth example cryptographic keys being session keys, and fifth example cryptographic keys being cryptographic public keys,
providing of prior art, an electrically erasable programmable read-only memory (EEPROM) which can come in a larger dedicated chip and also in an on-chip micro-controller design, used to hold, non-secure, computer programs (firmware) which are usually stored on separate and dedicated EEPROM memory chips which are connected to the digital computer processor through an input-output (I/O) bus with an on-processor instruction cache usually made of two layers: a L1 cache of faster, static RAM, and a L2 cache of very fast, associative memory or on-chip banked registers used to locally hold pages of operational codes (op codes) for fast execution,
providing of prior art, a static random access memory (SRAM) which can come in a larger dedicated chip and also in an on-chip micro-controller design with an on-chip input-output (I/O) bus with SRAM preferred over DRAM on-chip for faster speed and no need of a memory refresh cycle at the cost of one-fourth less bit density, for faster temporary storage of dynamic data which is usually in the form of separate and dedicated SRAM memory chips which are connected to the digital computer processor through an input-output (I/O) bus with an on-processor data cache of one or more levels (L1 cache being SRAM and L2 cache being associative memory or registers) used to locally hold pages of dynamic computer data for fast data cache access,
providing of prior art, a dynamic random access memory (DRAM) which can come in a larger dedicated chip and also in an on-chip micro-controller design using an on-chip input-output (I/O) bus with on-chip SRAM preferred over DRAM in micro-controllers for faster speed and no memory refresh cycle, with the latest example of fast DRAM being duo-data rate, synchronous, dynamic random access memory (DDR-SDRAM) which can hold either operational codes (for non-firmware based computer programs) or dynamic data (especially large arrays and large chunks of data such as video ‘frame buffers’), with the DRAM being an acknowledged bottle-neck on the central processor unit (CPU) bus with another greater bottle-neck being the transfer of digital data over the peripheral device or input-output (I/O) bus and its much slower often electromechanical input-output (I/O) devices,
providing of prior art, a low-cost, low-throughput, cryptographic embedded micro-controller (c-uCtlr) with scalar control operations, slow fixed-point arithmetic processing, and very slow, floating point interpreter based floating point processing (lacking a hardware floating point unit (FPU)), as used in a prior art, 8-bit, single chip solution, micro-controller based, smart card as widely used in Europe for over twenty years with universal success over-coming in all forms of human abuse and adverse weather conditions, with said tamper resistant non-volatile memory, random access memory (TNV-EEPROM), holding both cryptographic keys and very limited amounts of embedded secure cryptographic algorithm firmware for the entirely on-chip execution of cryptographic algorithms (secret key encryption-decryption, public key encryption-decryption, message digest ciphers (MDC's), message authentication ciphers (MAC's)), furthermore, possessing an on-chip input-output (I/O) bus in a micro-controller architecture with on-chip limited, static random access memory (SRAM) for fast dynamic data storage, and on-chip limited electrically erasable programmable read only memory (EEPROM) for computer firmware program storage, furthermore, possessing a wiretapable (‘red’) smart card serial data bus to the external world which is used for initial unique customer access code communications from a digital computer into the smart card to activate it, and then is subsequently used for reverse direction communications of internal smart card secure memory values representing cash to debit and also accounting access counts used in pass-thru encryption to transfer encrypted (‘cipher-text’) data from the cryptographic micro-processor (c-uP) inside the smart card to a smart card reader and pass-by processing proceeding to a digital computer which must do pass-thru decryption and pass-thru encryption for the return closed feed-back response communications exchange of possibly debited monetary values or incremented access counts needing secure storage in the smart card,
providing of prior art, the smart card used for media ticket applications containing tamper resistant, non-volatile memory (TNV-EEPROM) for key storage as part of cryptographic embedded micro-processors (c-uP's),
providing of prior art, serial data computer communications interfaces such as a personal computer (PC) based, serial bus connected (e.g. Universal Serial Bus or USB bus, and the faster and longer distance but more expensive, IEEE 1394 serial bus (‘Fire wire bus’)), used to connect a personal computer (PC) to a digitized human fingerprint reader and for other computer peripheral purposes,
providing of prior art, a smart card reader means involving several invention processes which simply reads the customer inserted smart card's pass-thru encrypted data and passes it over wiretapable (‘red’) buses to the digital computer, furthermore, a first example form of smart card reader means has physical metallic contacts with a power pin used to re-charge any smart card internal battery from an additional AC power line going into the smart card reader and suitable voltage conversion and regulation electronics, furthermore, a second example smart card reader means is a popular class of prior art, smart cards which have an optical interface which lacks any form of smart card battery re-charging capability but has improved durability, a third example smart card reader is a prior art, integrated smart card reader with bio-ID digitized fingerprint reader, furthermore, the smart card reader is a dumb and inexpensive computer serial data bus device with a first example serial communications interface being a prior art, serial data bus given as a universal serial bus (USB) providing maximum 3.0 Mega bits/second data transfer over a maximum 3.5 feet distance, which has no local area networking (LAN) interfaces which must be provided by the attached digital computer, a second example serial communications interface being a prior art, IEEE 1394 (‘Fire wire’) serial data bus which transfers a maximum of 10.0 Mega bits/second at a distance of up to a maximum of 10.0 feet,
providing of prior art, biological-identification (bio-ID) reader means which attach to personal computers (PC's) using a low-cost serial data bus such as a universal serial data bus (USB bus) with a first example bio-ID reader means being a smart card reader with piggy-backed, integrated, digitized fingerprint, bio-identification (bio-ID) reader for very customer convenient use, with an example customer use of a low security and unattended by a ‘warm-blooded’ authorized gate-keeper, bio-ID means of ‘warm-blooded’ index finger insertion into a digitized fingerprint reader and smart card insertion at the same time, a second example bio-ID reader means is a prior art, smart card reader with external AC power supply and power conversion and regulation transformers along with a piggy-backed ‘warm-blooded’ iris scan reader digital video-camera electronics which said iris scan reader is attached by IEEE 1394 (‘Fire wire’) digital cable to a digital video camera,
providing of prior art, an internet protocol (IP), wide area network (IP WAN),
providing of prior art, a world wide web server (WWW) or web or graphics rich portion of the Internet web server computer,
providing of prior art, a personal computer (PC), which is non-cryptographically secure,
providing of prior art, a personal computer (PC) web client,
providing of prior art, a personal computer (PC) peripherals,
providing of prior art, a data entry devices of an on-board protected electronic device, toggle field with a prior art liquid crystal display (LCD) for entry of the unique customer passphrase with closely corresponding passcode entry,
providing of prior art, a data entry device of computer keyboards used for unique customer password, and passphrase-passcode entry with wiretapable (‘red bus’) computer keyboard buses vulnerable to the known prior art, hacker tools of both software and hardware based keyboard capture buffers,
providing of prior art, a banked-EEPROM card reader-writer connected by a prior art, serial bus connected with first example serial bus being the Universal Serial Bus (R) (USB bus) connected banked non-volatile memory chip card reader-writer serial bus interface unit to an electronic device, with first example banked non-volatile memory chip card unit which inserts into the reader being a banked, electrically erasable programmable read only memory (banked-EEPROM) card unit (e.g. Sans Disk (R) card, or SD (R) card), and second example banked non-volatile memory chip card unit being a single, large chip tamper-resistant non-volatile electrically erasable programmable read-only memory (TNV-EEPROM) (e.g. Memory Stick (R) chip),
providing of prior art, a personal computer's (PC's) peripheral data storage devices such as hard disk drives (HDD's), compact disk (CD) record once (CD-R (R)) drives, compact disk read-write (CD-RW (R)) drives which all offer ‘backwards compatible’ CD media which can be used in read-only modes compatible with older, existing read-only CD drives (CD), also writable digital versatile disk (DVD) drives (e.g. DVD+RW (R), DVD-RW (R), DVD-RAM (R) which all offer ‘backwards compatible’ media which can be used in read-only modes compatible with older, existing read-only DVD drives (DVD-ROM),
providing of prior art, a personal computer's (PC's) based peripheral data storage media units (e.g. back-up devices, video devices, fast floppy drives (e.g. Iomega (R) Zip (R) drives), removable hard disk drives (removable HDD) (e.g. Iomega Jazz (R) drives)),
providing of prior art, a cryptographic digital signal processor (C-DSP) means designed for low-cost, very fast digital processing of fixed-point number array or arrays of fixed radix numbers having limited necessary precision typically less than 32-bits arranged in matrix arrays (32-bit integers with an assumed radix point which cannot move with a default assumed decimal point which cannot move) as popularly used in the Texas Instruments (TI) TMS-320 DSP and also the AT&T DSP-1, with major DSP features being an accumulator based design with arithmetic operation over-flow handling, no-overflow registers, pipelined design to DRAM connected over a central processor unit bus, constants for an ith round held as register variables for quick update for the (i+1)th round, and programming-time, programmable firmware libraries supporting flexible digital signal processing for different applications, furthermore, giving fast scalar control processing without a need for floating point operation re-normalization based upon exponents, with a floating point interpreter for limited floating point operations involving floating point number formats with exponents, furthermore, also having additional silicon compiler designed components of embedded tamper resistant non-volatile electrically erasable programmable read only memory (TNV-EEPROM) with a first example cryptographic digital signal processor (C-DSP) means being a standard DSP combined with the silicon compiler functions of the prior art, US National Institute of Standards and Technologies (NIST's) Clipper chip, being the Skipjack secret key algorithm as implemented in a silicon compiler with on-chip tamper resistant non-volatile memory (TNV-EEPROM), sub-circuit, single integrated circuit (‘single chip IC solution’) design giving stream cipher and block cipher encryption and decryption functions (additionally used in the prior art, Capstone program using a plug-in PC card (R) format once called PCMCIA having an embedded Clipper ASIC chip comparable to a prior art smart card program), which were both programs and standards were based upon the dedicated, custom designed ASIC, hardware integrated circuit (IC) implementation of the National Security Agency (NSA) developed, classified Clipper chip implementing the Skipjack secret key algorithm with on-chip tamper resistant non-volatile memory (TNV-EEPROM), second example cryptographic digital signal processor (C-DSP) means being standard digital signal processing (DSP) functions combined with silicon compiler functions implementing the Chandra patent (U.S. Pat. No. 4,817,140 issued on Mar. 28, 1989 and assigned to IBM Corporation), and third example cryptographic digital signal processor (C-DSP) means being numerous other US Patents and also public art, non-patented technical literature,
providing of prior art, a cryptographic digital signal processor (C-DSP) means intended for very fast processing of large fixed-point arrays of fixed-point or fixed radix numbers as shown in the prior art, Texas Instruments (TI) TMS-320 DSP and also the AT&T DSP-1, additionally containing a cryptographic hardware secret key algorithm sub-processor, tamper resistant non-volatile electrically erasable programmable read only memory (TNV-EEPROM), random access memory (RAM), analog to digital signal converters (ADC), moving picture electronics group standards X (MPEG X) hardware decompression only circuitry for digital audio/video, digital audio/video signal artificial degradation circuitry, digital to analog signal converters, and digital signal processing of digital audio/video signals circuitry,
providing of new art, cryptographic digital signal processor (C-DSP) means designed for low-cost, very fast, digital processing of fixed-point number arrays as shown in the prior art, popularly used, Texas Instruments TMS-320 DSP and also the AT&T DSP-1, furthermore, having additional silicon compiler designed components adding embedded tamper resistant non-volatile electrically erasable programmable read only memory (TNV-EEPROM) for secure cryptographic key storage, along with both tamper resistant to pin-probers, and cryptographically protected on-chip, firmware implemented new art, byte-oriented, secret key algorithm based secret key encryption and decryption for both stream oriented and block oriented encryption and decryption processes, with on-chip hardware and firmware library support for both secret key and public key algorithms such as an electronic true random number generator, an on-chip hardware floating point unit (FPU) for processing large blocks of secret key encrypted and decrypted data using newer y. 2003 firmware based, byte oriented, secret key algorithms such as Advanced Encryption Standard (AES), an extremely large integer to an extremely large integer exponentiation unit using the binary square and multiply method commonly used in public key cryptography, with additional on-chip silicon compiler designed hardware support for digital decompression (read-only) algorithms, with additional on-chip silicon compiler support for digital compression algorithms, with additional on-chip silicon compiler support for forward error detection and correction coding (e.g. Reed-Solomon or RS coding) done in the encoding process sequential order of digitally compress, encrypt, error detect and correct, with decoding done in the exact opposite sequential process order, with a first example C-DSP means being discussed broadly in the present inventor's present patent's technical material which is not subject to this present over-all system's or methods patent application which uses such a device as a provided hardware component,
providing of a new art, programmable gate array logic (GAL) form of high density, application specific integrated circuit (ASIC) with embedded cryptographic digital signal processor (C-DSP) means functions as mentioned in the paragraph just above,
providing of new art, a cryptographic digital signal processor (C-DSP) means designed for very fast execution of fixed-point number arrays such as the popular Texas Instruments TMS-320 and also the AT&T DSP-1, furthermore, having additional silicon compiler based embedded, prior art, cryptographic hardware secret key algorithm sub-processors based upon prior art, standardized, secret key algorithms with an example algorithm being given as IBM's patented Data Encryption Standard (DES), with on-chip firmware support, an on-chip hardware floating point unit (FPU) for processing large blocks of secret key encrypted and decrypted data using newer y. 2003 firmware based, byte oriented, secret key algorithms such as Advanced Encryption Standard (AES), an extremely large integer to an extremely large integer exponentiation unit using the binary square and multiply method commonly used in public key cryptography, with additional on-chip silicon compiler designed hardware support for digital decompression (read-only) algorithms, with additional on-chip silicon compiler support for digital compression algorithms, with additional on-chip silicon compiler support for forward error detection and correction coding (e.g. Reed-Solomon or RS coding) done in the encoding process sequential order of digitally compress, encrypt, and error detect and correct, with decoding done in the exact opposite sequential process order, which in turn are silicon compiler design embedded hardware sub-units inside of said prior art, cryptographic digital signal processors (C-DSP's),
providing of prior art, a cryptographic micro-processor (c-uP) or a central processing unit (CPU) such as an Intel Pentium (R) CPU with a control unit, and also with an integrated fast, hardware, floating point unit (FPU), integrated memory management unit (MMU), integrated instruction and data cache unit, integrated bus interface unit (BIU), and additional proposed subset functionality of a C-DSP means including integrated tamper resistant non-volatile electrically erasable programmable read only memory (TNV-EEPROM), all on a single chip, which has impedance monitored intermetallic deposition layers protecting the entire chip from illegal pin probers used by hackers targeting the on-chip architecture including the protected (‘black’) on-chip buses, and also for protecting the entire chip from wiretapping pin probers used to illegally read cryptographic keys stored on the on-chip said embedded, tamper resistant non-volatile electrically erasable programmable read only memory (TNV-EEPROM), with the main anti-tamper means being the automatic on-chip erasure of cryptographic memory (TNV-EEPROM) holding all cryptographic keys upon the fully automatic detection of any signs of chip tampering,
providing of new art, a cryptographic computing based unit (C-CPU) also having a subset of cryptographic digital signal processing (C-DSP) means having much more on-chip, hardware, floating point (FPU) throughput capacity than the C-DSP chip and a more powerful memory management unit (MMU) capability, while having subset security functionality as the cryptographic digital signal processor unit (C-DSP) means being on-chip tamper resistant non-volatile electrically erasable programmable read-only memory (TNV-EEPROM) or cryptographic memory for both cryptographic key storage and cryptographic algorithm firmware storage, automatic on-chip impedance monitoring of a whole chip inter-metallic layer with automatic erasure of cryptographic memory upon tamper detection, silicon compiler library designed on-chip functions with automatic placement and routing, on-chip support for read-only commercial players using an embedded C-CPU of a tamper protected, error detection or correction unit (e.g. Reed-Solomon unit), on chip support for read-only commercial players using an embedded C-CPU of a tamper protected (‘black unit’), embedded, secret key decryption sub-unit which supports both dedicated hardware and dedicated firmware secret key decryption of play-back mode only, uniquely secret key encrypted, commercial media, on-chip tamper protected digital de-compression only support in play-back only mode for standard form digital media (e.g. MP3 being discrete cosine transform (DCT) based, MPEG X being discrete cosine transform (DCT) based, fast wavelet transform (FWT) audio-video being covolutional coding based, JPEG being discrete cosine transform (DCT) based, JPEG 2000 being fast wavelet transform (FWT) or convolutional coding based, Fraunhoeffer Instititute fast wavelet transform (FWT) audio (R ) convolutional coding, AAC (R) brand convolutional coding) widely used in commercial media players, with more general bi-directional use in crypto-cell phones and crypto-hand-held computers for similar on-chip support respecting relevant process sequential orders being digitally compress media, encrypt media, error detection bits added, which must be undone in cryptography in the exact reverse sequential order, for the hardware and firmware based encryption and decryption of digital media data, but, without current on-chip support for encrypted operation codes (c-op codes) usable in the future for cryptographic computer programs and cryptographic multi-media programs, with a first example C-CPU means being discussed in the present inventor's present invention,
providing of new art, a non-cryptographic media player (MP) based upon prior art, non-cryptographic digital signal processor (DSP) means with starting functionality of the popular Texas Instruments TMS-320 DSP, constructed with serial bus connections to customer insertable and removable prior art, smart card reader-writer unit interfaces, and a read-only drive unit for standard physical format, digital media which is very similar in computer architecture to prior art, electronic-book readers which have a built-in, very small, liquid crystal display (LCD), and are similar in physical form to non-cryptographic compact disk players,
providing of new art, a cryptographic media player (c-MP) constructed with said, prior art, cryptographic digital signal processor (C-DSP) means having serial bus connections to customer insertable and removable prior art, smart card reader-writer unit interfaces, and also having a read-only drive unit for standard media with first example, read-only, media means being compact disk record once (CD-R), second example read-only media means being compact disk compact disk read-write (CD-RW), and third example read-only media means being banked non-volatile memory card (banked EEPROM), and fourth example read-only media means being digital versatile disk record once (DVD-R),
providing of new art, a cryptographic personal computer (c-PC) which is created by using new art, said cryptographic digital signal processor (C-DSP) means based plug-in, peripheral or contention bus or input-output bus (I/O bus) cards for prior art, personal computers (PC's), with the peripheral bus giving an interface to the motherboard's said cryptographic central processing unit (C-CPU) which in turn has a Universal Serial Bus (USB) interface to a USB based smart card reader,
providing of new art, a cryptographic personal computer (c-PC) having a subset functionality of C-DSP means, which is created by using a prior art, standard off-the shelf personal computer (PC) design with a cryptographic central processing unit (C-CPU) with the goal of creating an internal secure bus hardware or ‘black bus’ computer architecture system also having insecure hardware bus or ‘red bus’ or open wiretapable buses, which furthermore requires a new art, cryptographic operating system (C-OS),
providing of new art, a cryptographic media player (c-MP) for playing back custom secret key encrypted, compressed digital, audio-video in standard format with first example compressed digital audio-video being given as prior art, Moving Picture Electronics Group Standards X (MPEG X) and second example compressed digital audio-video being given as prior art, fast wavelet audio-video digital compression also called convolutional coding, furthermore, said player contains embedded, cryptographic computing units (C-CPU's) with serial bus interfaces to built-in, prior art, smart card reader units, and also having built-in, prior art, input/output (I/O) peripheral bus connected, computer industry standard, peripheral data storage drives in first example drive being a compact disk read only (CD) drive which reads compact disk record once format (CD-R),
providing of new art, a universal cryptographic set-top box form of media players (c-MP's) for playing back custom secret key encrypted, high definition television (HDTV) broadcasts and standard definition television (SDTV) broadcasts, as well as for playing custom secret key encrypted, cable channel programming, as well as for playing custom secret key encrypted satellite television programming which are based upon a more powerful, cryptographic media player computer architecture (c-MP),
providing of new art, a cryptographic micro-mirror module (c-MMM)-commercial theater projection-theater sound units which are special cryptographic media players which use prior art, more than one drive, digital versatile disk read only (DVD) drive units which also read digital versatile disk record (DVD-X) formats, furthermore, the DVD-X disks contain custom encrypted compressed digital media which can be decrypted only with a corresponding, unique, smart card programmed in a prior art, standard, personal computer (PC) over the wiretapable (‘red bus’) Internet as a special media ticket smart card using the methods of the present inventor's patent,
providing of prior art, a modified secure operating system (secure-OS) for world wide web (WWW) server computers which will custom customer session key encrypt a vendor secret key encrypted digital master, and electronically distribute custom, encrypted digital media masters, using firewalls, using anti-viral software updated weekly, using network protocol converters, using standard layered security methods, and using ‘inner sanctum’ protection for vendor session key or one-time secret key encrypted digital media masters,
providing of prior art, a world wide web (WWW) transmission control protocol-internet protocol (TCP-IP) command protocol stack program for Internet connectivity,
providing of prior art, standard, a plurality of cryptographic mathematics algorithms,
providing of prior art, a plurality of public key cryptography algorithms which create public keys and private keys,
providing of prior art, a plurality of secret key cryptography algorithms which create secret keys and session keys (1-time secret keys) and also play counts or access counts or media decryption counts and play codes (session keys or 1-time secret keys),
providing of prior art, a plurality of hybrid key cryptography algorithms which are combined public key and private key cryptography algorithms (prior art),
providing of prior art, a plurality of private key and secret key splitting algorithms,
providing of prior art, a plurality of private key and secret key escrow techniques,
providing of prior art, a plurality of algorithms used to generate: cryptographic keys which are the collective public keys, private keys, secret keys, session keys (1-time use only secret keys), play counts, play codes, passphrases-passcodes,
providing of prior art, a plurality of computer cryptography protocols,
providing of prior art, a plurality of pass-thru encryption algorithms for transmitting secure data over wiretapable computer buses (‘red buses’),
providing of prior art, standardized form, a plurality of lossy compressed digital media algorithms with first example algorithm being given as MPEG X (R) based upon a SVGA (R) video format and also newer UXGA (R) higher resolution video formats, second example algorithm being given as MP3 (R) based upon pulse code modulated (PCM's) audio sound only, third example algorithm being given as JPEG X (R) for still color photography only with JPEG being discrete cosine transform (DCT) based and JPEG 2000 being fast wavelet transform (FWT) compression based, fourth example algorithm being given as fast wavelet transform (FWT) audio-video, fifth example algorithm being given as proprietary Advanced Audio CODEC (R) (AAC (R)) using a FWT algorithm variant, sixth example algorithm being given as Fraunhoeffer Institute fast wavelet transform (FWT) audio (R who are the original international patentees for convolutional coding based lossy digital compression,
providing of prior art, a transmissions control protocol/internet protocol (TCP/IP) for Internet connectivity,
providing of prior art, a secure internet protocol layer (secure IP layer) layer of Internet data encryption,
providing of prior art, a secure sockets layer (SSL) layer of Internet data encryption,
providing of prior art, a plurality of world wide web (WWW) server standard interchange file language with first example protocol being hyper-text mark-up language (HTML), second example protocol being extensible business mark-up language (XBML or XML), and third example protocol being generalized-text mark-up language (GTML),
providing of a plurality of world wide web (WWW) client standard interchange file languages with first example being hyper-text mark-up language (HTML),
generating of a set of common system keys which is the process done by the media ticket smart card system authority's, party S's, dedicated public key generation authority, party G, while having absolutely no access to customer identifications,
generating of a set of media distribution vendor cryptographic keys eventually used in cryptographic digital signal processors (C-DSP's) for eventual manufacturing into cryptographic media players which is the process done by the media ticket smart card system authority's, party S's, dedicated public key generation authority, party G, while having absolutely no access to customer identifications,
generating of a media ticket smart card cryptographic key set or unique customer cryptographic key set, which is the process done by the media ticket smart card system authority's, party S's, dedicated public key generation authority, party G, while having absolutely no access to customer identifications,
distributing of said cryptographic digital signal processors (C-DSP's) which is the process done by the media ticket smart card system authority's, party S's, dedicated public key distribution authority, party D, distributing cryptographic digital signal processors (C-DSP's) (with party G having already pre-embedded an entire set of a unique per vendor, common cryptographic key table into each and every cryptographic digital signal processor (C-DSP) means) to media distribution vendors, parties Vn, for manufacturing into cryptographic media players while having absolutely no access to whole cryptographic keys,
distributing of the media ticket smart cards which is the process done by the media ticket smart card system authority's, party S's, dedicated public key distribution authority, party D, distributing media ticket smart cards to media distribution vendors for selling to customers while having absolutely no access to whole cryptographic keys,
escrowing of the split cryptographic keys which is the process done by the central key generation authority, party G, safe-guarding the split cryptographic customer keys, and split cryptographic vendor keys in an entirely secure and confidential manner with legal first means for simple customer identification and lost key recovery, second means for disputed ownership court ordered recovery, and third means for court ordered only use by law enforcement,
layering for a federated cryptography architecture which is the process done by the media ticket smart card system authority, party S, creating a federated architecture of cryptographic authority with 3-layers, a central layer composed of the media ticket smart card system authority, a local layer composed of authorized media distribution companies Vn, and a user layer composed of customers,
preparing of a unique play code and a unique play count which is the process done by the authorized digital media distribution company, party Vn, preparing a unique play code (session key or one-time secret key), a unique play count (paid for numbers of plays or counts of free trial plays), and custom encrypted digital media for downloading to each customer,
downloading to customer, party A, which is the process done by the authorized digital media distribution vendor, party Vn, using hybrid key cryptographing steps of hybrid key cryptographic digital media distribution from a central media distribution authority hosted on a World Wide Web (WWW) server to multiple personal computer (PC) based World Wide Web (WWW) clients of encrypted play codes (one-time secret keys or session keys) with header and encrypted play counts (paid for counts of plays or decryptions, or else counts of free trial plays) with header for deposit into media ticket smart cards attached to personal computer (PC) based media ticket smart card readers, and one-way transfer of custom session key or one-time secret key encrypted digital media which is pre-unique vendor secret key encrypted for deposit into physical digital media inserted into media drives attached to personal computers (PC's),
delivering by foot which is the process done by the customer, party A, of physically transferring both physical custom encrypted digital media and the customer, party A's, programmed media ticket smart cards from the customer's, party A's, personal computer to any person's cryptographic media player with a built-in media ticket smart card reader,
encrypting using pass-thru means involving several processes and components for transferring any type of digital data securely from the media ticket smart card up to the crytographic digital signal processor (C-DSP) means with first example pass-thru encrypting means being common family key or shared secret key encryption which is known to be vulnerable to a single point of attack, second example pass-thru encrypting means being a pre-embedded, common look-up table of unique vendor public key and matching private keys with organizational means involving several processes and components such as first organizational means being a row, column table indexed by a vendor identification number, third example pass-thru encrypting means being a pre-embedded common look-up table of unique vendor secret keys with organizational means involving several processes and components with first organizational means being a row, column table indexed by a vendor identification number,
encrypting using pass-thru return means involving several processes and components for transferring any digital data from the cryptographic digital signal processor (C-DSP) means to the media ticket smart card with first example pass-thru encrypting return means being common family key or shared secret key encryption which is known to be vulnerable to a single point of attack, second example pass-thru encrypting return means being a pre-embedded, common look-up table of unique vendor public key and matching private keys with organizational means involving several processes and components such as first organizational means being a row, column table indexed by a vendor identification number, third example pass-thru encrypting return means being a pre-embedded common look-up table of unique vendor secret keys with organizational means involving several processes and components with first organizational means being a row, column table indexed by a vendor identification number,
initializing before playing which is the process done by the customer, party A, of preparing any party's cryptographic media player with his own custom encrypted digital media his own media ticket smart card,
authenticating by customer triangle authentication which is the process done by the cryptographic digital signal processor embedded inside of a cryptographic media player,
transferring of cryptographic keys to the cryptographic digital signal processor (C-DSP) means by pass-thru encrypting means of cryptographic keys which is the process done by the cryptographic media player to receive encrypted play codes with header and encrypted play counts with header from the media ticket smart card n transferred over wiretapable computer buses to the player's own cryptographic memory for access by its cryptographic digital signal processor (C-DSP) means,
transferring of cryptographic keys away from the cryptographic digital signal processor (C-DSP) means by pass-thru encrypting return means of cryptographic keys which is the process done by the cryptographic media player's cryptographic digital signal processor (C-DSP) means to transfer encrypted play codes with header and encrypted play counts with header both with cryptographic digital signal processor (C-DSP) means incremented sequence counts to the media ticket smart card A transferred over wiretapable computer buses,
authenticating using media triangle authentication which is the process of matching the unique digital media with its matching unique play code by the method done by a cryptographic media player using digital media triangle authentication using sample reads of test data with successful decryption,
cryptographing using hybrid key cryptography which is the process done by a cryptographic digital signal processor (C-DSP) means inside of a cryptographic media player using hybrid key cryptography which is the process of using hybrid key cryptography which uses public key cryptography to authenticate remote parties, do digital signatures to authenticate digital media and establish media integrity with a remote party, and encrypt one-time secret keys known as session keys (ssk-n), used for only one session, which said session keys are sent to a remote party who decrypts them for storage in his own tamper resistant, non-volatile memory (TNV-EEPROM) embedded on his black, cryptographic computing unit in the example of a prior art cryptographic digital signal processor (C-DSP) means and a cryptographic central processing unit (C-CPU) which said session keys may be later stored in tamper resistant non-volatile memory (TNV-EEPROM) embedded in a media ticket smart card where they are referred to as play codes with paid for and authorized play counts,
accounting by the cryptographic digital signal processor (C-DSP) means which is the process done by the cryptographic media player using hybrid key cryptography digital media playing of one-way transfer of custom session key encrypted digital media owned by party n in a controlled access manner mostly for financial accounting purposes which uses the play codes (session key or one-time secret key) and play counts (paid for number of plays or count of free trial plays) contained in media ticket smart cards,
playing by the cryptographic digital signal processor (C-DSP) means which is the process done by the cryptographic media player using hybrid key cryptography which is the process of using hybrid key cryptography to do digital media playing in a controlled access manner using play codes (session key or one-time secret keys) and play counts (now contained within registers in the cryptographic digital signal processor (C-DSP) means and also the double secret key decryption of first a unique customer session key decryption followed by a unique vendor secret key decryption used directly used upon the custom encrypted one-way transfer of custom session key encrypted digital media which is pre-unique vendor secret key encrypted with sequence number checks for countering recorded replay attacks,
escrowing retrieval of lost, stolen, or disputed ownership media ticket smart cards which is the process done by the customer, party n, which collection of processes of or methods of invention sets systems standards and integrates components into a system which can be used in the future for new forms of internationally standardized cryptography sanctioned by industry trade groups such as the Recording Industry of America Association (RIAA), the Secure Digital Music Initiative (SDMI), the US National Association of Broadcasters (NAB), and also national standards agencies such as the American National Standards Institute (ANSI), National Institute for Standards and Technology (NIST), or International Telegraphy Union (ITU),
whereby the present invention creates several processes in doing digital media distribution over the prior art Internet using secure World Wide Web (WWW) servers involving the cryptographically secure transfer or download to personal computers (PC's) of digital media with subsequent transfer to cryptographic media players,
whereby the present invention creates several processes in safeguarding multi-million dollar digital masters.

58. The process of claim 57 whereby the method or process of cryptographing using public key cryptography which is the process done by said cryptographic media player with its embedded said cryptographic digital signal processor (C-DSP) means using public key cryptography which is the process of using public key cryptography authentication, encryption, and decryption using public keys (puk-n), and private keys (prk-n), stored within tamper resistant non-volatile memory (TNV-EEPROM) embedded within non-wiretapable (“black”) cryptographic computing units in the example of cryptographic digital signal processors (C-DSP) means.

59. The process of claim 58 whereby the process or method of cryptographing using secret key cryptography which is the process done by said cryptographic media player with its embedded said cryptographic digital signal processor (C-DSP) means using secret key cryptography which is the process of using secret key cryptography with a non-wiretapable (“black”) bus, cryptographic computing unit in example of a cryptographic digital signal processing (C-DSP) means using secret keys (sek-n), or session keys (ssk-n), stored upon tamper resistant, non-volatile memory (TNV-EEPROM), consists of the sub-step of:
cryptographing using fast hardware session key cryptography which is the process done by a cryptographic digital signal processor (C-DSP) means inside of a cryptographic media player using hardware secret key cryptography which is the process of using a dedicated hardware secret key sub-processor which is embedded within a secure (“black”), cryptographic digital signal processing (C-DSP) means with access to higher level tamper resistant non-volatile (“black”) memory for cryptographic key storage of private keys and secret keys, which hardware secret key sub-processor is much faster than software for secret key cryptography and is intended for fast, secret key cryptography encryption and decryption of block transferred digital media.

60. A specific method of or process for doing public key cryptography over an open systems architecture in a totally cryptographically secure manner meant for safeguarding multi-million dollar digital masters for the specific process of “over the air,” broadband cable, broadband phone line, direct digital satellite, or Institute of Electrical and Electronic Engineers (IEEE 802.11c) wireless Ethernet distribution of custom pre-encrypted, “cipher text,” digital media in high definition television (HDTV)/standards definition television (SDTV) digital form which open systems architecture includes existing prior art components integrated into a new art systems process of:
providing of prior art, a tamper-resistant non-volatile electrically erasable programmable read-only memory (TNV-EEPROM) which can be in an external dedicated chip and also in an on-chip micro-controller design, which is used to hold embedded, brief in length, cryptographic computer programs, cryptographic system keys with first example cryptographic keys being family keys or shared secret keys, second example cryptographic keys being cryptographic private keys, third example cryptographic keys being secret keys, fourth example cryptographic keys being session keys, and fifth example cryptographic keys being cryptographic public keys,
providing of prior art, an electrically erasable programmable read-only memory (EEPROM) which can come in a larger dedicated chip and also in an on-chip micro-controller design, used to hold, non-secure, computer programs (firmware) which are usually stored on separate and dedicated EEPROM memory chips which are connected to the digital computer processor through an input-output (I/O) bus with an on-processor instruction cache usually made of two layers: a L1 cache of faster, static RAM, and a L2 cache of very fast, associative memory or on-chip banked registers used to locally hold pages of operational codes (op codes) for fast execution,
providing of prior art, a static random access memory (SRAM) which can come in a larger dedicated chip and also in an on-chip micro-controller design with an on-chip input-output (I/O) bus with SRAM preferred over DRAM on-chip for faster speed and no need of a memory refresh cycle at the cost of one-fourth less bit density, for faster temporary storage of dynamic data which is usually in the form of separate and dedicated SRAM memory chips which are connected to the digital computer processor through an input-output (I/O) bus with an on-processor data cache of one or more levels (L1 cache being SRAM and L2 cache being associative memory or registers) used to locally hold pages of dynamic computer data for fast data cache access,
providing of prior art, a dynamic random access memory (DRAM) which can come in a larger dedicated chip and also in an on-chip micro-controller design using an on-chip input-output (I/O) bus with on-chip SRAM preferred over DRAM in micro-controllers for faster speed and no memory refresh cycle, with the latest example of fast DRAM being duo-data rate, synchronous, dynamic random access memory (DDR-SDRAM) which can hold either operational codes (for non-firmware based computer programs) or dynamic data (especially large arrays and large chunks of data such as video ‘frame buffers’), with the DRAM being an acknowledged bottle-neck on the central processor unit (CPU) bus with another greater bottle-neck being the transfer of digital data over the peripheral device or input-output (I/O) bus and its much slower often electromechanical input-output (I/O) devices,
providing of prior art, a low-cost, low-throughput, cryptographic embedded micro-controller (c-uCtlr) with scalar control operations, slow fixed-point arithmetic processing, and very slow, floating point interpreter based floating point processing (lacking a hardware floating point unit (FPU)), as used in a prior art, 8-bit, single chip solution, micro-controller based, smart card as widely used in Europe for over twenty years with universal success over-coming in all forms of human abuse and adverse weather conditions, with said tamper resistant non-volatile memory, random access memory (TNV-EEPROM), holding both cryptographic keys and very limited amounts of embedded secure cryptographic algorithm firmware for the entirely on-chip execution of cryptographic algorithms (secret key encryption-decryption, public key encryption-decryption, message digest ciphers (MDC's), message authentication ciphers (MAC's)), furthermore, possessing an on-chip input-output (I/O) bus in a micro-controller architecture with on-chip limited, static random access memory (SRAM) for fast dynamic data storage, and on-chip limited electrically erasable programmable read only memory (EEPROM) for computer firmware program storage, furthermore, possessing a wiretapable (‘red’) smart card serial data bus to the external world which is used for initial unique customer access code communications from a digital computer into the smart card to activate it, and then is subsequently used for reverse direction communications of internal smart card secure memory values representing cash to debit and also accounting access counts used in pass-thru encryption to transfer encrypted (‘cipher-text’) data from the cryptographic micro-processor (c-uP) inside the smart card to a smart card reader and pass-by processing proceeding to a digital computer which must do pass-thru decryption and pass-thru encryption for the return closed feed-back response communications exchange of possibly debited monetary values or incremented access counts needing secure storage in the smart card,
providing of prior art, the smart card used for media ticket applications containing tamper resistant, non-volatile memory (TNV-EEPROM) for key storage as part of cryptographic embedded micro-processors (c-uP's),
providing of prior art, serial data computer communications interfaces such as a personal computer (PC) based, serial bus connected (e.g. Universal Serial Bus or USB bus, and the faster and longer distance but more expensive, IEEE 1394 serial bus (‘Fire wire bus’)), used to connect a personal computer (PC) to a digitized human fingerprint reader and for other computer peripheral purposes,
providing of prior art, a smart card reader means involving several invention processes which simply reads the customer inserted smart card's pass-thru encrypted data and passes it over wiretapable (‘red’) buses to the digital computer, furthermore, a first example form of smart card reader means has physical metallic contacts with a power pin used to re-charge any smart card internal battery from an additional AC power line going into the smart card reader and suitable voltage conversion and regulation electronics, furthermore, a second example smart card reader means is a popular class of prior art, smart cards which have an optical interface which lacks any form of smart card battery re-charging capability but has improved durability, a third example smart card reader is a prior art, integrated smart card reader with bio-ID digitized fingerprint reader, furthermore, the smart card reader is a dumb and inexpensive computer serial data bus device with a first example serial communications interface being a prior art, serial data bus given as a universal serial bus (USB) providing maximum 3.0 Mega bits/second data transfer over a maximum 3.5 feet distance, which has no local area networking (LAN) interfaces which must be provided by the attached digital computer, a second example serial communications interface being a prior art, IEEE 1394 (‘Fire wire’) serial data bus which transfers a maximum of 10.0 Mega bits/second at a distance of up to a maximum of 10.0 feet,
providing of prior art, biological-identification (bio-ID) reader means which attach to personal computers (PC's) using a low-cost serial data bus such as a universal serial data bus (USB bus) with a first example bio-ID reader means being a smart card reader with piggy-backed, integrated, digitized fingerprint, bio-identification (bio-ID) reader for very customer convenient use, with an example customer use of a low security and unattended by a ‘warm-blooded’ authorized gate-keeper, bio-ID means of ‘warm-blooded’ index finger insertion into a digitized fingerprint reader and smart card insertion at the same time, a second example bio-ID reader means is a prior art, smart card reader with external AC power supply and power conversion and regulation transformers along with a piggy-backed ‘warm-blooded’ iris scan reader digital video-camera electronics which said iris scan reader is attached by IEEE 1394 (‘Fire wire’) digital cable to a digital video camera,
providing of prior art, an internet protocol (IP), wide area network (IP WAN),
providing of prior art, a world wide web server (WWW) or web or graphics rich portion of the Internet web server computer,
providing of prior art, a personal computer (PC), which is non-cryptographically secure,
providing of prior art, a personal computer (PC) web client,
providing of prior art, a personal computer (PC) peripherals,
providing of prior art, a data entry devices of an on-board protected electronic device, toggle field with a prior art liquid crystal display (LCD) for entry of the unique customer passphrase with closely corresponding passcode entry,
providing of prior art, a data entry device of computer keyboards used for unique customer password, and passphrase-passcode entry with wiretapable (‘red bus’) computer keyboard buses vulnerable to the known prior art, hacker tools of both software and hardware based keyboard capture buffers,
providing of prior art, a banked-EEPROM card reader-writer connected by a prior art, serial bus connected with first example serial bus being the Universal Serial Bus (R) (USB bus) connected banked non-volatile memory chip card reader-writer serial bus interface unit to an electronic device, with first example banked non-volatile memory chip card unit which inserts into the reader being a banked, electrically erasable programmable read only memory (banked-EEPROM) card unit (e.g. Sans Disk (R) card, or SD (R) card), and second example banked non-volatile memory chip card unit being a single, large chip tamper-resistant non-volatile electrically erasable programmable read-only memory (TNV-EEPROM) (e.g. Memory Stick (R) chip),
providing of prior art, a personal computer's (PC's) peripheral data storage devices such as hard disk drives (HDD's), compact disk (CD) record once (CD-R (R)) drives, compact disk read-write (CD-RW (R)) drives which all offer ‘backwards compatible’ CD media which can be used in read-only modes compatible with older, existing read-only CD drives (CD), also writable digital versatile disk (DVD) drives (e.g. DVD+RW (R), DVD-RW (R), DVD-RAM (R) which all offer ‘backwards compatible’ media which can be used in read-only modes compatible with older, existing read-only DVD drives (DVD-ROM),
providing of prior art, a personal computer's (PC's) based peripheral data storage media units (e.g. back-up devices, video devices, fast floppy drives (e.g. Iomega (R) Zip (R) drives), removable hard disk drives (removable HDD) (e.g. Iomega Jazz (R drives)),
providing of prior art, a cryptographic digital signal processor (C-DSP) means designed for low-cost, very fast digital processing of fixed-point number array or arrays of fixed radix numbers having limited necessary precision typically less than 32-bits arranged in matrix arrays (32-bit integers with an assumed radix point which cannot move with a default assumed decimal point which cannot move) as popularly used in the Texas Instruments (TI) TMS-320 DSP and also the AT&T DSP-1, with major DSP features being an accumulator based design with arithmetic operation over-flow handling, no-overflow registers, pipelined design to DRAM connected over a central processor unit bus, constants for an ith round held as register variables for quick update for the (i+1)th round, and programming-time, programmable firmware libraries supporting flexible digital signal processing for different applications, furthermore, giving fast scalar control processing without a need for floating point operation re-normalization based upon exponents, with a floating point interpreter for limited floating point operations involving floating point number formats with exponents, furthermore, also having additional silicon compiler designed components of embedded tamper resistant non-volatile electrically erasable programmable read only memory (TNV-EEPROM) with a first example cryptographic digital signal processor (C-DSP) means being a standard DSP combined with the silicon compiler functions of the prior art, US National Institute of Standards and Technologies (NIST's) Clipper chip, being the Skipjack secret key algorithm as implemented in a silicon compiler with on-chip, tamper resistant non-volatile memory (TNV-EEPROM), sub-circuit, single integrated circuit (‘single chip IC solution’) design giving stream cipher and block cipher encryption and decryption functions (additionally used in the prior art, Capstone program using a plug-in PC card (R) format once called PCMCIA having an embedded Clipper ASIC chip comparable to a prior art smart card program), which were both programs and standards were based upon the dedicated, custom designed ASIC, hardware integrated circuit (IC) implementation of the National Security Agency (NSA) developed, classified Clipper chip implementing the Skipjack secret key algorithm with on-chip tamper resistant non-volatile memory (TNV-EEPROM), second example cryptographic digital signal processor (C-DSP) means being standard digital signal processing (DSP) functions combined with silicon compiler functions implementing the Chandra patent (U.S. Pat. No. 4,817,140 issued on Mar. 28, 1989 and assigned to IBM Corporation), and third example cryptographic digital signal processor (C-DSP) means being numerous other US Patents and also public art, non-patented technical literature,
providing of prior art, a cryptographic digital signal processor (C-DSP) means intended for very fast processing of large fixed-point arrays of fixed-point or fixed radix numbers as shown in the prior art, Texas Instruments (TI) TMS-320 DSP and also the AT&T DSP-1, additionally containing a cryptographic hardware secret key algorithm sub-processor, tamper resistant non-volatile electrically erasable programmable read only memory (TNV-EEPROM), random access memory (RAM), analog to digital signal converters (ADC), moving picture electronics group standards X (MPEG X) hardware decompression only circuitry for digital audio/video, digital audio/video signal artificial degradation circuitry, digital to analog signal converters, and digital signal processing of digital audio/video signals circuitry,
providing of new art, cryptographic digital signal processor (C-DSP) means designed for low-cost, very fast, digital processing of fixed-point number arrays as shown in the prior art, popularly used, Texas Instruments TMS-320 DSP and also the AT&T DSP-1, furthermore, having additional silicon compiler designed components adding embedded tamper resistant non-volatile electrically erasable programmable read only memory (TNV-EEPROM) for secure cryptographic key storage, along with both tamper resistant to pin-probers, and cryptographically protected on-chip, firmware implemented new art, byte-oriented, secret key algorithm based secret key encryption and decryption for both stream oriented and block oriented encryption and decryption processes, with on-chip hardware and firmware library support for both secret key and public key algorithms such as an electronic true random number generator, an on-chip hardware floating point unit (FPU) for processing large blocks of secret key encrypted and decrypted data using newer y. 2003 firmware based, byte oriented, secret key algorithms such as Advanced Encryption Standard (AES), an extremely large integer to an extremely large integer exponentiation unit using the binary square and multiply method commonly used in public key cryptography, with additional on-chip silicon compiler designed hardware support for digital decompression (read-only) algorithms, with additional on-chip silicon compiler support for digital compression algorithms, with additional on-chip silicon compiler support for forward error detection and correction coding (e.g. Reed-Solomon or RS coding) done in the encoding process sequential order of digitally compress, encrypt, and error detect adn correct, with decoding done in the exact opposite sequential process order, with a first example C-DSP means being discussed broadly in the present inventor's present patent's technical material which is not subject to this present over-all system's or methods patent application which uses such a device as a provided hardware component,
providing of a new art, programmable gate array logic (GAL) form of high density, application specific integrated circuit (ASIC) with embedded cryptographic digital signal processor (C-DSP) means functions as mentioned in the paragraph just above,
providing of new art, a cryptographic digital signal processor (C-DSP) means designed for very fast execution of fixed-point number arrays such as the popular Texas Instruments TMS-320 and also the AT&T DSP-1, furthermore, having additional silicon compiler based embedded, prior art, cryptographic hardware secret key algorithm sub-processors based upon prior art, standardized, secret key algorithms with an example algorithm being given as IBM's patented Data Encryption Standard (DES), with on-chip firmware support, an on-chip hardware floating point unit (FPU) for processing large blocks of secret key encrypted and decrypted data using newer y. 2003 firmware based, byte oriented, secret key algorithms such as Advanced Encryption Standard (AES), an extremely large integer to an extremely large integer exponentiation unit using the binary square and multiply method commonly used in public key cryptography, with additional on-chip silicon compiler designed hardware support for digital decompression (read-only) algorithms, with additional on-chip silicon compiler support for digital compression algorithms, with additional on-chip silicon compiler support for forward error detection and correction coding (e.g. Reed-Solomon or RS coding) done in the encoding process sequential order of digitally compress, encrypt, and error detect and correct, with decoding done in the exact opposite sequential process order, which in turn are silicon compiler design embedded hardware sub-units inside of said prior art, cryptographic digital signal processors (C-DSP's),
providing of prior art, a cryptographic micro-processor (c-uP) or a central processing unit (CPU) such as an Intel Pentium (R) CPU with a control unit, and also with an integrated fast, hardware, floating point unit (FPU), integrated memory management unit (MMU), integrated instruction and data cache unit, integrated bus interface unit (BIU), and additional proposed subset functionality of a C-DSP means including integrated tamper resistant non-volatile electrically erasable programmable read only memory (TNV-EEPROM), all on a single chip, which has impedance monitored intermetallic deposition layers protecting the entire chip from illegal pin probers used by hackers targeting the on-chip architecture including the protected (‘black’) on-chip buses, and also for protecting the entire chip from wiretapping pin probers used to illegally read cryptographic keys stored on the on-chip said embedded, tamper resistant non-volatile electrically erasable programmable read only memory (TNV-EEPROM), with the main anti-tamper means being the automatic on-chip erasure of cryptographic memory (TNV-EEPROM) holding all cryptographic keys upon the fully automatic detection of any signs of chip tampering,
providing of new art, a cryptographic computing based unit (C-CPU) also having a subset of cryptographic digital signal processing (C-DSP) means having much more on-chip, hardware, floating point (FPU) throughput capacity than the C-DSP chip and a more powerful memory management unit (MMU) capability, while having subset security functionality as the cryptographic digital signal processor unit (C-DSP) means being on-chip tamper resistant non-volatile electrically erasable programmable read-only memory (TNV-EEPROM) or cryptographic memory for both cryptographic key storage and cryptographic algorithm firmware storage, automatic on-chip impedance monitoring of a whole chip inter-metallic layer with automatic erasure of cryptographic memory upon tamper detection, silicon compiler library designed on-chip functions with automatic placement and routing, on-chip support for read-only commercial players using an embedded C-CPU of a tamper protected, error detection or correction unit (e.g. Reed-Solomon unit), on chip support for read-only commercial players using an embedded C-CPU of a tamper protected (‘black unit’), embedded, secret key decryption sub-unit which supports both dedicated hardware and dedicated firmware secret key decryption of play-back mode only, uniquely secret key encrypted, commercial media, on-chip tamper protected digital de-compression only support in play-back only mode for standard form digital media (e.g. MP3 being discrete cosine transform (DCT) based, MPEG X being discrete cosine transform (DCT) based, fast wavelet transform (FWT) audio-video being covolutional coding based, JPEG being discrete cosine transform (DCT) based, JPEG 2000 being fast wavelet transform (FWT) or convolutional coding based, Fraunhoeffer Instititute fast wavelet transform (FWT) audio (R convolutional coding, AAC (R) brand convolutional coding) widely used in commercial media players, with more general bi-directional use in crypto-cell phones and crypto-hand-held computers for similar on-chip support respecting relevant process sequential orders being digitally compress media, encrypt media, error detection and correction bits added, which must be undone in cryptography in the exact reverse sequential order, for the hardware and firmware based encryption and decryption of digital media data, but, without current on-chip support for encrypted operation codes (c-op codes) usable in the future for cryptographic computer programs and cryptographic multi-media programs, with a first example C-CPU means being discussed in the present inventor's present invention,
providing of new art, a non-cryptographic media player (MP) based upon prior art, non-cryptographic digital signal processor (DSP) means with starting functionality of the popular Texas Instruments TMS-320 DSP, constructed with serial bus connections to customer insertable and removable prior art, smart card reader-writer unit interfaces, and a read-only drive unit for standard physical format, digital media which is very similar in computer architecture to prior art, electronic-book readers which have a built-in, very small, liquid crystal display (LCD), and are similar in physical form to non-cryptographic compact disk players,
providing of new art, a cryptographic media player (c-MP) constructed with said, prior art, cryptographic digital signal processor (C-DSP) means having serial bus connections to customer insertable and removable prior art, smart card reader-writer unit interfaces, and also having a read-only drive unit for standard media with first example, read-only, media means being compact disk record once (CD-R), second example read-only media means being compact disk compact disk read-write (CD-RW), and third example read-only media means being banked non-volatile memory card (banked EEPROM), and fourth example read-only media means being digital versatile disk record once (DVD-R),
providing of new art, a cryptographic personal computer (c-PC) which is created by using new art, said cryptographic digital signal processor (C-DSP) means based plug-in, peripheral or contention bus or input-output bus (I/O bus) cards for prior art, personal computers (PC's), with the peripheral bus giving an interface to the motherboard's said cryptographic central processing unit (C-CPU) which in turn has a Universal Serial Bus (USB) interface to a USB based smart card reader,
providing of new art, a cryptographic personal computer (c-PC) having a subset functionality of C-DSP means, which is created by using a prior art, standard off-the shelf personal computer (PC) design with a cryptographic central processing unit (C-CPU) with the goal of creating an internal secure bus hardware or ‘black bus’ computer architecture system also having insecure hardware bus or ‘red bus’ or open wiretapable buses, which furthermore requires a new art, cryptographic operating system (C-OS),
providing of new art, a cryptographic media player (c-MP) for playing back custom secret key encrypted, compressed digital, audio-video in standard format with first example compressed digital audio-video being given as prior art, Moving Picture Electronics Group Standards X (MPEG X) and second example compressed digital audio-video being given as prior art, fast wavelet audio-video digital compression also called convolutional coding, furthermore, said player contains embedded, cryptographic computing units (C-CPU's) with serial bus interfaces to built-in, prior art, smart card reader units, and also having built-in, prior art, input/output (I/O) peripheral bus connected, computer industry standard, peripheral data storage drives in first example drive being a compact disk read only (CD) drive which reads compact disk record once format (CD-R),
providing of new art, a universal cryptographic set-top box form of media players (c-MP's) for playing back custom secret key encrypted, high definition television (HDTV) broadcasts and standard definition television (SDTV) broadcasts, as well as for playing custom secret key encrypted, cable channel programming, as well as for playing custom secret key encrypted satellite television programming which are based upon a more powerful, cryptographic media player computer architecture (c-MP),
providing of new art, a cryptographic micro-mirror module (c-MMM)-commercial theater projection-theater sound units which are special cryptographic media players which use prior art, more than one drive, digital versatile disk read only (DVD) drive units which also read digital versatile disk record (DVD-X) formats, furthermore, the DVD-X disks contain custom encrypted compressed digital media which can be decrypted only with a corresponding, unique, smart card programmed in a prior art, standard, personal computer (PC) over the wiretapable (‘red bus’) Internet as a special media ticket smart card using the methods of the present inventor's patent,
providing of prior art, a modified secure operating system (secure-OS) for world wide web (WWW) server computers which will custom customer session key encrypt a vendor secret key encrypted digital master, and electronically distribute custom, encrypted digital media masters, using firewalls, using anti-viral software updated weekly, using network protocol converters, using standard layered security methods, and using ‘inner sanctum’ protection for vendor session key or one-time secret key encrypted digital media masters,
providing of prior art, a world wide web (WWW) transmission control protocol-internet protocol (TCP-IP) command protocol stack program for Internet connectivity,
providing of prior art, standard, a plurality of cryptographic mathematics algorithms,
providing of prior art, a plurality of public key cryptography algorithms which create public keys and private keys,
providing of prior art, a plurality of secret key cryptography algorithms which create secret keys and session keys (1-time secret keys) and also play counts or access counts or media decryption counts and play codes (session keys or 1-time secret keys),
providing of prior art, a plurality of hybrid key cryptography algorithms which are combined public key and private key cryptography algorithms (prior art),
providing of prior art, a plurality of private key and secret key splitting algorithms,
providing of prior art, a plurality of private key and secret key escrow techniques,
providing of prior art, a plurality of algorithms used to generate: cryptographic keys which are the collective public keys, private keys, secret keys, session keys (1-time use only secret keys), play counts, play codes, passphrases-passcodes,
providing of prior art, a plurality of computer cryptography protocols,
providing of prior art, a plurality of pass-thru encryption algorithms for transmitting secure data over wiretapable computer buses (‘red buses’),
providing of prior art, standardized form, a plurality of lossy compressed digital media algorithms with first example algorithm being given as MPEG X (R) based upon a SVGA (R) video format and also newer UXGA (R) higher resolution video formats, second example algorithm being given as MP3 (R) based upon pulse code modulated (PCM's) audio sound only, third example algorithm being given as JPEG X (R) for still color photography only with JPEG being discrete cosine transform (DCT) based and JPEG 2000 being fast wavelet transform (FWT) compression based, fourth example algorithm being given as fast wavelet transform (FWT) audio-video, fifth example algorithm being given as proprietary Advanced Audio CODEC (R) (AAC (R)) using a FWT algorithm variant, sixth example algorithm being given as Fraunhoeffer Institute fast wavelet transform (FWT) audio (R ) who are the original international patentees for convolutional coding based lossy digital compression,
providing of prior art, a transmissions control protocol/internet protocol (TCP/IP) for Internet connectivity,
providing of prior art, a secure internet protocol layer (secure IP layer) layer of Internet data encryption,
providing of prior art, a secure sockets layer (SSL) layer of Internet data encryption,
providing of prior art, a plurality of world wide web (WWW) server standard interchange file language with first example protocol being hyper-text mark-up language (HTML), second example protocol being extensible business mark-up language (XBML or XML), and third example protocol being generalized-text mark-up language (GTML),
providing of a plurality of world wide web (WWW) client standard interchange file languages with first example being hyper-text mark-up language (HTML),
generating of a set of common system keys which is the process done by the media ticket smart card system authority's, party S's, dedicated public key generation authority, party G, while having absolutely no access to customer identifications,
generating of unique per vendor, common look-up table distributed, media distribution vendor cryptographic keys eventually used in cryptographic digital signal processors (C-DSP's) for eventual manufacturing into cryptographic media players which is the process done by the media ticket smart card system authority's, party S's, dedicated public key generation authority, party G, while having absolutely no access to customer identifications,
generating of a unique media ticket smart card cryptographic key set which is the process done by the media ticket smart card system authority's, party S's, dedicated public key generation authority, party G, while having absolutely no access to customer identifications,
distributing of a set of cryptographic digital signal processors (C-DSP's) which is the process done by the media ticket smart card system authority's, party S's, dedicated public key distribution authority, party D, distributing cryptographic digital signal processors (C-DSP's) to media distribution vendors, parties Vn, for manufacturing into cryptographic media players called cryptographic set-top boxes while having absolutely no access to whole cryptographic keys,
distributing of the media ticket smart cards which is the process done by the media ticket smart card system authority's, party S's, dedicated public key distribution authority, party D, distributing media ticket smart cards to media distribution vendors for selling to customers while having absolutely no access to whole cryptographic keys,
escrowing of the split cryptographic keys which is the process done by the central key generation authority, party G, safe-guarding the split cryptographic customer keys, and split cryptographic vendor keys in an entirely secure and confidential manner with legal first means for simple customer identification and lost key recovery, second means for disputed ownership court ordered recovery, and third means for court ordered only use by law enforcement,
layering for a federated cryptography architecture which is the process done by the media ticket smart card system authority, party S, creating a federated architecture of cryptographic authority with 3-layers, a central layer composed of the media ticket smart card system authority, a local layer composed of authorized media distribution companies Vn, and a user layer composed of customers,
preparing of play codes and play counts which is the process done by the authorized digital media distribution company, party Vn, preparing play codes (session keys or one-time secret keys), play counts (paid for numbers of plays or counts of free trial plays), and custom encrypted digital media for downloading to each customer,
downloading to customer, party A, which is the process done by the authorized digital media distribution vendor, party Vn, using hybrid key cryptographing steps of hybrid key cryptographic digital media distribution from a central media distribution authority hosted on a web server to multiple personal computer (PC) based web clients of encrypted play codes (one-time secret keys or session keys) with header and encrypted play counts (paid for counts of plays or decryptions, or else counts of free trial plays) with header for deposit into media ticket smart cards attached to personal computer (PC) media ticket smart card readers, and one-way transfer of custom session key encrypted digital media which is pre-unique vendor secret key encrypted for deposit into physical digital media inserted into media drives attached to personal computers (PC's),
delivering by foot which is the process done by the customer, party A, of physically transferring a programmed media ticket smart card from the customer's, party A's, personal computer (PC) to any person's said cryptographic media player with its embedded said cryptographic digital signal processor (C-DSP) means with a built-in media ticket smart card reader,
custom broadcasting to customer, party A, which is the process done by the authorized digital media distribution vendor, party Vn, using hybrid key cryptographing steps of hybrid key cryptographic digital media distribution from a central media distribution authority hosted on a broadcast server to multiple homes or businesses having cryptographic set-top boxes for one-way transfer of custom session key encrypted digital media for possible digital recording into physical digital media inserted into media drives attached to an attached digital recorder,
pass-thru encrypting means involving several processes and components for transferring any type of digital data securely from the media ticket smart card up to said cryptographic media player or said cryptographic set-top box with its embedded said crytographic digital signal processor (C-DSP) means with first example pass-thru encrypting means being common family key or shared secret key encryption which is known to be vulnerable to a single point of attack, second example pass-thru encrypting means being a pre-embedded, common look-up table of unique vendor public key and matching private keys with organizational means involving several processes and components such as first organizational means being a row, column table indexed by a vendor identification number, third example pass-thru encrypting means being a pre-embedded common look-up table of unique vendor secret keys with organizational means involving several processes and components with first organizational means being a row, column table indexed by a vendor identification number,
pass-thru encrypting return means involving several processes and components for transferring any digital data from said cryptographic media player or said cryptographic set-top box with its embedded said cryptographic digital signal processor (C-DSP) means to the media ticket smart card with first example pass-thru encrypting return means being common family key or shared secret key encryption which is known to be vulnerable to a single point of attack, second example pass-thru encrypting return means being a pre-embedded, common look-up table of unique vendor public key and matching private keys with organizational means involving several processes and components such as first organizational means being a row, column table indexed by a vendor identification number, third example pass-thru encrypting return means being a pre-embedded common look-up table of unique vendor secret keys with organizational means involving several processes and components with first organizational means being a row, column table indexed by a vendor identification number,
initializing before playing which is the process done by the customer, party A, of preparing any party's cryptographic media player or said cryptographic set-top box for his own custom broadcast encrypted digital media and his own media ticket smart card,
authenticating by customer triangle authentication which is the process done by said cryptographic set-top box with its embedded said cryptographic digital signal processor (C-DSP) means,
transferring of cryptographic keys to said cryptographic media player or said cryptographic set-top box with its embedded said cryptographic digital signal processor (C-DSP) means by pass-thru encrypting means of cryptographic keys which is the process done by the cryptographic set-top box to receive encrypted play codes with header and encrypted play counts with header from the media ticket smart card n transferred over wiretapable computer buses to the set-top box's own cryptographic memory (TNV-EEPROM) for access by its cryptographic digital signal processor (C-DSP) means,
transferring of cryptographic keys away from said cryptographic media player or said cryptographic set-top box with its embedded said cryptographic digital signal processor (C-DSP) means by pass-thru encrypting return means of cryptographic keys which is the process done by the cryptographic set-top box's cryptographic digital signal processor (C-DSP) means to transfer encrypted play codes with header and encrypted play counts with header both with cryptographic digital signal processor (C-DSP) means incremented sequence counts to the media ticket smart card A transferred over wiretapable computer buses,
authenticating using media triangle authentication which is the process of matching the unique digital media with its matching unique play code by the method done by said cryptographic set-top box with its embedded said cryptographic digital signal processor (C-DSP) means using digital media triangle authentication using sample reads of test data with successful decryptions,
cryptographing using hybrid key cryptography which is the process done by said cryptographic media player or said cryptographic set-top box with its embedded said cryptographic digital signal processor (C-DSP) means using hybrid key cryptography which is the process which uses public key cryptography to authenticate remote parties, do digital signatures to authenticate digital media and establish media integrity with a remote party, and encrypt one-time secret keys known as session keys (ssk-n), used for only one session, which said session keys are sent to a remote party who decrypts them for storage in his own tamper resistant, non-volatile memory (TNV-EEPROM) embedded on his black, cryptographic computing unit in the example of a cryptographic digital signal processor (C-DSP) means and a cryptographic central processing (C-CPU) unit which said session keys may be later stored in tamper resistant non-volatile memory (TNV-EEPROM) embedded in a media ticket smart card where they are referred to as play codes with paid for and authorized play counts,
accounting by said cryptographic media player or said cryptographic set-top box with its embedded said cryptographic digital signal processor (C-DSP) means which is the process using hybrid key cryptography digital media playing of one-way transfer of custom session key encrypted digital media owned by party n in a controlled access manner mostly for financial accounting purposes which uses the play codes (session key or one-time secret key) and play counts (paid for number of plays or count of free trial plays) contained in media ticket smart cards,
playing by said cryptographic media player or said cryptographic set-top box with its embedded said cryptographic digital signal processor (C-DSP) means which is the process using hybrid key cryptography which is the process of using hybrid key cryptography to do digital media playing in a controlled access manner using play codes (session key or one-time secret keys) and play counts (now contained within registers in the cryptographic digital signal processor (C-DSP) means and also the double secret key decryption of a unique customer session key decryption followed by a unique vendor secret key encryption, used directly used upon the custom encrypted one-way transfer of custom session key encrypted digital media which is pre-unique vendor secret key decrypted with sequence number checks for countering recorded replay attacks,
electronic television guide (TV guide) picture in a picture (PIP) viewing and channel selection and future program recording such as through an example graphical user interface (GUI) means of a “spreadsheet type” or “matrix type” of display accomplished through a annotated text data means involving several processes which is new with the inventor's cross referenced invention [REF 512] which uses a new cryptography “silhouette-like” technique extension to the MPEG IV standards for very efficient carrying of limited digital television guide information which can easily be removed in a MPEG X decompression circuit for sending to video RAM and subsequent display in a digital picture in a picture (PIP) on a digital monitor,
escrowing retrieval of lost, stolen, or disputed ownership media ticket smart cards which is the process done by the customer, party n, which collection of processes of or methods of invention sets systems standards and integrates components into a system which can be used in the future for new forms of internationally standardized cryptography sanctioned by industry trade groups such as the Recording Industry of America Association (RIAA), the Secure Digital Music Initiative (SDMI), the US National Association of Broadcasters (NAB), and also national standards agencies such as the American National Standards Institute (ANSI), National Institute for Standards and Technology (NIST), or International Telegraphy Union (ITU),
whereby the present invention creates several processes in doing digital media distribution over the prior art Internet using secure World Wide Web (WWW) servers involving the cryptographically secure transfer or download to personal computers (PC's) of digital media with subsequent transfer to cryptographic media players,
whereby the present invention creates several processes in safeguarding multi-million dollar digital masters.

61. The process of or methods of claim 60 whereby the process of public key cryptographing is done for authentication by said cryptographic media player or said cryptographic set-top box with its embedded said cryptographic digital signal processor (C-DSP) means using prior art, public key cryptography algorithms which is the process of using public key cryptography authentication, encryption, and decryption using public keys (puk-n), and private keys (prk-n), stored within tamper resistant non-volatile memory (TNV-EEPROM) embedded within non-wiretapable (“black”) cryptographic computing units in the example of cryptographic digital signal processors (C-DSP) means.

62. The process of or methods of claim 61 whereby the process of secret key cryptographing uses prior art, secret key cryptography which is the process done by said cryptographic media player or said cryptographic set-top box with its embedded said cryptographic digital signal processor (C-DSP) means using secret key cryptography which is the process of using secret key cryptography with a non-wiretapable (“black”) bus, cryptographic computing unit in example of a cryptographic digital signal processing (C-DSP) means using secret keys (sek-n), or session keys (ssk-n), stored upon tamper resistant, non-volatile memory (TNV-EEPROM), using the following sub-process:
cryptographing using fast hardware session key cryptography which is the process done by a cryptographic digital signal processor (C-DSP) means inside of a cryptographic set-top box using hardware secret key cryptography which is the process of using a dedicated hardware secret key sub-processor which is embedded within a secure (“black”), cryptographic digital signal processing (C-DSP) means with access to higher level tamper resistant non-volatile (TNV-EEPROM) (“black”) memory for cryptographic key storage of private keys and secret keys, which hardware secret key sub-processor is much faster than software for secret key cryptography and is intended for fast, secret key cryptography encryption and decryption of block transferred digital media.

63. A specific method of or process for doing public key cryptography over an open systems architecture in a totally cryptographically secure manner meant for safeguarding multi-million dollar digital masters for the process of commercial movie distribution involving fully digital micro-mirror modules (MMM) which open systems architecture includes existing prior art components to give new art systems processes of:
providing of prior art, a tamper-resistant non-volatile electrically erasable programmable read-only memory (TNV-EEPROM) which can be in an external dedicated chip and also in an on-chip micro-controller design, which is used to hold embedded, brief in length, cryptographic computer programs, cryptographic system keys with first example cryptographic keys being family keys or shared secret keys, second example cryptographic keys being cryptographic private keys, third example cryptographic keys being secret keys, fourth example cryptographic keys being session keys, and fifth example cryptographic keys being cryptographic public keys,
providing of prior art, an electrically erasable programmable read-only memory (EEPROM) which can come in a larger dedicated chip and also in an on-chip micro-controller design, used to hold, non-secure, computer programs (firmware) which are usually stored on separate and dedicated EEPROM memory chips which are connected to the digital computer processor through an input-output (I/O) bus with an on-processor instruction cache usually made of two layers: a L1 cache of faster, static RAM, and a L2 cache of very fast, associative memory or on-chip banked registers used to locally hold pages of operational codes (op codes) for fast execution,
providing of prior art, a static random access memory (SRAM) which can come in a larger dedicated chip and also in an on-chip micro-controller design with an on-chip input-output (I/O) bus with SRAM preferred over DRAM on-chip for faster speed and no need of a memory refresh cycle at the cost of one-fourth less bit density, for faster temporary storage of dynamic data which is usually in the form of separate and dedicated SRAM memory chips which are connected to the digital computer processor through an input-output (I/O) bus with an on-processor data cache of one or more levels (L1 cache being SRAM and L2 cache being associative memory or registers) used to locally hold pages of dynamic computer data for fast data cache access,
providing of prior art, a dynamic random access memory (DRAM) which can come in a larger dedicated chip and also in an on-chip micro-controller design using an on-chip input-output (I/O) bus with on-chip SRAM preferred over DRAM in micro-controllers for faster speed and no memory refresh cycle, with the latest example of fast DRAM being duo-data rate, synchronous, dynamic random access memory (DDR-SDRAM) which can hold either operational codes (for non-firmware based computer programs) or dynamic data (especially large arrays and large chunks of data such as video ‘frame buffers’), with the DRAM being an acknowledged bottle-neck on the central processor unit (CPU) bus with another greater bottle-neck being the transfer of digital data over the peripheral device or input-output (I/O) bus and its much slower often electromechanical input-output (I/O) devices,
providing of prior art, a low-cost, low-throughput, cryptographic embedded micro-controller (c-uCtlr) with scalar control operations, slow fixed-point arithmetic processing, and very slow, floating point interpreter based floating point processing (lacking a hardware floating point unit (FPU)), as used in a prior art, 8-bit, single chip solution, micro-controller based, smart card as widely used in Europe for over twenty years with universal success over-coming in all forms of human abuse and adverse weather conditions, with said tamper resistant non-volatile memory, random access memory (TNV-EEPROM), holding both cryptographic keys and very limited amounts of embedded secure cryptographic algorithm firmware for the entirely on-chip execution of cryptographic algorithms (secret key encryption-decryption, public key encryption-decryption, message digest ciphers (MDC's), message authentication ciphers (MAC's)), furthermore, possessing an on-chip input-output (I/o) bus in a micro-controller architecture with on-chip limited, static random access memory (SRAM) for fast dynamic data storage, and on-chip limited electrically erasable programmable read only memory (EEPROM) for computer firmware program storage, furthermore, possessing a wiretapable (‘red’) smart card serial data bus to the external world which is used for initial unique customer access code communications from a digital computer into the smart card to activate it, and then is subsequently used for reverse direction communications of internal smart card secure memory values representing cash to debit and also accounting access counts used in pass-thru encryption to transfer encrypted (‘cipher-text’) data from the cryptographic micro-processor (c-uP) inside the smart card to a smart card reader and pass-by processing proceeding to a digital computer which must do pass-thru decryption and pass-thru encryption for the return closed feed-back response communications exchange of possibly debited monetary values or incremented access counts needing secure storage in the smart card,
providing of prior art, the smart card used for media ticket applications containing tamper resistant, non-volatile memory (TNV-EEPROM) for key storage as part of cryptographic embedded micro-processors (c-uP's),
providing of prior art, serial data computer communications interfaces such as a personal computer (PC) based, serial bus connected (e.g. Universal Serial Bus or USB bus, and the faster and longer distance but more expensive, IEEE 1394 serial bus (‘Fire wire bus’)), used to connect a personal computer (PC) to a digitized human fingerprint reader and for other computer peripheral purposes,
providing of prior art, a smart card reader means involving several invention processes which simply reads the customer inserted smart card's pass-thru encrypted data and passes it over wiretapable (‘red’) buses to the digital computer, furthermore, a first example form of smart card reader means has physical metallic contacts with a power pin used to re-charge any smart card internal battery from an additional AC power line going into the smart card reader and suitable voltage conversion and regulation electronics, furthermore, a second example smart card reader means is a popular class of prior art, smart cards which have an optical interface which lacks any form of smart card battery re-charging capability but has improved durability, a third example smart card reader is a prior art, integrated smart card reader with bio-ID digitized fingerprint reader, furthermore, the smart card reader is a dumb and inexpensive computer serial data bus device with a first example serial communications interface being a prior art, serial data bus given as a universal serial bus (USB) providing maximum 3.0 Mega bits/second data transfer over a maximum 3.5 feet distance, which has no local area networking (LAN) interfaces which must be provided by the attached digital computer, a second example serial communications interface being a prior art, IEEE 1394 (‘Fire wire’) serial data bus which transfers a maximum of 10.0 Mega bits/second at a distance of up to a maximum of 10.0 feet,
providing of prior art, biological-identification (bio-ID) reader means which attach to personal computers (PC's) using a low-cost serial data bus such as a universal serial data bus (USB bus) with a first example bio-ID reader means being a smart card reader with piggy-backed, integrated, digitized fingerprint, bio-identification (bio-ID) reader for very customer convenient use, with an example customer use of a low security and unattended by a ‘warm-blooded’ authorized gate-keeper, bio-ID means of ‘warm-blooded’ index finger insertion into a digitized fingerprint reader and smart card insertion at the same time, a second example bio-ID reader means is a prior art, smart card reader with external AC power supply and power conversion and regulation transformers along with a piggy-backed ‘warm-blooded’ iris scan reader digital video-camera electronics which said iris scan reader is attached by IEEE 1394 (‘Fire wire’) digital cable to a digital video camera,
providing of prior art, an internet protocol (IP), wide area network (IP WAN),
providing of prior art, a world wide web server (WWW) or web or graphics rich portion of the Internet web server computer,
providing of prior art, a personal computer (PC), which is non-cryptographically secure,
providing of prior art, a personal computer (PC) web client,
providing of prior art, a personal computer (PC) peripherals,
providing of prior art, a data entry devices of an on-board protected electronic device, toggle field with a prior art liquid crystal display (LCD) for entry of the unique customer passphrase with closely corresponding passcode entry,
providing of prior art, a data entry device of computer keyboards used for unique customer password, and passphrase-passcode entry with wiretapable (‘red bus’) computer keyboard buses vulnerable to the known prior art, hacker tools of both software and hardware based keyboard capture buffers,
providing of prior art, a banked-EEPROM card reader-writer connected by a prior art, serial bus connected with first example serial bus being the Universal Serial Bus (R) (USB bus) connected banked non-volatile memory chip card reader-writer serial bus interface unit to an electronic device, with first example banked non-volatile memory chip card unit which inserts into the reader being a banked, electrically erasable programmable read only memory (banked-EEPROM) card unit (e.g. Sans Disk (R) card, or SD (R) card), and second example banked non-volatile memory chip card unit being a single, large chip tamper-resistant non-volatile electrically erasable programmable read-only memory (TNV-EEPROM) (e.g. Memory Stick (R) chip),
providing of prior art, a personal computer's (PC's) peripheral data storage devices such as hard disk drives (HDD's), compact disk (CD) record once (CD-R (R)) drives, compact disk read-write (CD-RW (R)) drives which all offer ‘backwards compatible’ CD media which can be used in read-only modes compatible with older, existing read-only CD drives (CD), also writable digital versatile disk (DVD) drives (e.g. DVD+RW (R), DVD-RW (R), DVD-RAM (R) which all offer ‘backwards compatible’ media which can be used in read-only modes compatible with older, existing read-only DVD drives (DVD-ROM),
providing of prior art, a personal computer's (PC's) based peripheral data storage media units (e.g. back-up devices, video devices, fast floppy drives (e.g. Iomega (R) Zip (R) drives), removable hard disk drives (removable HDD) (e.g. Iomega Jazz (R drives)),
providing of prior art, a cryptographic digital signal processor (C-DSP) means designed for low-cost, very fast digital processing of fixed-point number array or arrays of fixed radix numbers having limited necessary precision typically less than 32-bits arranged in matrix arrays (32-bit integers with an assumed radix point which cannot move with a default assumed decimal point which cannot move) as popularly used in the Texas Instruments (TI) TMS-320 DSP and also the AT&T DSP-1, with major DSP features being an accumulator based design with arithmetic operation over-flow handling, no-overflow registers, pipelined design to DRAM connected over a central processor unit bus, constants for an ith round held as register variables for quick update for the (i+1)th round, and programming-time, programmable firmware libraries supporting flexible digital signal processing for different applications, furthermore, giving fast scalar control processing without a need for floating point operation re-normalization based upon exponents, with a floating point interpreter for limited floating point operations involving floating point number formats with exponents, furthermore, also having additional silicon compiler designed components of embedded tamper resistant non-volatile electrically erasable programmable read only memory (TNV-EEPROM) with a first example cryptographic digital signal processor (C-DSP) means being a standard DSP combined with the silicon compiler functions of the prior art, US National Institute of Standards and Technologies (NIST's) Clipper chip, being the Skipjack secret key algorithm as implemented in a silicon compiler with on-chip tamper resistant non-volatile memory (TNV-EEPROM), sub-circuit, single integrated circuit (‘single chip IC solution’) design giving stream cipher and block cipher encryption and decryption functions (additionally used in the prior art, Capstone program using a plug-in PC card (R) format once called PCMCIA having an embedded Clipper ASIC chip comparable to a prior art smart card program), which were both programs and standards were based upon the dedicated, custom designed ASIC, hardware integrated circuit (IC) implementation of the National Security Agency (NSA) developed, classified Clipper chip implementing the Skipjack secret key algorithm with on-chip tamper resistant non-volatile memory (TNV-EEPROM), second example cryptographic digital signal processor (C-DSP) means being standard digital signal processing (DSP) functions combined with silicon compiler functions implementing the Chandra patent (U.S. Pat. No. 4,817,140 issued on Mar. 28, 1989 and assigned to IBM Corporation), and third example cryptographic digital signal processor (C-DSP) means being numerous other US Patents and also public art, non-patented technical literature,
providing of prior art, a cryptographic digital signal processor (C-DSP) means intended for very fast processing of large fixed-point arrays of fixed-point or fixed radix numbers as shown in the prior art, Texas Instruments (TI) TMS-320 DSP and also the AT&T DSP-1, additionally containing a cryptographic hardware secret key algorithm sub-processor, tamper resistant non-volatile electrically erasable programmable read only memory (TNV-EEPROM), random access memory (RAM), analog to digital signal converters (ADC), moving picture electronics group standards X (MPEG X) hardware decompression only circuitry for digital audio/video, digital audio/video signal artificial degradation circuitry, digital to analog signal converters, and digital signal processing of digital audio/video signals circuitry,
providing of new art, cryptographic digital signal processor (C-DSP) means designed for low-cost, very fast, digital processing of fixed-point number arrays as shown in the prior art, popularly used, Texas Instruments TMS-320 DSP and also the AT&T DSP-1, furthermore, having additional silicon compiler designed components adding embedded tamper resistant non-volatile electrically erasable programmable read only memory (TNV-EEPROM) for secure cryptographic key storage, along with both tamper resistant to pin-probers, and cryptographically protected on-chip, firmware implemented new art, byte-oriented, secret key algorithm based secret key encryption and decryption for both stream oriented and block oriented encryption and decryption processes, with on-chip hardware and firmware library support for both secret key and public key algorithms such as an electronic true random number generator, an on-chip hardware floating point unit (FPU) for processing large blocks of secret key encrypted and decrypted data using newer y. 2003 firmware based, byte oriented, secret key algorithms such as Advanced Encryption Standard (AES), an extremely large integer to an extremely large integer exponentiation unit using the binary square and multiply method commonly used in public key cryptography, with additional on-chip silicon compiler designed hardware support for digital decompression (read-only) algorithms, with additional on-chip silicon compiler support for digital compression algorithms, with additional on-chip silicon compiler support for forward error detection and correction coding (e.g. Reed-Solomon or RS coding) done in the encoding process sequential order of digitally compress, encrypt, and error detect and correct, with decoding done in the exact opposite sequential process order, with a first example C-DSP means being discussed broadly in the present inventor's present patent's technical material which is not subject to this present over-all system's or methods patent application which uses such a device as a provided hardware component,
providing of a new art, programmable gate array logic (GAL) form of high density, application specific integrated circuit (ASIC) with embedded cryptographic digital signal processor (C-DSP) means functions as mentioned in the paragraph just above,
providing of new art, a cryptographic digital signal processor (C-DSP) means designed for very fast execution of fixed-point number arrays such as the popular Texas Instruments TMS-320 and also the AT&T DSP-1, furthermore, having additional silicon compiler based embedded, prior art, cryptographic hardware secret key algorithm sub-processors based upon prior art, standardized, secret key algorithms with an example algorithm being given as IBM's patented Data Encryption Standard (DES), with on-chip firmware support, an on-chip hardware floating point unit (FPU) for processing large blocks of secret key encrypted and decrypted data using newer y. 2003 firmware based, byte oriented, secret key algorithms such as Advanced Encryption Standard (AES), an extremely large integer to an extremely large integer exponentiation unit using the binary square and multiply method commonly used in public key cryptography, with additional on-chip silicon compiler designed hardware support for digital decompression (read-only) algorithms, with additional on-chip silicon compiler support for digital compression algorithms, with additional on-chip silicon compiler support for forward error detection and correction coding (e.g. Reed-Solomon or RS coding) done in the encoding process sequential order of digitally compress, encrypt, and error detect and correct, with decoding done in the exact opposite sequential process order, which in turn are silicon compiler design embedded hardware sub-units inside of said prior art, cryptographic digital signal processors (C-DSP's),
providing of prior art, a cryptographic micro-processor (c-uP) or a central processing unit (CPU) such as an Intel Pentium (R) CPU with a control unit, and also with an integrated fast, hardware, floating point unit (FPU), integrated memory management unit (MMU), integrated instruction and data cache unit, integrated bus interface unit (BIU), and additional proposed subset functionality of a C-DSP means including integrated tamper resistant non-volatile electrically erasable programmable read only memory (TNV-EEPROM), all on a single chip, which has impedance monitored intermetallic deposition layers protecting the entire chip from illegal pin probers used by hackers targeting the on-chip architecture including the protected (‘black’) on-chip buses, and also for protecting the entire chip from wiretapping pin probers used to illegally read cryptographic keys stored on the on-chip said embedded, tamper resistant non-volatile electrically erasable programmable read only memory (TNV-EEPROM), with the main anti-tamper means being the automatic on-chip erasure of cryptographic memory (TNV-EEPROM) holding all cryptographic keys upon the fully automatic detection of any signs of chip tampering,
providing of new art, a cryptographic computing based unit (C-CPU) also having a subset of cryptographic digital signal processing (C-DSP) means having much more on-chip, hardware, floating point (FPU) throughput capacity than the C-DSP chip and a more powerful memory management unit (MMU) capability, while having subset security functionality as the cryptographic digital signal processor unit (C-DSP) means being on-chip tamper resistant non-volatile electrically erasable programmable read-only memory (TNV-EEPROM) or cryptographic memory for both cryptographic key storage and cryptographic algorithm firmware storage, automatic on-chip impedance monitoring of a whole chip inter-metallic layer with automatic erasure of cryptographic memory upon tamper detection, silicon compiler library designed on-chip functions with automatic placement and routing, on-chip support for read-only commercial players using an embedded C-CPU of a tamper protected, error detection or correction unit (e.g. Reed-Solomon unit), on chip support for read-only commercial players using an embedded C-CPU of a tamper protected (‘black unit’), embedded, secret key decryption sub-unit which supports both dedicated hardware and dedicated firmware secret key decryption of play-back mode only, uniquely secret key encrypted, commercial media, on-chip tamper protected digital de-compression only support in play-back only mode for standard form digital media (e.g. MP3 being discrete cosine transform (DCT) based, MPEG X being discrete cosine transform (DCT) based, fast wavelet transform (FWT) audio-video being convolutional coding based, JPEG being discrete cosine transform (DCT) based, JPEG 2000 being fast wavelet transform (FWT) or convolutional coding based, Fraunhoeffer Institute fast wavelet transform (FWT) audio (R) convolutional coding, AAC (R) brand convolutional coding) widely used in commercial media players, with more general bi-directional use in crypto-cell phones and crypto-hand-held computers for similar on-chip support respecting relevant process sequential orders being digitally compress media, encrypt media, error detection and correction bits added, which must be undone in cryptography in the exact reverse sequential order, for the hardware and firmware based encryption and decryption of digital media data, but, without current on-chip support for encrypted operation codes (c-op codes) usable in the future for cryptographic computer programs and cryptographic multi-media programs, with a first example C-CPU means being discussed in the present inventor's present invention,
providing of new art, a non-cryptographic media player (MP) based upon prior art, non-cryptographic digital signal processor (DSP) means with starting functionality of the popular Texas Instruments TMS-320 DSP, constructed with serial bus connections to customer insertable and removable prior art, smart card reader-writer unit interfaces, and a read-only drive unit for standard physical format, digital media which is very similar in computer architecture to prior art, electronic-book readers which have a built-in, very small, liquid crystal display (LCD), and are similar in physical form to non-cryptographic compact disk players,
providing of new art, a cryptographic media player (c-MP) constructed with said, prior art, cryptographic digital signal processor (C-DSP) means having serial bus connections to customer insertable and removable prior art, smart card reader-writer unit interfaces, and also having a read-only drive unit for standard media with first example, read-only, media means being compact disk record once (CD-R), second example read-only media means being compact disk compact disk read-write (CD-RW), and third example read-only media means being banked non-volatile memory card (banked EEPROM), and fourth example read-only media means being digital versatile disk record once (DVD-R),
providing of new art, a cryptographic personal computer (c-PC) which is created by using new art, said cryptographic digital signal processor (C-DSP) means based plug-in, peripheral or contention bus or input-output bus (I/O bus) cards for prior art, personal computers (PC's), with the peripheral bus giving an interface to the motherboard's said cryptographic central processing unit (C-CPU) which in turn has a Universal Serial Bus (USB) interface to a USB based smart card reader,
providing of new art, a cryptographic personal computer (c-PC) having a subset functionality of C-DSP means, which is created by using a prior art, standard off-the shelf personal computer (PC) design with a cryptographic central processing unit (C-CPU) with the goal of creating an internal secure bus hardware or ‘black bus’ computer architecture system also having insecure hardware bus or ‘red bus’ or open wiretapable buses, which furthermore requires a new art, cryptographic operating system (C-OS),
providing of new art, a cryptographic media player (c-MP) for playing back custom secret key encrypted, compressed digital, audio-video in standard format with first example compressed digital audio-video being given as prior art, Moving Picture Electronics Group Standards X (MPEG X) and second example compressed digital audio-video being given as prior art, fast wavelet audio-video digital compression also called convolutional coding, furthermore, said player contains embedded, cryptographic computing units (C-CPU's) with serial bus interfaces to built-in, prior art, smart card reader units, and also having built-in, prior art, input/output (I/O) peripheral bus connected, computer industry standard, peripheral data storage drives in first example drive being a compact disk read only (CD) drive which reads compact disk record once format (CD-R),
providing of new art, a universal cryptographic set-top box form of media players (c-MP's) for playing back custom secret key encrypted, high definition television (HDTV) broadcasts and standard definition television (SDTV) broadcasts, as well as for playing custom secret key encrypted, cable channel programming, as well as for playing custom secret key encrypted satellite television programming which are based upon a more powerful, cryptographic media player computer architecture (c-MP),
providing of new art, a cryptographic micro-mirror module (c-MMM)-commercial theater projection-theater sound units which are special cryptographic media players which use prior art, more than one drive, digital versatile disk read only (DVD) drive units which also read digital versatile disk record (DVD-X) formats, furthermore, the DVD-X disks contain custom encrypted compressed digital media which can be decrypted only with a corresponding, unique, smart card programmed in a prior art, standard, personal computer (PC) over the wiretapable (‘red bus’) Internet as a special media ticket smart card using the methods of the present inventor's patent,
providing of prior art, a modified secure operating system (secure-OS) for world wide web (WWW) server computers which will custom customer session key encrypt a vendor secret key encrypted digital master, and electronically distribute custom, encrypted digital media masters, using firewalls, using anti-viral software updated weekly, using network protocol converters, using standard layered security methods, and using ‘inner sanctum’ protection for vendor session key or one-time secret key encrypted digital media masters,
providing of prior art, a world wide web (WWW) transmission control protocol-internet protocol (TCP-IP) command protocol stack program for Internet connectivity,
providing of prior art, standard, a plurality of cryptographic mathematics algorithms,
providing of prior art, a plurality of public key cryptography algorithms which create public keys and private keys,
providing of prior art, a plurality of secret key cryptography algorithms which create secret keys and session keys (1-time secret keys) and also play counts or access counts or media decryption counts and play codes (session keys or 1-time secret keys),
providing of prior art, a plurality of hybrid key cryptography algorithms which are combined public key and private key cryptography algorithms (prior art),
providing of prior art, a plurality of private key and secret key splitting algorithms,
providing of prior art, a plurality of private key and secret key escrow techniques,
providing of prior art, a plurality of algorithms used to generate: cryptographic keys which are the collective public keys, private keys, secret keys, session keys (1-time use only secret keys), play counts, play codes, passphrases-passcodes,
providing of prior art, a plurality of computer cryptography protocols,
providing of prior art, a plurality of pass-thru encryption algorithms for transmitting secure data over wiretapable computer buses (‘red buses’),
providing of prior art, standardized form, a plurality of lossy compressed digital media algorithms with first example algorithm being given as MPEG X (R) based upon a SVGA (R) video format and also newer UXGA (R) higher resolution video formats, second example algorithm being given as MP3 (R) based upon pulse code modulated (PCM's) audio sound only, third example algorithm being given as JPEG X (R) for still color photography only with JPEG being discrete cosine transform (DCT) based and JPEG 2000 being fast wavelet transform (FWT) compression based, fourth example algorithm being given as fast wavelet transform (FWT) audio-video, fifth example algorithm being given as proprietary Advanced Audio CODEC(R)(AAC (R)) using a FWT algorithm variant, sixth example algorithm being given as Fraunhoeffer Institute fast wavelet transform (FWT) audio (R ) who are the original international patentees for convolutional coding based lossy digital compression,
providing of prior art, a transmissions control protocol/internet protocol (TCP/IP) for Internet connectivity,
providing of prior art, a secure internet protocol layer (secure IP layer) layer of Internet data encryption,
providing of prior art, a secure sockets layer (SSL) layer of Internet data encryption,
providing of prior art, a plurality of world wide web (WWW) server standard interchange file language with first example protocol being hyper-text mark-up language (HTML), second example protocol being extensible business mark-up language (XBML or XML), and third example protocol being generalized-text mark-up language (GTML),
providing of a plurality of world wide web (WWW) client standard interchange file languages with first example being hyper-text mark-up language (HTML),
generating of a set of common system keys which is the process done by the media ticket smart card system authority's, party S's, dedicated public key generation authority, party G, while having absolutely no access to customer identifications,
generating of a unique per vendor, commonly distributed, set of media distribution vendor cryptographic keys eventually used in cryptographic digital signal processors (C-DSP's) for eventual manufacturing into cryptographic micro mirror modules which is the process done by the media ticket smart card system authority's, party S's, dedicated public key generation authority, party G, while having absolutely no access to customer identifications,
generating of a unique media ticket smart card cryptographic key set or unique set of customer cryptographic keys which is the process done by the media ticket smart card system authority's, party S's, dedicated public key generation authority, party G, while having absolutely no access to customer identifications,
distributing of the cryptographic digital signal processors (C-DSP's) which is the process done by the media ticket smart card system authority's, party S's, dedicated public key distribution authority, party D, distributing cryptographic digital signal processors (C-DSP's) to media distribution vendors, parties Vn, for manufacturing into cryptographic micro-mirror module players while having absolutely no access to whole cryptographic keys,
distributing of media ticket smart cards which is the process done by the media ticket smart card system authority's, party S's, dedicated public key distribution authority, party D, distributing media ticket smart cards to media distribution vendors for selling to customers while having absolutely no access to whole cryptographic keys,
escrowing of the split cryptographic keys which is the process done by the central key generation authority, party G, safe-guarding the split cryptographic customer keys, and split cryptographic vendor keys in an entirely secure and confidential manner with legal first means for simple customer identification and lost key recovery, second means for disputed ownership court ordered recovery, and third means for court ordered only use by law enforcement,
layering for a federated cryptography architecture which is the process done by the media ticket smart card system authority, party S, creating a federated architecture of cryptographic authority with 3-layers, a central layer composed of the media ticket smart card system authority, a local layer composed of authorized media distribution companies Vn, and a user layer composed of customers,
preparing of a unique play code and a unique play count which is the process done by the authorized digital media distribution company, party Vn, preparing said unique play code (a session key or one-time secret key), and said unique play count (a paid for number of plays or count of free trial plays), and custom encrypted digital media for downloading to each customer,
downloading to customer, party A, which is the process done by the authorized digital media distribution vendor, party Vn, using hybrid key cryptographing steps of hybrid key cryptographic digital media distribution from a central media distribution authority hosted on a web server to multiple personal computer (PC) based web clients of encrypted play codes (one-time secret keys or session keys) with header and encrypted play counts (paid for counts of plays or decryptions, or else counts of free trial plays) with header for deposit into media ticket smart cards attached to personal computer (PC) media ticket smart card readers, and one-way transfer of custom session key encrypted digital media which is pre-unique vendor secret key encrypted for deposit into physical digital media inserted into media drives attached to personal computers (PC's),
delivering by foot which is the process done by the customer, party A, of physically transferring both physical custom encrypted digital media and the customer, party A's, programmed media ticket smart cards from the customer's, party A's, personal computer (PC) to any person's cryptographic micro mirror module with a built-in media ticket smart card reader,
pass-thru encrypting means involving several processes and components for transferring any type of digital data securely from the media ticket smart card up to said cryptographic media player or said cryptographic micro-mirror machine module (MMM) with its embedded said cryptographic digital signal processor (C-DSP) means with first example pass-thru encrypting means being common family key or shared secret key encryption which is known to be vulnerable to a single point of attack, second example pass-thru encrypting means being a pre-embedded, common look-up table of unique vendor public key and matching private keys with organizational means involving several processes and components such as first organizational means being a row, column table indexed by a vendor identification number, third example pass-thru encrypting means being a pre-embedded common look-up table of unique vendor secret keys with organizational means involving several processes and components with first organizational means being a row, column table indexed by a vendor identification number,
pass-thru encrypting return means involving several processes and components for transferring any digital data from said cryptographic media player or said cryptographic micro-mirror machine module (MMM) with its embedded said cryptographic digital signal processor (C-DSP) means to the media ticket smart card with first example pass-thru encrypting return means being common family key or shared secret key encryption which is known to be vulnerable to a single point of attack, second example pass-thru encrypting return means being a pre-embedded, common look-up table of unique vendor public key and matching private keys with organizational means involving several processes and components such as first organizational means being a row, column table indexed by a vendor identification number, third example pass-thru encrypting return means being a pre-embedded common look-up table of unique vendor secret keys with organizational means involving several processes and components with first organizational means being a row, column table indexed by a vendor identification number,
initializing before playing which is the process done by the customer, party A, of preparing any party's cryptographic micro-mirror machine module (MMM) with its embedded cryptographic digital signal processor (C-DSP) means with his own custom encrypted digital media movies and his own media ticket smart card,
authenticating by customer triangle authentication which is the process done by said cryptographic micro-mirror machine module (MMM) with its embedded said cryptographic digital signal processor (C-DSP) means,
transferring of cryptographic keys to the cryptographic micro-mirror machine module (MMM) or said cryptographic media player with its embedded said cryptographic digital signal processor (C-DSP) means by pass-thru encrypting means of cryptographic keys which is the process done by the cryptographic micro mirror module to receive encrypted play codes with header and encrypted play counts with header from the media ticket smart card n transferred over wiretapable computer buses to the cryptographic micro mirror module's own cryptographic memory (TNV-EEPROM) for access by its cryptographic digital signal processor (C-DSP) means,
transferring of cryptographic keys away from said cryptographic media player or said cryptographic micro-mirror machine module (MMM) with its embedded said cryptographic digital signal processor (C-DSP) means by pass-thru encrypting return means of cryptographic keys which is the process done by the cryptographic media player's cryptographic micro mirror module to transfer encrypted play codes with header and encrypted play counts with header both with cryptographic digital signal processor (C-DSP) means incremented sequence counts to the media ticket smart card A transferred over wiretapable computer buses,
authenticating using media triangle authentication which is the process of matching the unique digital media with its matching unique play code by the method done by said cryptographic media player or said cryptographic micro-mirror machine module (MMM) with its embedded said cryptographic digital signal processor (C-DSP) means using digital media triangle authentication to read test data with a successful decryption,
cryptographing using hybrid key cryptography which is the process done by said cryptographic media player or said cryptographic micro-mirror machine module (MMM) with its embedded said cryptographic digital signal processor (C-DSP) means using hybrid key cryptography which is the process of using hybrid key cryptography which uses public key cryptography to authenticate remote parties, do digital signatures to authenticate digital media and establish media integrity with a remote party, and encrypt one-time secret keys known as session keys (ssk-n), used for only one session, which said session keys are sent to a remote party who decrypts them for storage in his own tamper resistant, non-volatile memory embedded on his black, cryptographic computing unit in the example of a cryptographic digital signal processor (C-DSP) means and a cryptographic central processing unit (C-CPU) which said session keys may be later stored in tamper resistant non-volatile memory (TNV-EEPROM) embedded in a media ticket smart card where they are referred to as play codes with paid for and authorized play counts,
accounting by said cryptographic media player with its embedded said cryptographic media player or said cryptographic micro-mirror machine module (MMM) with its embedded said cryptographic digital signal processor (C-DSP) means which is the process done by the cryptographic micro mirror module using hybrid key cryptography digital media playing of one-way transfer of custom session key encrypted digital media owned by party n in a controlled access manner mostly for financial accounting purposes which uses the play codes (session key or one-time secret key) and play counts (paid for number of plays or count of free trial plays) contained in media ticket smart cards,
playing by said cryptographic media player or said cryptographic micro-mirror machine module (MMM) with its embedded said cryptographic digital signal processor (C-DSP) means which is the process done by the cryptographic micro-mirror module (MMM) player using hybrid key cryptography which is the process of using hybrid key cryptography to do digital media playing in a controlled access manner using play codes (session key or one-time secret keys) and play counts (now contained within registers in the cryptographic digital signal processor (C-DSP) means and also the double secret key decryption of a unique customer session key decryption followed by a unique vendor secret key decryption, being directly used upon the custom encrypted one-way transfer of custom session key encrypted digital media which is pre-unique vendor secret key encrypted with sequence number checks for countering recorded replay attacks,
escrowing retrieval of lost, stolen, or disputed ownership media ticket smart cards which is the process done by the customer, party n, which collection of processes of or methods of invention sets systems standards and integrates components into a system which can be used in the future for new forms of internationally standardized cryptography sanctioned by industry trade groups such as the Recording Industry of America Association (RIAA), the Secure Digital Music Initiative (SDMI), the US National Association of Broadcasters (NAB), and also national standards agencies such as the American National Standards Institute (ANSI), National Institute for Standards and Technology (NIST), or International Telegraphy Union (ITU),
whereby the present invention creates several new processes in doing digital media distribution over the prior art Internet using secure World Wide Web (WWW) servers involving the cryptographically secure transfer or download to personal computers (PC's) of digital media with subsequent transfer to said cryptographic media players or said cryptographic micro-mirror machine modules (MMM) with embedded said cryptographic digital signal processors (C-DSP) means,
whereby the present invention creates several processes for safeguarding multi-million dollar digital masters.

64. The process or methods of claim 63 whereby the process of cryptographing public key cryptography is the process done by said cryptographic micro-mirror module (MMM) having an embedded said cryptographic digital signal processor (C-DSP) means using public key cryptography which is the process of using public key cryptography authentication, encryption, and decryption using public keys (puk-n), and private keys (prk-n), stored within tamper resistant non-volatile memory (TNV-EEPROM) embedded within non-wiretapable (“black”) cryptographic computing units in the example of cryptographic digital signal processors (C-DSP's).

65. The process of or methods of claim 64 whereby the process of cryptographing using secret key cryptography which is the process done by said cryptographic micro-mirror module (MMM) with its embedded said cryptographic digital signal processor (C-DSP) means using secret key cryptography which is the process of using secret key cryptography with a non-wiretapable (“black”) bus, cryptographic computing unit in example of a cryptographic digital signal processing (C-DSP) means using secret keys (sek-n), or session keys (ssk-n), stored upon tamper resistant, non-volatile memory (TNV-EEPROM), which comprises the sub-process of:
cryptographing using fast hardware session key cryptography which is the process done by a cryptographic digital signal processor (C-DSP) means inside of a cryptographic micro mirror module using hardware secret key cryptography which is the process of using a prior art, silicon compiler designed, dedicated hardware secret key sub-processor which is embedded within a secure (“black”), cryptographic digital signal processing (C-DSP) means with access to higher level tamper resistant non-volatile (TNV-EEPROM) (“black”) memory for cryptographic key storage of private keys and secret keys, which hardware secret key sub-processor is much faster than software for secret key cryptography and is intended for fast, secret key cryptography encryption and decryption of block transferred digital media.
